(19) United States
(12) Patent Application Publication
(10) Pub. No.: US 2012/0189062 A1
(43) Pub. Date: Jul. 26, 2012

(54) MOVING PICTURE CODING METHOD, MOVING PICTURE CODING APPARATUS, MOVING PICTURE DECODING METHOD, MOVING PICTURE DECODING APPARATUS, AND MOVING PICTURE CODING AND DECODING APPARATUS

(76) Inventors: Toshiyasu SUGIO, Osaka (JP); Takahiro Nishi, Nara (JP); Youji Shibahara, Osaka (JP); Hisao Sasai, Osaka (JP)

(21) Appl. No.: 13/356,983

(22) Filed: Jan. 24, 2012

Related U.S. Application Data
(60) Provisional application No. 61/436,358, filed on Jan. 26, 2011.

(51) Int. Cl. H04N 7/26

(52) U.S. Cl. 375/240.16; 375/E07.123; 375/E07.027

(57) ABSTRACT

A moving picture coding apparatus includes: a reference picture list management unit which assigns a reference picture index to each reference picture and creates reference picture lists together with display order and the like; a skip mode prediction direction determination unit which determines a prediction direction in a skip mode for a current block to be coded, using the reference picture lists; and an inter prediction control unit which compares a cost of a motion vector estimation mode, a cost of a direct mode, and a cost of the skip mode in which a prediction picture is generated using a predicted motion vector generated according to the prediction direction determined by the skip mode prediction direction determination unit, and determines a more efficient inter prediction mode among the three modes.

### CROSS REFERENCE TO RELATED APPLICATION

The present application claims the benefit of U.S. Provisional Patent Application No. 61/436,358 filed Jan. 26, 2011. The entire disclosures of the above-identified applications, including the specifications, drawings and claims are incorporated herein by reference in their entirety.

### BACKGROUND OF THE INVENTION

(1) Field of the Invention

The present invention relates to a moving picture coding method for coding an input picture on a block-by-block basis using inter picture prediction in which coded pictures are referred to, and to a moving picture decoding method for decoding a bitstream on a block-by-block basis using the inter picture prediction.

(2) Description of the Related Art

In moving picture coding processing, a quantity of information is generally reduced using redundancy of moving pictures in spatial and temporal directions. Here, a general method using the redundancy in the spatial direction is represented by the transformation into frequency domain while a general method using the redundancy in the temporal direction is represented by an inter-picture prediction (hereinafter referred to as inter prediction) coding process. In the inter prediction coding, when a certain picture is coded, a coded picture located before or after the current picture to be coded in display time order is used as a reference picture. Subsequently, a motion vector of the current picture with respect to the reference picture is derived by motion estimation. A difference between image data of the current picture and prediction picture data resulting from motion compensation based on the derived motion vector is calculated to remove the redundancy in the temporal direction. Here, the motion estimation refers to calculating a difference value between a current block to be coded in a picture to be coded and a block in a reference picture, using a block having the minimum difference value in the reference picture as a reference block, and deriving a motion vector based on a position of the current block and a position of the reference block.

In the moving picture coding scheme called H.264, which has already been standardized, three types of picture, I-picture, P-picture, and B-picture, are used to compress the information amount. The I-picture is a picture on which no inter prediction coding is performed, that is, on which a coding process using intra-picture prediction (hereinafter referred to as intra prediction) is performed. The P-picture is a picture on which the inter prediction coding is performed with reference to one coded picture located before or after the current picture in display time order. The B-picture is a picture on which the inter prediction coding is performed with reference to two coded pictures located before or after the current picture in display time order.

In the inter prediction coding, a reference picture list for identifying a reference picture is generated. The reference picture list is a list in which reference picture indexes are allocated to coded reference pictures to be referred to in the inter prediction. For example, two reference picture lists (L0 and L1) correspond to the B-picture which is used for coding with reference to two pictures. FIG. 1A is a diagram for illustrating assignment of reference picture indexes to reference pictures. FIG. 1B and FIG. 1C are tables showing examples of reference picture lists corresponding to a B-picture.

FIG. 1A assumes, for instance, a case where a reference picture 3, a reference picture 2, a reference picture 1, and a current picture to be coded are arranged in display order. In this case, the reference picture list 1 (L0) is an example of a reference picture list for a prediction direction 1 in bidirectional prediction. In the reference picture list 1, as shown in FIG. 1B, the value “0” of a reference picture index 1 is allocated to a reference picture 1 in a display order 2, the value “1” of the reference picture index is allocated to a reference picture 2 in a display order 1, and the value “2” of the reference picture index 1 is allocated to a reference picture 3 in a display order 0. In other words, the reference picture indexes are allocated in order of proximity to the current picture in display order. On the other hand, the reference picture list 2 (L1) is an example of a reference picture list for a prediction direction 2 in the bi-directional prediction. The value “0” of a reference picture index 2 is allocated to a reference picture 2 in a display order 1, the value “1” of the reference picture index 2 is allocated to a reference picture 1 in a display order 2, and the value “2” of the reference picture index 2 is allocated to a reference picture 3 in a display order 0. As such, a different reference picture index can be allocated to each of the reference pictures, according to the prediction direction (reference pictures 1 and 2 in FIG. 1A), and the same reference picture index can be allocated to the reference picture (the reference picture 3 in FIG. 1A).

Furthermore, the moving picture coding scheme called H.264 includes, as an inter prediction coding mode for each current block to be coded in the B-picture, (i) a motion vector estimation mode in which a difference value between prediction picture data and picture data of a current block and a motion vector used in generating prediction picture data are coded, (ii) a direct mode in which only a picture data difference value is coded and a motion vector is predicted from an adjacent block or the like, and (iii) a skip mode in which neither the picture data difference value nor the motion vector is coded and a prediction picture at a location indicated by a motion vector predicted from an adjacent block or the like is directly used as a decoded picture. The direct mode further includes: a spatial direct mode in which a motion vector is predicted from an adjacent block adjacent to a current block to be coded in a current picture to be coded including the current block; and a temporal direct mode in which a motion vector is predicted from a co-located block of a current block to be coded. Here, the co-located block is a block which is in a picture different from the current picture and is co-located, in the picture, with the current block.

In the motion vector estimation mode for the B-picture, it is possible to select, as a prediction direction, bidirectional prediction in which a prediction picture is generated by referring to two coded picture located before or after a current picture or unidirectional prediction in which a prediction picture is generated by referring to one coded picture located before or after a current picture.

In contrast, in the skip mode and the direct mode for the B-picture, a prediction direction of a current block is determined according to a prediction mode for an adjacent block or the like. A specific example is described with reference to FIG. 2. In FIG. 2, a coded block adjacent to the left of a current block is an adjacent block A, a coded block adjacent to the top of the current block is an adjacent block B, and a coded block adjacent to the top right of the current block is an adjacent block C.

Moreover, in FIG. 2, the bidirectional prediction is used for the adjacent block A, and the adjacent block A has a motion vector MvL0_A in a prediction direction 1 and a motion vector MvL1_A in a prediction direction 2. Here, the MvL0 is a motion vector which refers to a reference picture identified by the reference picture list 1 (L0), and the MvL1 is a motion vector which refers to a reference picture identified by the reference picture list (L1). Furthermore, the unidirectional prediction is used for the adjacent block B, and the adjacent block B has a motion vector MvL0_B in a prediction direction 1. Moreover, the unidirectional prediction is used for the adjacent block C, and the adjacent block C has a motion vector MvL0_C in a prediction direction 1. Here, it is assumed that the motion vectors MvL0_A, MvL0_B, and MvL0_C of the respective adjacent blocks refer to the same reference picture RefIdxL0, and that the MvL1_A refers to a reference picture RefIdxL1.

When it is assumed that the reference pictures in the prediction directions 1 and 2 in the skip mode and the direct mode of the current block are RefIdxL0 and RefIdxL1, respectively, the prediction directions in the skip mode and the direct mode are the bidirectional prediction when the bi-directional prediction is present in which at least one of adjacent blocks refers to the RefIdxL0 and RefIdxL1. In a case shown in FIG. 2, the adjacent block A meets the above condition, and thus the bidirectional prediction is selected as the prediction direction of the current block.

### SUMMARY OF THE INVENTION

However, in a conventional method for determining a prediction direction in skip mode or direct mode, since the bidirectional prediction is always selected although, for instance, the estimation accuracy of the motion vector MvL1_A in the prediction direction 1 of the adjacent block A shown in FIG. 2 is low, a prediction picture in the skip mode or the direct mode is deteriorated, which leads to the reduction in coding efficiency.

The present invention has been conceived to solve the above problem, and an object of the present invention is to provide a moving picture coding method and a moving picture decoding method which make it possible to derive a motion vector most suitable for a current picture to be coded and to increase coding efficiency.

In order to achieve the above object, a moving picture coding method according to an aspect of the present invention is a moving picture coding method for coding, by using inter picture prediction, a current block to be coded, with reference to a reference picture list in which a reference picture index is assigned to a candidate reference picture so as to specify a reference picture to be referred to when the current block in a current picture to be coded is coded, the moving picture coding method including: determining, as one or more first candidates, one or more motion vectors and one or more reference picture index values which are used by a first adjacent block adjacent to the current block; determining, as a second candidate, one or more motion vectors used by a second adjacent block adjacent to the current block and the one or more the reference picture index values used by the first adjacent block; determining, from among the one or more first candidates and the second candidate, one or more motion vectors and one or more reference picture index values which are to be used by the current block; and coding the current block using the determined one or more motion vectors and the determined one or more reference picture index values.

With this configuration, it is possible to derive the motion vector most suitable for the current picture and the reference picture as well as to increase the coding efficiency.

Moreover, the second adjacent block may be a reference block which is included in a coded picture different from the current picture and is at a position in the coded picture which corresponds to a position of the current block in the current picture.

Furthermore, the moving picture coding method may further include specifying, from a candidate list in which candidate indexes are assigned to the one or more first candidates and the second candidate, a candidate index value corresponding to the one or more motion vectors and the one or more reference picture index values which are determined to be used by the current block.

Moreover, the moving picture coding method may further include adding the specified candidate index value to a bitstream obtained by coding the current picture.

Furthermore, the one or more motion vectors in the second candidate may be one or more motion vectors obtained by scaling, according to reference distances of the current picture and the reference picture, one or more motion vectors used by a reference block.

Moreover, in the determining as a second candidate, a reference picture index value used by an adjacent block adjacent to the left of the current block may be determined as the reference picture index value of the second candidate.

Furthermore, in the determining as a second candidate, the reference picture index value of the second candidate may be determined to be a smallest value when the reference picture index value used by the adjacent block adjacent to the left of the current block is not present.

A moving picture decoding method according to another aspect of the present invention is a moving picture decoding method for decoding, by using inter picture prediction, a current block to be decoded, with reference to a reference picture list in which a reference picture index is assigned to a candidate reference picture so as to specify a reference picture to be referred to when the current block in a current picture to be decoded is decoded, the moving picture decoding method including: determining, as one or more first candidates, one or more motion vectors and one or more reference picture index values which are used by a first adjacent block adjacent to the current block; determining, as a second candidate, one or more motion vectors used by a second adjacent block adjacent to the current block and the one or more reference picture index values used by the first adjacent block; determining, from among the one or more first candidates and the second candidate, one or more motion vectors and one or more reference picture index values which are to be used by the current block; and decoding the current block using the determined one or more motion vectors and the determined one or more reference picture index values.

With this configuration, it is possible to decode the bitstream coded using the most suitable motion vector and reference picture.

Moreover, the second adjacent block may be a reference block which is included in a decoded picture different from the current picture and is at a position in the decoded picture which corresponds to a position of the current block in the current picture.

Furthermore, the moving picture decoding method may further include: obtaining a candidate index value from a bitstream including the current picture; and determining, using the obtained candidate index value, one or more motion vectors and one or more reference picture index values which are to be used by the current block, based on a candidate list in which candidate indexes including the candidate index are assigned to the one or more first candidates and the second candidate.

Moreover, the one or more motion vectors in the second candidate may be one or more motion vectors obtained by scaling, according to reference distances of the current picture and the reference picture, one or more motion vectors used by a reference block.

Furthermore, in the determining as a second candidate, a reference picture index value used by an adjacent block adjacent to the left of the current block may be determined as the reference picture index value of the second candidate.

Moreover, in the determining as a second candidate, the reference picture index value of the second candidate may be determined to be a smallest value when the reference picture index value used by the adjacent block adjacent to the left of the current block is not present.

It is to be noted that the present invention can be realized not only as such moving picture coding method and moving picture decoding method but also as a moving picture coding apparatus, a moving picture decoding apparatus, and a moving picture coding and decoding apparatus which have, as units, the characteristic steps included in the moving picture coding method and the moving picture decoding method, and as a program causing a computer to execute the steps. Such a program can be realized as a computer-readable recording medium such as a CD-ROM, and as information, data, or a signal indicating the program. The program, the information, the data, and the signal may be distributed via a communication network such as the Internet.

The present invention makes it possible to derive the motion vector most suitable for the current picture and the reference picture and to increase the coding efficiency.

### BRIEF DESCRIPTION OF THE DRAWINGS

These and other objects, advantages and features of the invention will become apparent from the following description thereof taken in conjunction with the accompanying drawings that illustrate a specific embodiment of the present invention. In the Drawings:

FIG. 1A is a diagram showing assignment of reference picture indexes to reference pictures;

FIG. 1B is a table showing an example of a reference picture list corresponding to a B-picture;

FIG. 1C is a table showing another example of a reference picture list corresponding to a B-picture;

FIG. 2 is a diagram showing a relationship among a current block to be coded, adjacent blocks, and motion vectors of the adjacent blocks;

FIG. 3 is a block diagram showing a configuration of one embodiment of a moving picture coding apparatus using a moving picture coding method according to an implementation of the present invention;

FIG. 4 is a flow chart showing an outline of a process flow of the moving picture coding method according to the implementation of the present invention;

FIG. 5 is a flow chart showing a flow of determining a skip mode prediction direction which is performed by a skip mode prediction direction determination unit;

FIG. 6 is a flow chart showing a flow of determining an inter prediction mode which is performed by an inter prediction control unit 109;

FIG. 7 is a flow chart showing a process flow of cost CostInter calculation in a motion vector estimation mode;

FIG. 8 is a flow chart showing a process flow of cost CostDirect calculation in a direct mode;

FIG. 9 is a diagram showing a relationship among a current block to be coded, adjacent blocks, and motion vectors of the current block and the adjacent blocks;

FIG. 10 is a flow chart showing a process flow of cost CostSkip calculation in a skip mode;

FIG. 11A is a table showing examples of candidate predicted motion vectors;

FIG. 11B is a table showing an example of a code table used in performing variable-length coding on a predicted motion vector index;

FIG. 12 is a diagram showing a relationship between a current block to be coded and adjacent blocks;

FIG. 13 is a diagram showing a relationship between a co-located block of a current block to be coded and motion vectors of the co-located block;

FIG. 14 is a block diagram showing a configuration of one embodiment of a moving picture coding apparatus using a moving picture coding method according to an implementation of the present invention;

FIG. 15 is a flow chart showing an outline of a process flow of the moving picture coding method according to the implementation of the present invention;

FIG. 16 is a flow chart showing a flow of determining a skip mode prediction direction addition flag which is performed by a skip mode prediction direction addition determination unit;

FIG. 17 is a flow chart showing a process flow of cost CostSkip calculation in the skip mode;

FIG. 18 is a block diagram showing a configuration of one embodiment of a moving picture coding apparatus using a moving picture coding method according to an implementation of the present invention;

FIG. 19 is a flow chart showing an outline of a process flow of the moving picture coding method according to the implementation of the present invention;

FIG. 20 is a block diagram showing a configuration of one embodiment of a moving picture coding apparatus using a moving picture coding method according to an implementation of the present invention;

FIG. 21 is a flow chart showing an outline of a process flow of the moving picture coding method according to the implementation of the present invention;

FIG. 22 is a block diagram showing a configuration of one embodiment of a moving picture decoding apparatus using a moving picture decoding method according to an implementation of the present invention;

FIG. 23 is a flow chart showing an outline of a process flow of the moving picture decoding method according to the implementation of the present invention;

FIG. 24 is a diagram showing an example of syntax of a bitstream in the moving picture decoding method according to the implementation of the present invention;

FIG. 25 is a block diagram showing a configuration of one embodiment of a moving picture decoding apparatus using a moving picture decoding method according to an implementation of the present invention;

FIG. 26 is a flow chart showing an outline of a process flow of the moving picture decoding method according to the implementation of the present invention;

FIG. 27 is a diagram showing an example of syntax of a bitstream in the moving picture decoding method according to the implementation of the present invention;

FIG. 28 is a block diagram showing a configuration of one embodiment of a moving picture decoding apparatus using a moving picture decoding method according to an implementation of the present invention;

FIG. 29 is a flow chart showing an outline of a process flow of the moving picture decoding method according to the implementation of the present invention;

FIG. 30A is a diagram showing an example of syntax of a bitstream in the moving picture decoding method according to the implementation of the present invention;

FIG. 30B is a diagram showing another example of syntax of a bitstream in the moving picture decoding method according to the implementation of the present invention;

FIG. 31 is a block diagram showing a configuration of one embodiment of a moving picture decoding apparatus using a moving picture decoding method according to an implementation of the present invention;

FIG. 32 is a flow chart showing an outline of a process flow of the moving picture decoding method according to the implementation of the present invention;

FIG. 33A is a diagram showing an example of syntax of a bitstream in the moving picture decoding method according to the implementation of the present invention;

FIG. 33B is a diagram showing another example of syntax of a bitstream in the moving picture decoding method according to the implementation of the present invention;

FIG. 34 is a block diagram showing a configuration of one embodiment of a moving picture coding apparatus using a moving picture coding method according to an implementation of the present invention;

FIG. 35 is a flow chart showing an outline of a process flow of the moving picture coding method according to the implementation of the present invention;

FIG. 36 is a flow chart showing a flow of determining a direct mode prediction direction which is performed by a direct mode prediction direction determination unit;

FIG. 37 is a flow chart showing a flow of determining an inter prediction mode which is performed by an inter prediction control unit;

FIG. 38 is a flow chart showing a process flow of cost CostInter calculation in the motion vector estimation mode;

FIG. 39 is a flow chart showing a process flow of cost CostDirect calculation in the direct mode;

FIG. 40 is a flow chart showing a process flow of cost CostSkip calculation in the skip mode;

FIG. 41 is a block diagram showing a configuration of one embodiment of a moving picture coding apparatus using a moving picture coding method according to an implementation of the present invention;

FIG. 42 is a flow chart showing an outline of a process flow of the moving picture coding method according to the implementation of the present invention;

FIG. 43 is a block diagram showing a configuration of one embodiment of a moving picture coding apparatus using a moving picture coding method according to an implementation of the present invention;

FIG. 44 is a flow chart showing an outline of a process flow of the moving picture coding method according to the implementation of the present invention;

FIG. 45 is a block diagram showing a configuration of one embodiment of a moving picture decoding apparatus using a moving picture decoding method according to an implementation of the present invention;

FIG. 46 is a flow chart showing an outline of a process flow of the moving picture decoding method according to the implementation of the present invention;

FIG. 47 is a diagram showing an example of syntax of a bitstream in the moving picture decoding method according to the implementation of the present invention;

FIG. 48 is a block diagram showing a configuration of one embodiment of a moving picture decoding apparatus using a moving picture decoding method according to an implementation of the present invention;

FIG. 49 is a flow chart showing an outline of a process flow of the moving picture decoding method according to the implementation of the present invention;

FIG. 50A is a diagram showing an example of syntax of a bitstream in the moving picture decoding method according to the implementation of the present invention;

FIG. 50B is a diagram showing another example of syntax of a bitstream in the moving picture decoding method according to the implementation of the present invention;

FIG. 51 is a block diagram showing a configuration of one embodiment of a moving picture decoding apparatus using a moving picture decoding method according to an implementation of the present invention;

FIG. 52 is a flow chart showing an outline of a process flow of the moving picture decoding method according to the implementation of the present invention;

FIG. 53A is a diagram showing an example of syntax of a bitstream in the moving picture decoding method according to the implementation of the present invention;

FIG. 53B is a diagram showing another example of syntax of a bitstream in the moving picture decoding method according to the implementation of the present invention;

FIG. 54 is a block diagram showing a configuration of one embodiment of a moving picture coding apparatus using a moving picture coding method according to an implementation of the present invention;

FIG. 55 is a flow chart showing an outline of a process flow of the moving picture coding method according to the implementation of the present invention;

FIG. 56 is a flow chart showing a flow of determining a merge mode prediction direction which is performed by a merge mode prediction direction determination unit;

FIG. 57 is a flow chart showing a flow of determining an inter prediction mode which is performed by an inter prediction control unit;

FIG. 58 is a flow chart showing a process flow of cost CostInter calculation in the motion vector estimation mode;

FIG. 59 is a flow chart showing a process flow of cost CostMerge calculation in a merge mode;

FIG. 60 is a table showing an example of assigning merge indexes to motion vectors and reference picture indexes used in the merge mode;

FIG. 61 is a flow chart showing a process flow of cost CostSkip calculation in the skip mode;

FIG. 62 is a block diagram showing a configuration of one embodiment of a moving picture decoding apparatus using a moving picture decoding method according to an implementation of the present invention;

FIG. 63 is a flow chart showing an outline of a process flow of the moving picture decoding method according to the implementation of the present invention;

FIG. 64 is a diagram showing an example of syntax of a bitstream in the moving picture decoding method according to the implementation of the present invention;

FIG. 65 is a diagram showing an overall configuration of a content providing system for implementing content distribution services;

FIG. 66 is a diagram showing an overall configuration of a digital broadcasting system;

FIG. 67 is a block diagram showing an example of a configuration of a television;

FIG. 68 is a block diagram showing an example of a configuration of an information reproducing/recording unit that reads and writes information from or on a recording medium that is an optical disk;

FIG. 69 is a diagram showing an example of a structure of a recording medium that is an optical disk;

FIG. 70A is a diagram showing an example of a cellular phone;

FIG. 70B is a diagram showing an example of a structure of the cellular phone;

FIG. 71 is a diagram showing a structure of multiplexed data;

FIG. 72 is a diagram schematically showing how each of streams is multiplexed in multiplexed data;

FIG. 73 is a diagram showing how a video stream is stored in a stream of PES packets in more detail:

FIG. 74 is a diagram showing structures of TS packets and source packets in multiplexed data;

FIG. 75 is a diagram showing a data structure of a PMT;

FIG. 76 is a diagram showing an internal structure of multiplexed data information;

FIG. 77 is a diagram showing an internal structure of stream attribute information;

FIG. 78 is a flow chart showing steps for identifying video data;

FIG. 79 is a block diagram showing an example of a configuration of an integrated circuit for implementing the moving picture coding method and the moving picture decoding method according to each of Embodiments;

FIG. 80 is a block diagram showing a configuration for switching between driving frequencies;

FIG. 81 is a flow chart showing steps for identifying video data and switching between driving frequencies;

FIG. 82 shows an example of a look-up table in which standards of video data are associated with driving frequencies;

FIG. 83A is a diagram showing an example of a configuration for sharing a module of a signal processing unit; and

FIG. 83B is a diagram showing another example of a configuration for sharing a module of a signal processing unit.

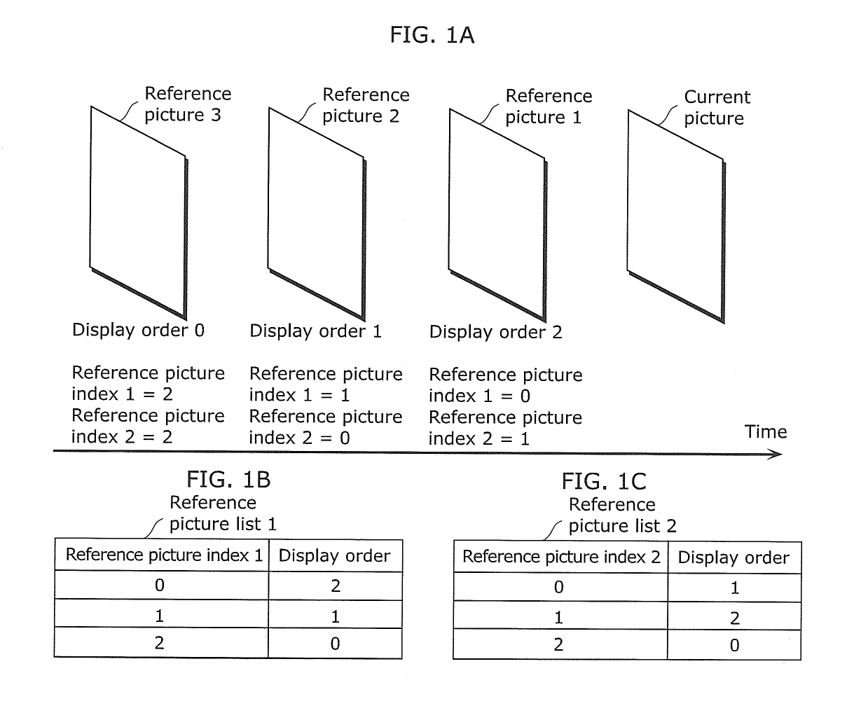

### DESCRIPTION OF THE PREFERRED EMBODIMENTS

Embodiments of the present invention are described below with reference to the drawings.

In the moving picture coding scheme, it is possible to select a coding mode called a merge mode as an inter prediction mode for each current block to be coded of a B-picture or a P-picture. In the merge mode, a motion vector and a reference picture index is copied from an adjacent block adjacent to the current block, and the current block is coded. Here, the motion vector and the reference picture index can be selected by adding, to a bitstream, an index or the like of the adjacent block used for the copy.

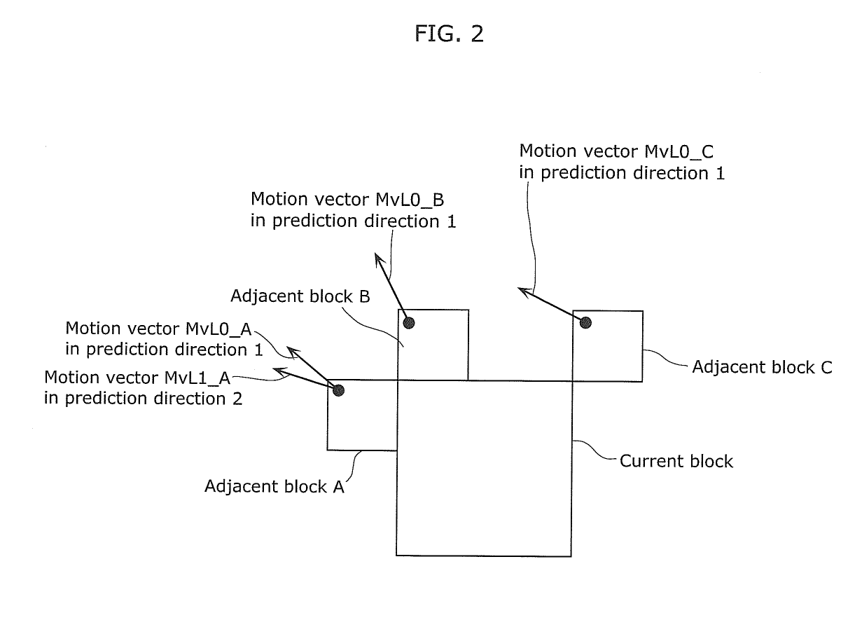

For example, in a case shown in FIG. 2, at least one motion vector and at least one reference picture index which have the best coding efficiency are selected, as a motion vector of a current block to be coded and a reference picture index, from among motion vectors and reference picture indexes for adjacent blocks A, B, and C and motion vectors and reference picture indexes in a temporal prediction motion vector mode which are calculated using a co-located block. Then, a merge index indicating the selected adjacent block is added to a bitstream. For instance, when the adjacent block A is selected, the current block is coded using motion vectors MvL0_A and MvL1_A in the respective prediction directions 1 and 2 of the adjacent block A and reference picture indexes for reference pictures referred to by the respective motion vectors, and only the merge index indicating that the adjacent block A has been used is added to the bitstream. As a result, it is possible to reduce amounts of information of the motion vectors or the reference picture indexes.

However, in a method for determining a prediction direction in merge mode, when the adjacent block A shown in FIG. 2 is, for example, a copy source, since bidirectional prediction is always selected although the estimation accuracy of the motion vector MvL1_A in the prediction direction 1 of the adjacent block A is low, a prediction picture in the merge mode is deteriorated, which leads to the reduction in coding efficiency.

### Embodiment 1

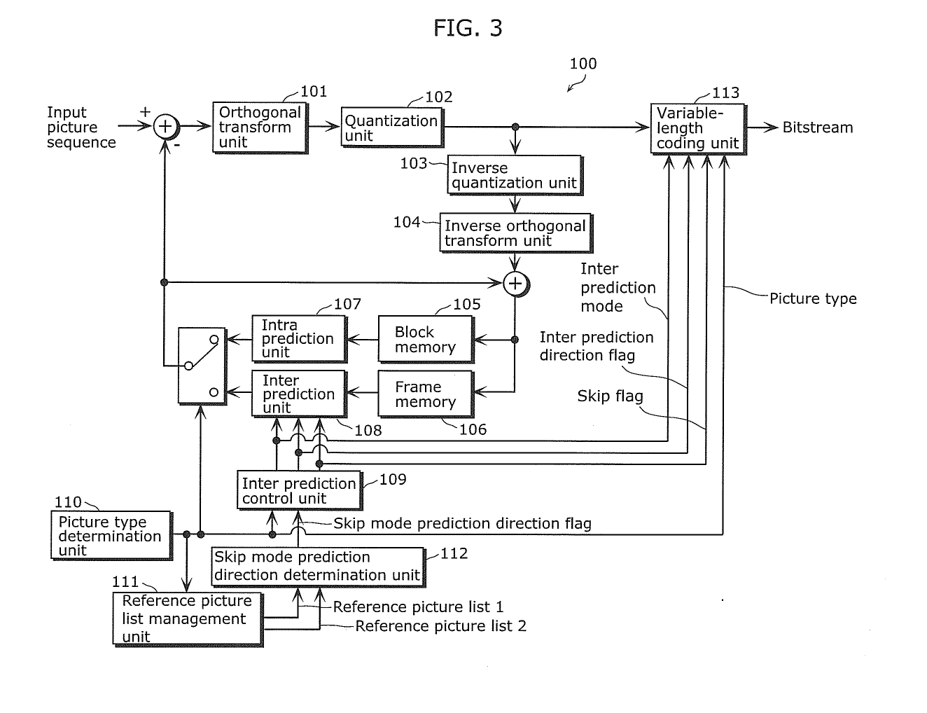

FIG. 3 is a block diagram showing a configuration of a moving picture coding apparatus using a moving picture coding method according to Embodiment 1 of the present invention.

A moving picture coding apparatus 100 includes, as shown in FIG. 3, an orthogonal transform unit 101, a quantization unit 102, an inverse quantization unit 103, an inverse orthogonal transform unit 104, a block memory 105, a frame memory 106, an intra prediction unit 107, an inter prediction unit 108, an inter prediction control unit 109, a picture type determination unit 110, a reference picture list management unit 111, a skip mode prediction direction determination unit 112, and a variable-length coding unit 113. The orthogonal transform unit 101 transforms, from image domain into frequency domain, prediction error data between prediction picture data generated by a unit to be described later and an input picture sequence. The quantization unit 102 performs a quantization process on the prediction error data transformed into the frequency domain. The inverse quantization unit 103 performs an inverse quantization process on the prediction error data on which the quantization unit 102 has performed the quantization process. The inverse orthogonal transform unit 104 transforms, from frequency domain into image domain, the prediction error data on which the inverse quantization process has been performed. The block memory 105 stores, in units of blocks, a decoded picture obtained from the prediction picture data and the prediction error data on which the inverse quantization process has been performed. The frame memory 106 stores the decoded picture in units of frames. The picture type determination unit 110 determines which one of the picture types, I-picture, B-picture, and P-picture, is used to code the input picture sequence, and generates picture type information. The intra prediction unit 107 generates prediction picture data by performing intra prediction on a current block to be coded, using the decoded picture stored in the units of blocks in the block memory 105. The inter prediction unit 108 generates prediction picture data by performing inter prediction on the current block, using the decoded picture stored in the units of frames in the block memory 106.

The inter prediction control unit 109 compares a cost of a motion vector estimation mode in which a prediction picture is generated using a motion vector obtained by motion estimation, a cost of a direct mode in which a prediction picture is generated using a predicted motion vector generated from an adjacent block or the like, and a cost of a skip mode in which a prediction picture is generated using a predicted motion vector generated according to a prediction direction determined by the skip mode prediction direction determination unit 112, and determines a more efficient inter prediction mode from among the three modes.

The reference picture list management unit 111 assigns reference picture indexes to coded reference pictures to be referred to in the inter prediction, and creates reference picture lists together with display order and so on.

It is to be noted that although the reference pictures are managed based on the reference picture indexes and the display order in this embodiment, the reference pictures may be managed based on the reference picture indexes, coding order, and so on.

The skip mode prediction direction determination unit 112 determines, through a method to be described later, a prediction direction in the skip mode for the current block, using reference picture lists 1 and 2 created by the reference picture list management unit 111.

The variable-length coding unit 113 generates a bitstream by performing a variable length coding process on the prediction error data on which the quantization process has been performed, an inter prediction mode, an inter prediction direction flag, a skip flag, and picture type information.

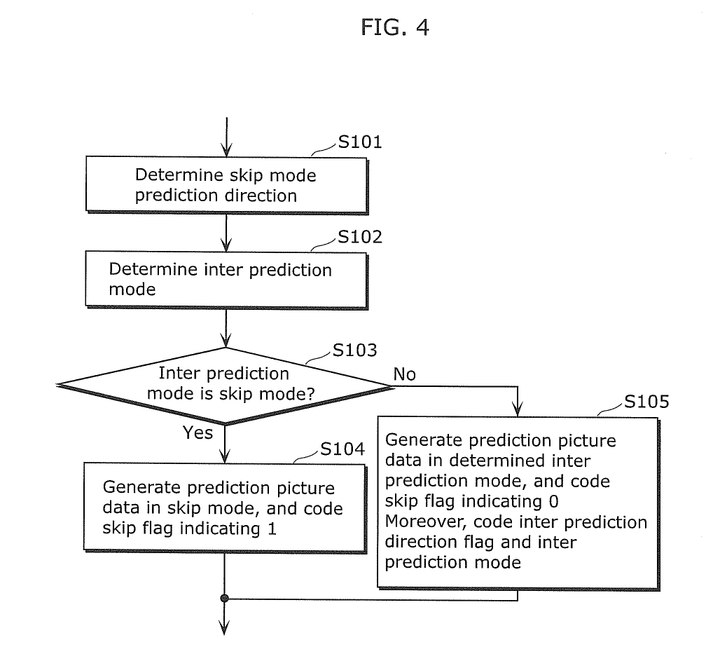

FIG. 4 is a flow chart showing an outline of a process flow of the moving picture coding method according to the implementation of the present invention.

The skip mode prediction direction determination unit 112 determines a prediction direction in the case of coding a current block to be coded in the skip mode (Step S101). The inter prediction control unit 109 compares a cost of the motion vector estimation mode in which a prediction picture is generated using a motion vector obtained by motion estimation, a cost of the direct mode in which a prediction picture is generated using a predicted motion vector generated from an adjacent block or the like, and a cost of the skip mode in which a prediction picture is generated using a predicted motion vector generated according to the prediction direction determined by the skip mode prediction direction determination unit 112, and determines a more efficient inter prediction mode from among the three modes (Step S102). The method for calculating a cost is to be described later. Next, the inter prediction control unit 109 determines whether or not the determined inter prediction mode is the skip mode (Step S103). When it is determined that the inter prediction mode is the skip mode (Yes in Step S103), the inter prediction control unit 109 generates a prediction picture in the skip mode and sets a skip flag to indicate 1. Then, the inter prediction control unit 109 sends the skip flag to the variable-length coding unit 113 so that the skip flag is added to a bitstream of the current block (Step S104). On the other hand, when it is determined that the inter prediction mode is not the skip mode (No in Step S103), the inter prediction control unit 109 performs inter prediction according to the determined inter prediction mode, generates prediction picture data, and sets the skip flag to indicate 0. Then, the inter prediction control unit 109 sends the skip flag to the variable-length coding unit 113 so that the skip flag is added to the bitstream of the current block. Moreover, the inter prediction control unit 109 sends, to the variable-length coding unit 113, the inter prediction mode indicating the motion vector estimation mode or the direct mode and the inter prediction direction flag so that the inter prediction mode and the inter prediction direction flag are added to the bitstream of the current block (Step S105).

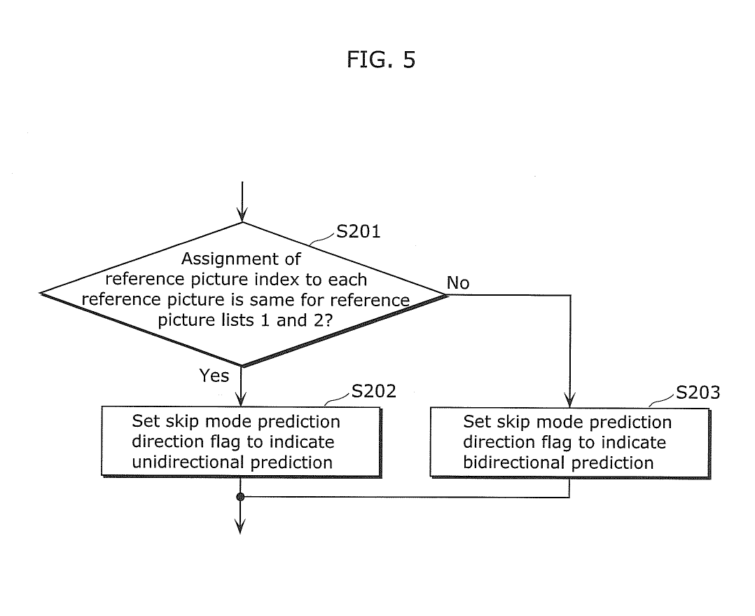

FIG. 5 is a flow chart showing a flow of determining a skip mode prediction direction which is performed by the skip mode prediction direction determination unit 112.

In general, when the assignment of the reference picture index to each reference picture is the same for the reference picture lists 1 and 2, although the motion vectors in the prediction directions 1 and 2 are selected in the bidirectional prediction, there are a case where only the motion vector in the prediction direction 1 is used in the unidirectional prediction and a case where the motion vector in the prediction direction 2 is overall reduced. For instance, when the assignment of the reference picture index to each reference picture is the same for the reference picture lists 1 and 2, unidirectional prediction using the reference picture list 2 is prohibited, and thus it is possible to increase the coding efficiency by reducing an amount of coded data of an inter prediction direction flag. In this case, only the motion vector in the prediction direction 1 is used in the unidirectional prediction, and thus the motion vector in the prediction direction 2 is overall reduced. Here, if the bidirectional prediction is selected as the prediction direction in the skip mode, there is a tendency that the motion vector in the predicted direction 2 of an adjacent block which can be used in generating a predicted motion vector in the prediction direction 2 is reduced, and thus there is a possibility that the accuracy of the predicted motion vector in the prediction direction 2 becomes low. For this reason, when the assignment of the reference picture index to each reference picture is the same for the reference picture lists 1 and 2, it is possible to increase the coding efficiency by fixing the prediction direction in the skip mode to the unidirectional prediction.

The skip mode prediction direction determination unit 112 determines whether or not the assignment of the reference picture index to each reference picture is the same for the reference picture lists 1 and 2, using the reference picture lists 1 and 2 (Step S201). For example, the display orders of the reference pictures indicated by the respective reference picture indexes 1 are obtained from the reference picture list 1 and are compared to the display orders of the reference pictures indicated by the respective reference picture indexes 2 in the reference picture list 2. When the display orders are the same, it is possible to determine that the assignment is the same for the reference picture lists 1 and 2. When it is determined that the assignment of the reference picture index to each reference picture is the same for the reference picture lists 1 and 2 (Yes in Step S201), the skip mode prediction direction determination unit 112 sets a skip mode prediction direction flag to the unidirectional prediction (Step S202). On the other hand, when it is determined that the assignment of the reference picture index to each reference picture is not the same for the reference picture lists 1 and 2 (No in Step S201), the skip mode prediction direction determination unit 112 sets the skip mode prediction direction flag to the bidirectional prediction (Step S203).

It is to be noted that although it is determined in Step 201 whether or not the assignment of the reference picture index to each reference picture is the same for the reference picture lists 1 and 2 in this embodiment, the determination may be made using coding order or the like.

Moreover, although the prediction direction in the skip mode is fixed to the unidirection when it is determined that the assignment of the reference picture index to each reference picture is the same for the reference picture lists 1 and 2 in this embodiment, the prediction direction in the skip mode may be fixed to the unidirection when a reference picture indicated by the reference picture index 1 of the prediction direction 1 is the same as a reference picture indicated by the reference picture index 2 of the prediction direction 2 in the skip mode corresponding to the current block. For example, the display order of the reference picture indicated by the reference picture index 1 is obtained from the reference picture list 1 and is compared to the display order of the reference picture indicated by the reference picture index 2 in the reference picture list 2. When the display orders are the same, it is possible to determine that the pictures are the same for the reference picture lists 1 and 2. Even in such a case, the motion vectors in the prediction directions 1 and 2 are selected in the bidirectional prediction. However, there is the case where only the motion vector in the prediction direction 1 is used in the unidirectional prediction and the motion vector in the prediction direction 2 is overall reduced. As a result, it is possible to increase the coding efficiency by fixing the prediction direction in the skip mode to the unidirectional prediction.

Moreover, when a current picture to be coded is a B-picture coded by using a bidirectional prediction picture with reference to two coded pictures located before the current picture, the prediction direction in the skip mode may be fixed to the unidirectional prediction. For such a B-picture, there is a case where the assignment of the reference picture index to each reference picture is the same for the reference picture lists 1 and 2 or a case where the reference picture indicated by the reference picture index 1 of the prediction direction 1 is the same as the reference picture indicated by the reference picture index 2 of the prediction direction 2 in the skip mode corresponding to the current block. Even in such a case, the motion vectors in the prediction directions 1 and 2 are selected in the bidirectional prediction. However, there is the case where only the motion vector in the prediction direction 1 is used in the unidirectional prediction and the motion vector in the prediction direction 2 is overall reduced. As a result, it is possible to increase the coding efficiency by fixing the prediction direction in the skip mode to the unidirectional prediction.

Moreover, when the current picture is a B-picture coded by using the bidirectional prediction picture with reference to two coded pictures located after the current picture, the prediction direction in the skip mode may be fixed to the unidirectional prediction. For such a B-picture, there is the case where the assignment of the reference picture index to each reference picture is the same for the reference picture lists 1 and 2 or the case where the reference picture indicated by the reference picture index 1 of the prediction direction 1 is the same as the reference picture indicated by the reference picture index 2 of the prediction direction 2 in the skip mode corresponding to the current block. Even in such a case, the motion vectors in the prediction directions 1 and 2 are selected in the bidirectional prediction. However, there is the case where only the motion vector in the prediction direction 1 is used in the unidirectional prediction and the motion vector in the prediction direction 2 is overall reduced. As a result, it is possible to increase the coding efficiency by fixing the prediction direction in the skip mode to the unidirectional prediction.

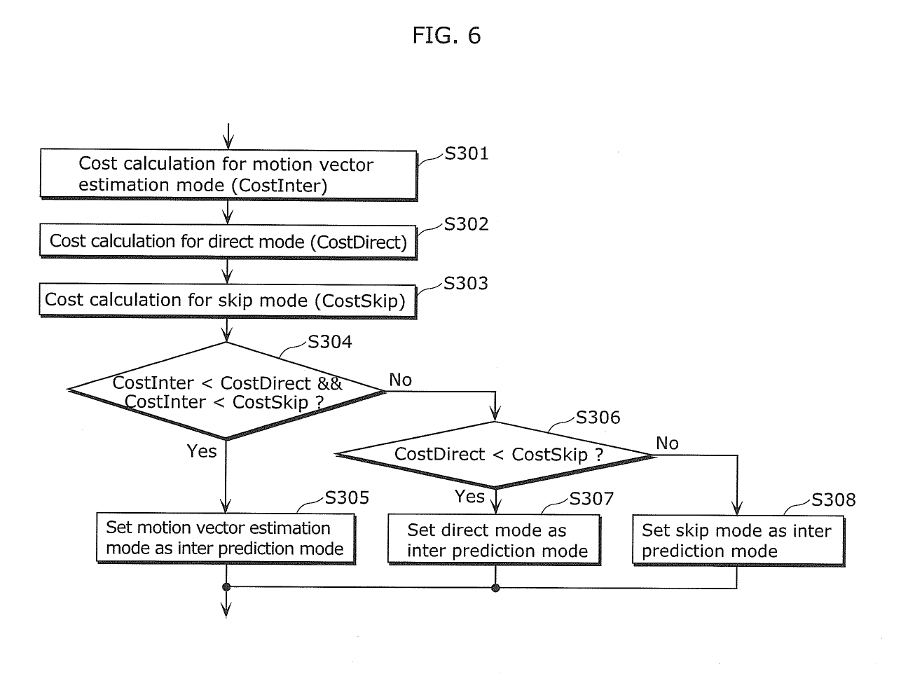

FIG. 6 is a flow chart showing a flow of determining an inter prediction mode which is performed by the inter prediction control unit 109.

The inter prediction control unit 109 calculates, through a method to be described later, cost CostInter of the motion vector estimation mode in which the prediction picture is generated using the motion vector obtained by the motion estimation (Step S301). The inter prediction control unit 109 calculates, through a method to be described later, cost CostDirect of the direct mode in which a predicted motion vector is generated using the motion vector of the adjacent block or the like and the prediction picture is generated using the predicted motion vector (Step S302). The inter prediction control unit 109 calculates, through a method to be described later, cost CostSkip of the skip mode in which the prediction picture is generated according to the skip mode prediction direction flag determined by the skip mode prediction direction determination unit 112 (Step S303). The inter prediction control unit 109 compares the cost CostInter of the motion vector estimation mode, the cost CostDirect of the direct mode, and the cost CostSkip of the skip mode, and determines whether or not the cost CostInter of the motion vector estimation mode is smallest (Step S304). When it is determined that the cost CostInter of the motion vector estimation mode is smallest (Yes in Step S304), the inter prediction control unit 109 determines and sets the motion vector estimation mode as the inter prediction mode (Step S305). On the other hand, when it is determined that the cost CostInter of the motion vector estimation mode is not smallest (No in Step S304), the inter prediction control unit 109 compares the cost CostDirect of the direct mode and the cost CostSkip of the skip mode, and determines whether or not the cost CostDirect of the direct mode is smaller (Step S306). When it is determined that the cost CostDirect of the direct mode is smaller (Yes in Step S306), the inter prediction control unit 109 determines the direct mode as the inter prediction mode, and sets the direct mode to inter prediction mode information (Step S307). On the other hand, when it is determined that the cost CostDirect of the direct mode is not smaller (No in Step S306), the inter prediction control unit 109 sets the skip mode as the inter prediction mode and to the inter prediction mode information (Step S308).

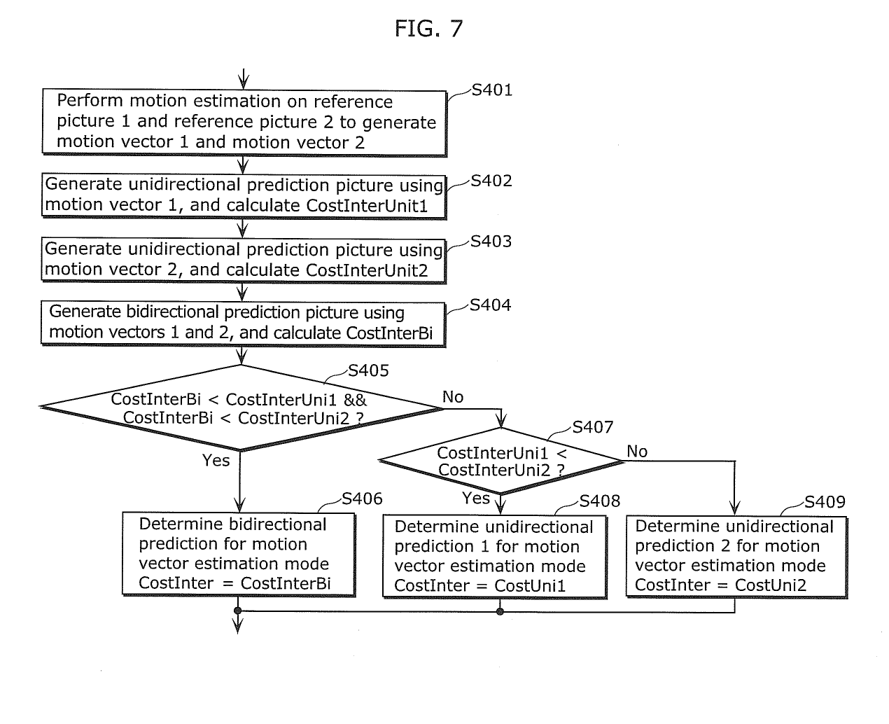

The following describes in detail the cost CostInter calculation method used in Step S301 shown in FIG. 6, with reference to FIG. 7. FIG. 7 is a flow chart showing a process flow of cost CostInter calculation in the motion vector estimation mode.

The inter prediction control unit 109 performs motion estimation on a reference picture 1 indicated by a reference picture index 1 of the prediction direction 1 and a reference picture 2 indicated by a reference picture index 2 of the prediction direction 2, so as to generate the motion vector 1 and the motion vector 2 corresponding to the respective reference pictures (Step S401). Here, the motion estimation refers to calculating a difference value between a current block to be coded in a picture to be coded and a block in a reference picture, using a block having the smallest difference value in the reference picture as a reference block, and calculating a motion vector based on a position of the current block and a position of the reference block. Next, the inter prediction control unit 109 generates a prediction picture in the prediction direction 1 using the generated motion vector 1, and calculates cost CostInterUni1 of the prediction picture by, for instance, the following equation of the R-D optimization model (Step S402).

Cost=D+λ×R (Equation 1)

In Equation 1, D represents cording distortion, and, for example, a sum of absolute differences between pixel values obtained by coding and decoding a current block using a prediction picture generated using a motion vector and an original pixel value of the current block is substituted for D. R represents an amount of generated coded data, and, for instance, an amount of coded data necessary for coding a motion vector used in generating a prediction picture is substituted for R. λ is an undetermined multiplier in the Lagrange's method. Then, the inter prediction control unit 109 generates a prediction picture in the prediction direction 2 using the generated motion vector 2, and calculates cost CostInterUni2 by Equation 1 (Step S403). Next, the inter prediction control unit 109 generates a bidirectional prediction picture using the generated motion vectors 1 and 2, and calculates cost CostInterBi by Equation 1 (Step S404). Here, the bidirectional prediction picture is, for instance, a bidirectional prediction picture obtained by performing, for each pixel, averaging on the prediction picture generated using the motion vector 1 and the prediction picture generated using the motion vector 2. The inter prediction control unit 109 compares the values of the cost CostInterUni1, the cost CostInterUni2, and the cost CostInterBi, and determines whether or not the cost CostInterBi is smallest (Step S405). When it is determined that the cost CostInterBi is smallest (Yes in Step S405), the inter prediction control unit 109 determines the bidirectional prediction for the prediction direction in the motion vector estimation mode, and sets the cost CostInterBi to the cost CostInter of the motion vector estimation mode (Step S406). On the other hand, when it is determined that the cost CostInterBi is not smallest (No in Step S405), the inter prediction control unit 109 compares the cost CostInterUni1 and the cost CostInterUni2, and determines whether or not the value of the cost CostInterUni1 is smaller (Step S407). When it is determined that the value of the cost CostInterUni1 is smaller (Yes in Step S407), the inter prediction control unit 109 determines unidirectional prediction 1 of the prediction direction for the motion vector estimation mode, and sets the cost CostInterUni1 to the cost CostInter of the motion vector estimation mode (Step S408). On the other hand, when it is determined that the value of the cost CostInterUni1 is not smaller (No in Step S407), the inter prediction control unit 109 determines unidirectional prediction 2 of the prediction direction 2 for the motion vector estimation mode, and sets the cost CostInterUni2 to the cost CostInter of the motion vector estimation mode (Step S409).

It is to be noted that although the averaging is performed for each pixel when the bidirectional prediction picture is generated in this embodiment, weighted averaging may be performed.

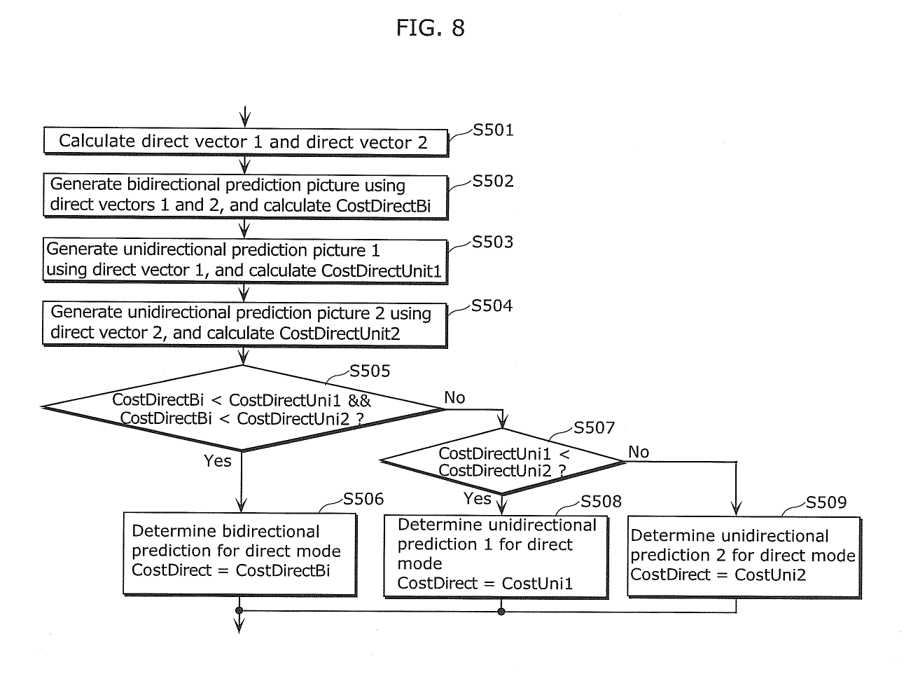

The following describes in detail the cost CostDirect calculation method used in Step S302 shown in FIG. 6, with reference to FIG. 8. FIG. 8 is a flow chart showing a process flow of cost CostDirect calculation in the direct mode.

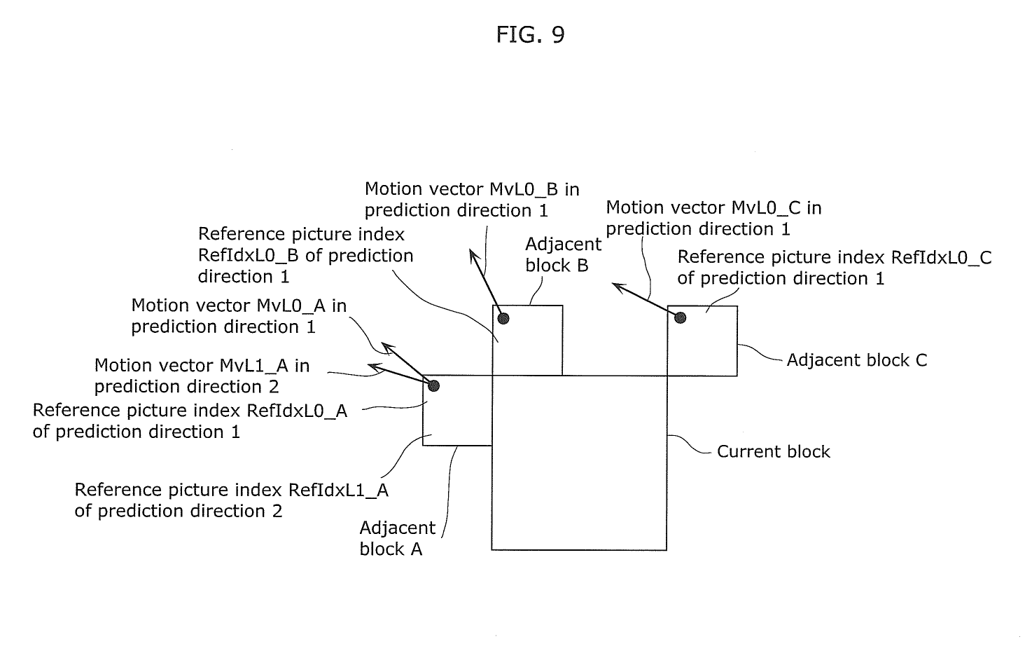

The inter prediction control unit 109 calculates the direct vector 1 in the prediction direction 1 and the direct vector 2 in the prediction direction 2 (Step S501). Here, the direct vectors are calculated using, for example, a motion vector of an adjacent block. A specific example is described with reference to FIG. 9.

FIG. 9 is a diagram showing a relationship among a current block to be coded, adjacent blocks, and motion vectors of the current block and the adjacent blocks. In FIG. 9, a coded block adjacent to the left of a current block is an adjacent block A, a coded block adjacent to the top of the current block is an adjacent block B, and a coded block adjacent to the top right of the current block is an adjacent block C.

Moreover, in FIG. 9, the bidirectional prediction is used for the adjacent block A having (i) a motion vector MvL0_A in the prediction direction 1 which refers to a reference picture indicated by a reference picture index RefIdxL0_A of the prediction direction 1 and (ii) a motion vector MvL1_A in the prediction direction 2 which refers to a reference picture indicated by a reference picture index RefIdxL1_A of the prediction direction 2. Furthermore, the unidirectional prediction is used for the adjacent block B having a motion vector MvL0_B in the prediction direction 1 which refers to a reference picture indicated by a reference picture index RefIdxL0_B of the prediction direction 1. Moreover, the unidirectional prediction is used for the adjacent block C having a motion vector MvL0_C in the prediction direction 1 which refers to the reference picture indicated by a reference picture index of the prediction direction 1.

In calculating direct vectors, first, values of a reference picture index RefIdxL0 of the prediction direction 1 and a reference picture index RefIdxL1 of the prediction direction 2 which correspond to the current block are determined. For instance, it is conceivable that the reference picture indexes RefIdxL0 and RefIdxL1 having the value “0” are always used in the direct mode.

It is to be noted that although the value “0” is always used as the value of each reference picture index for the current block in the direct mode in this embodiment, a reference picture index indicating a reference picture which is more frequently referred to by an adjacent block may be calculated based on a value of a reference picture index for the adjacent block or the like. For example, in FIG. 7, when a value of each reference picture index can be “0” or “1”, it is conceivable that a median value Median (RefIdxL0_A, RefIdxL0_B, RefIdxL0_C) among RefIdxL0_A, RefIdxL0_B, and RefIdxL0_C is calculated as the reference picture index RefIdxL0 for the current block in the prediction direction 1. Here, the median value is calculated as shown by following Equations 2 to 4.

$$\begin{matrix}Median ( x , y , z ) = x + y + z - Min ( x , Min ( y , z ) ) - Max ( x , Max ( y , z ) ) & ( Equation 2 ) \\ Min ( x , y ) = \{ \begin{matrix}x & ( x \leq y ) \\ y & ( x > y )\end{matrix} & ( Equation 3 ) \\ Max ( x , y ) = \{ \begin{matrix}x & ( x \geq y ) \\ y & ( x < y )\end{matrix} & ( Equation 4 )\end{matrix}$$

The reference picture index indicating the reference picture which is more frequently referred to by the adjacent block is used as the reference picture index for the current block, and thus prediction accuracy of the direct vector is increased. As a result, it is possible to increase the coding efficiency. It is to be noted that although the above example of this embodiment shows the example where the reference picture index indicating the reference picture which is more frequently referred to by the adjacent block is calculated using the median value, the present invention is not limited to this. For instance, an identical relation between reference picture indexes for adjacent blocks may be examined and calculated. Furthermore, when all values of reference picture indexes for adjacent blocks are different from each other, a reference picture index which indicates, among reference pictures indicated by the reference picture indexes, a reference picture closest to a current picture to be coded in display order may be used as the reference picture index for the current block

Moreover, the reference picture index which indicates, among reference pictures referred to by the adjacent block, the reference picture closest to the current picture in display order may be assigned as the value of the reference picture index for the current block in the direct mode. For example, in the case shown in FIG. 9, it is conceivable that the smallest value Min (RefIdxL0_A, RefIdxL0_B, or RefIdxL0_C) among RefIdxL0_A, RefIdxL0_B, and RefIdxL0_C is calculated as the reference picture index RefIdxL0 for the current block in the prediction direction 1. Here, the smallest value is calculated as shown by Equation 5.

Min(x,y,z)=Min(x,Min(y,z)) (Equation 5)

In general, it is highly likely that a smaller value of a reference picture index is assigned to a reference picture that is closer to the current picture in display order, and thus it is possible to calculate a reference picture index which indicates a reference picture closest to the current picture in display order, by calculating the smallest value of the reference picture index. It is to be noted that the reference picture index which indicates the reference picture closest to the current picture in display order may be calculated by obtaining a display order of each reference picture from reference picture indexes for adjacent blocks and reference picture lists.

Direct vectors are calculated from calculated reference picture index for a current block and motion vectors and reference picture indexes for adjacent blocks. For instance, a direct vector is calculated from a median value Median (MvL0_A, MvL0_B, MvL0_C) among MvL0_A, MvL0_B, and MvL0_C that are the motion vectors of the respective adjacent blocks. The direct vector 1 in the prediction direction 1 is calculated by Equation 2 using the motion vector in the prediction direction 1 of the adjacent block. Moreover, the direct vector 2 in the prediction direction 2 is calculated by Equation 2 using the motion vector in the prediction direction 2 of the adjacent block. Here, when the value of the reference picture index for the current block is different from that of the reference picture index for the adjacent block, the median value may be calculated with the motion vector of the adjacent block being “0”.

Moreover, when there is no adjacent block having the same value of a reference picture index as that of the reference picture index for the current block, a motion vector having the value “0” may be used as the direct vector.

Then, the inter prediction control unit 109 generates a bidirectional prediction picture using the calculated direct vectors 1 and 2, and calculates cost CostDirectBi of the bidirectional prediction picture by Equation 1 (Step S502). Here, the bidirectional prediction picture is, for instance, a bidirectional prediction picture obtained by performing, for each pixel, averaging on the prediction picture generated using the motion vector 1 and the prediction picture generated using the motion vector 2. The inter prediction control unit 109 generates a prediction picture in the prediction direction 1 using the calculated direct vector 1, and calculates cost CostDirectUni1 of the prediction picture by Equation 1 (Step S503). The inter prediction control unit 109 generates a prediction picture in the prediction direction 2 using the calculated direct vector 2, and calculates cost CostDirectUni2 by Equation 1 (Step S504). Next, the inter prediction control unit 109 compares a value of the cost CostDirectUni1, a value of the cost CostDirectUni2, and a value of the cost CostDirectBi, and determines whether or not the cost CostDirectBi is smallest (Step S505). When it is determined that the cost CostDirectBi is smallest (Yes in Step S505), the inter prediction control unit 109 determines the bidirectional prediction for the prediction direction in the direct mode, and sets the cost CostDirectBi to the cost CostDirect in the direct mode (Step S506). On the other hand, when it is determined that the cost CostDirectBi is not smallest (No in Step S505), the inter prediction control unit 109 compares the cost CostDirectUni1 and the cost CostDirectUni2, and determines whether or not the value of the cost CostDirectUni1 is smaller (Step S507). When it is determined that the value of the cost CostDirectUni1 is smaller (Yes in Step S507), the inter prediction control unit 109 determines the unidirectional prediction 1 in the prediction direction 1 for the direct mode, and sets the cost CostDirectUni1 to the cost CostDirect in the direct mode (Step S508). On the other hand, when it is determined that the value of the cost CostDirectUni1 is not smaller (No in Step S507), the inter prediction control unit 109 determines the unidirectional prediction 2 in the prediction direction 2 for the direct mode, and sets the cost CostDirectUni2 to the cost CostDirect in the direct mode (Step S509).

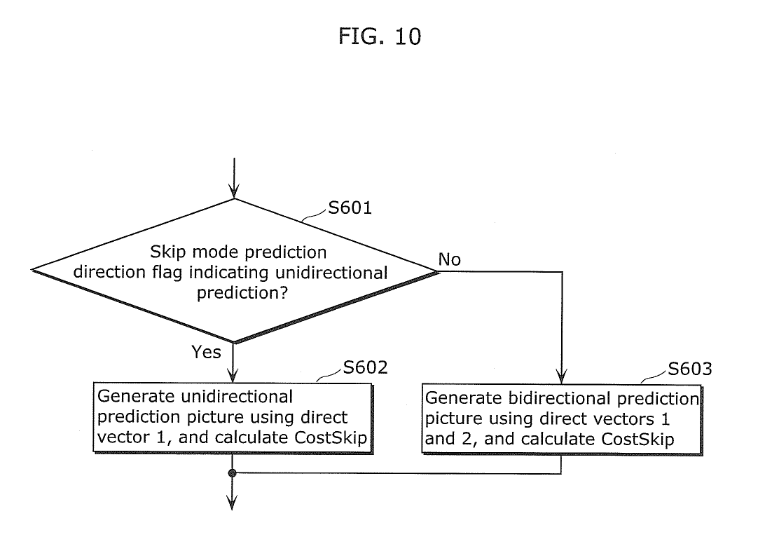

The following describes in detail the cost CostSkip calculation method used in Step S303 shown in FIG. 6, with reference to FIG. 10. FIG. 10 is a flow chart showing a process flow of cost CostSkip calculation in the skip mode.

The inter prediction control unit 109 determines whether or not the skip mode prediction direction flag determined by the skip mode prediction direction determination unit 112 indicates the unidirectional prediction (Step S601). When it is determined that the skip mode prediction direction flag indicates the unidirectional prediction (Yes in Step S601), the inter prediction control unit 109 generates a prediction picture in the prediction direction 1 using the direct vector 1 calculated in Step S501 of FIG. 8, and calculates cost CostSkip in the skip mode by Equation 1 (Step S602). On the other hand, when it is determined that the skip mode prediction direction flag does not indicate the unidirectional prediction (No in Step S601), the inter prediction control unit 109 generates a bidirectional prediction picture using the direct vectors 1 and 2 calculated in Step S501 of FIG. 8, and calculates cost CostSkip in the skip mode by Equation 1 (Step S603). Here, the bidirectional prediction picture is, for instance, a bidirectional prediction picture obtained by performing, for each pixel, averaging on the prediction picture generated using the motion vector 1 and the prediction picture generated using the motion vector 2.

It is to be noted that although this embodiment has described the example of generating the unidirectional prediction picture using the direct vector 1 when the skip mode prediction direction flag indicates the unidirectional prediction, the unidirectional prediction picture may be generated using the direct vector 2 throughout the whole embodiment.

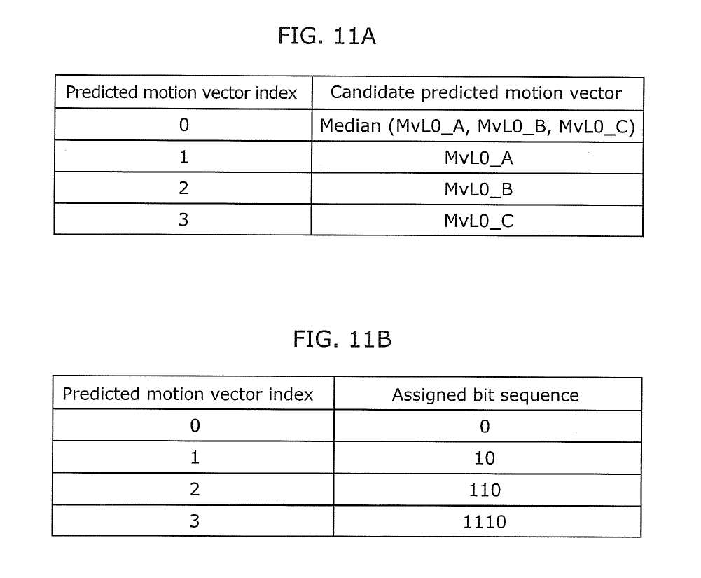

It is also to be noted that although this embodiment has described, as the direct vector calculation method, the example of calculating the median value Median (MvL0_A, MvL0_B, MvL0_C) among the MvL0_A, the MvL0_B, and the MvL0_C, the present invention is not limited to this calculation method. For example, a predicted motion vector having the smallest Cost may be selected, as a direct vector to be used for coding, from among candidate predicted motion vectors, and a predicted motion vector index indicating the selected predicted motion vector may be added to a bitstream. Here, the Cost is calculated by Equation 1, for instance. As stated above, it is possible to derive a direct vector having smaller Cost, by selecting, from among the candidates, a direct vector to be used for coding. FIG. 11A is a table showing examples of candidate predicted motion vectors. A value of a predicted motion vector index corresponding to the Median (MvL0_A, MvL0_B, MvL0_C) is “0”, a value of a predicted motion vector index corresponding to the MvL0_A is “1”, a value of a predicted motion vector corresponding to the MvL0_B is “2”, and a value of a predicted motion vector corresponding to the MvL0_C is “3”. A method of assigning a predicted motion vector index is not limited to this example. FIG. 11B shows an example of a code table used in performing variable-length coding on a predicted motion vector index corresponding to the candidate predicted motion vector having the smallest Cost. A code having a shorter code length is assigned in ascending order of a value of a predicted motion vector index. Thus, it is possible to increase the coding efficiency by reducing a value of a predicted motion vector index corresponding to a candidate predicted motion vector that is highly likely to have high prediction accuracy.

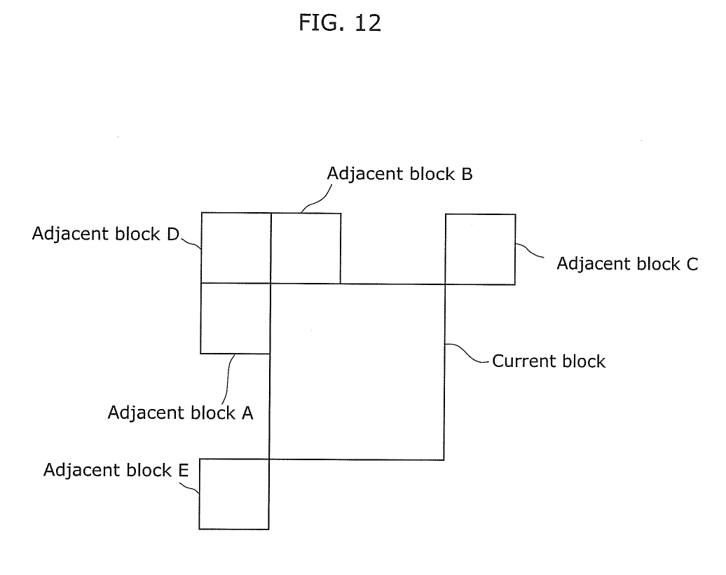

Furthermore, although this embodiment has described the example of using, for the calculation of the reference picture index for the current block and the direct vector, the reference picture indexes and the motion vectors for the respective adjacent blocks A, B, and C shown in FIG. 9, the present invention is not necessarily limited to the example. For example, as shown in FIG. 12, an adjacent block D or an adjacent block E may be used. When a motion vector in the prediction direction 1 of the adjacent block C is not used because, for instance, a reference picture index for the adjacent block C in the prediction direction 1 is different from the reference picture index for the current block in the prediction direction 1, it is conceivable that the adjacent block D or E is used instead. In this case also, it may be determined whether or not the motion vector of the adjacent block D or E is to be used, depending on whether or not a reference picture index for the adjacent block D or E in the prediction direction 1 matches the reference picture index for the current block.

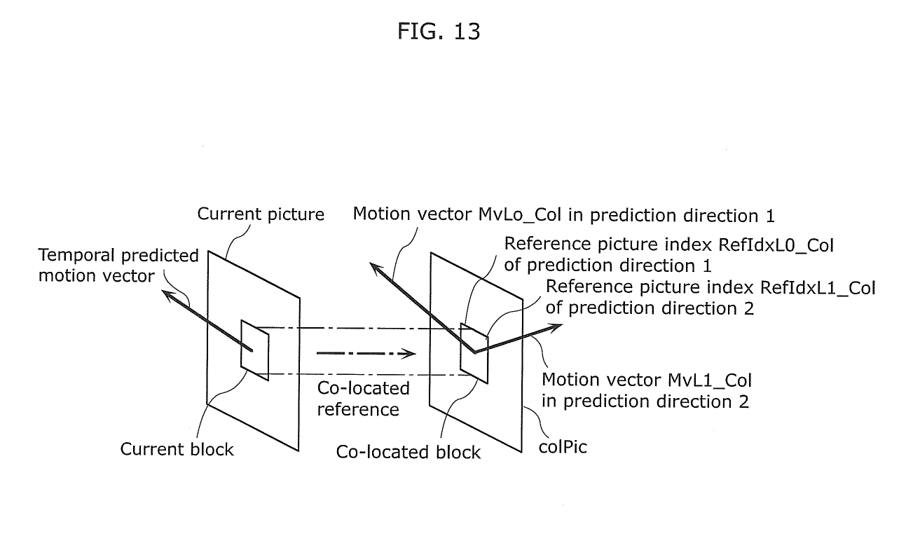

Furthermore, although this embodiment has described the example of using, for the calculation of the reference picture index for the current block and the direct vector, the reference picture indexes and the motion vectors for the respective adjacent blocks A, B, and C shown in FIG. 9, the present invention is not necessarily limited to the example. For example, as shown in FIG. 13, a co-located block corresponding to the current block may be used. Here, the co-located block is a block that is in a picture different from a picture including a current block to be coded and is co-located, in the picture including the block, with the current block. Moreover, it is possible to switch, using a flag or the like, whether a block included in a picture located before the current picture in display time order (hereinafter, referred to as a forward reference block) or block included in a picture located after the current picture in display time order (hereinafter, referred to as a backward reference block) is the co-located block. FIG. 13 shows a case where the co-located block is the backward reference block. When a value of a reference picture index is calculated from the co-located block shown in FIG. 13, an adjacent block, and the like, it is conceivable that, for instance, a reference picture index indicating a reference picture most frequently referred to by the adjacent block and the co-located block is a reference picture index of a current picture to be coded. More specifically, when the reference picture index for the current block in the prediction direction 1 is calculated, it is conceivable to assign, to the reference picture index for the current block, a value of a reference picture index indicating a reference picture most frequently referred to among reference pictures indicated by the reference picture indexes RefIdxL0_A, RefIdxL0_B, and RefIdxL0_C for the respective adjacent blocks A, B, and C shown in FIG. 9 and by a reference picture index RefIdxL0Co1 for the co-located block shown in FIG. 13. Furthermore, when all the reference pictures indicated by the reference picture indexes for the adjacent blocks and the co-located block are different from each other, a reference picture index which indicates, among the reference pictures indicated by the reference picture indexes, a reference picture closest to the current picture in display order may be used as the reference picture index for the current block. Moreover, the reference picture index which indicates, among reference pictures referred to by the adjacent blocks and the co-located block, the reference picture closest to the current picture in display order may be assigned as the value of the reference picture index for the current block in the direct mode. For example, the value of the reference picture index for the current block can be calculated from the smallest value or the like of the reference picture indexes for the adjacent blocks and the co-located block.

Moreover, when a direct vector is calculate from the co-located block shown in FIG. 13, for instance, it is conceivable that a motion vector of the co-located block is scaled or the like in accordance with a reference distance, to calculate a direct vector of the current block. More specifically, when a direct vector in the prediction direction 1 of the current block shown in FIG. 13, it is conceivable that a motion vector in the prediction direction 1 of the co-located block is scaled using a reference picture index RfIdxL0_Co1 for the co-located block in the prediction direction 1, to calculate the direct vector of the reference picture indicated by the reference picture index for the current block.

Moreover, although this embodiment has given the description using the direct mode as the example of calculating the reference picture index or the motion vector of the current block using the adjacent block and the co-located block, the present invention is not necessarily limited to this. The calculation may be also performed using the same method in the skip mode or the merge mode.

Furthermore, although this embodiment has described, as the example of calculating the reference picture index or the motion vector of the current block using the adjacent block and the co-located block, the case where the current picture is a given B-picture (a B-picture corresponding to the reference picture lists 1 and 2 which have the same assignment of a reference picture index to each reference picture), the present invention is not necessarily limited to this. For instance, the method may be applied when the current picture is another B-picture (a B-picture corresponding to the reference picture lists 1 and 2 which differ in the assignment of a reference picture index to each reference picture). When the current picture is the other B-picture, the values of the reference picture indexes in the respective reference picture lists 1 and 2 are derived using this embodiment. More specifically, the value of the reference picture index indicating, among the reference pictures indicated by the reference picture indexes RefIdxL0_A, RefIdxL0_B, and RefIdxL0_C for the adjacent blocks A, B, and C adjacent to the current block and by a reference picture index RefIdxL0_Co1 for a co-located block specified in the reference picture list 1, the reference picture most frequently referred to is assigned to a reference picture index for the current block in the reference picture list 1. Moreover, the value of the reference picture index indicating, among reference pictures indicated by reference picture indexes RefIdxL1_A, RefIdxLl_B, and RefIdxL1_C for the adjacent blocks A, B, and C adjacent to the current block and by a reference picture index RefIdxL1_Co2 for a co-located block specified in the reference picture list 2, the reference picture most frequently referred to is assigned to a reference picture index for the current block in the reference picture list 2. Furthermore, when the current picture is a P-picture, this embodiment may be applied.

As described above, according to this embodiment, it is possible to select the prediction direction most suitable for the current block when determining the prediction direction in the skip mode. As a result it is possible to increase the coding efficiency. In particular, when the assignment of a reference picture index to each reference picture is the same for the reference picture lists 1 and 2, it is possible to enhance the quality of the prediction picture by selecting the unidirectional prediction regardless of the prediction direction of the adjacent block, and increase the coding efficiency.

### Embodiment 2

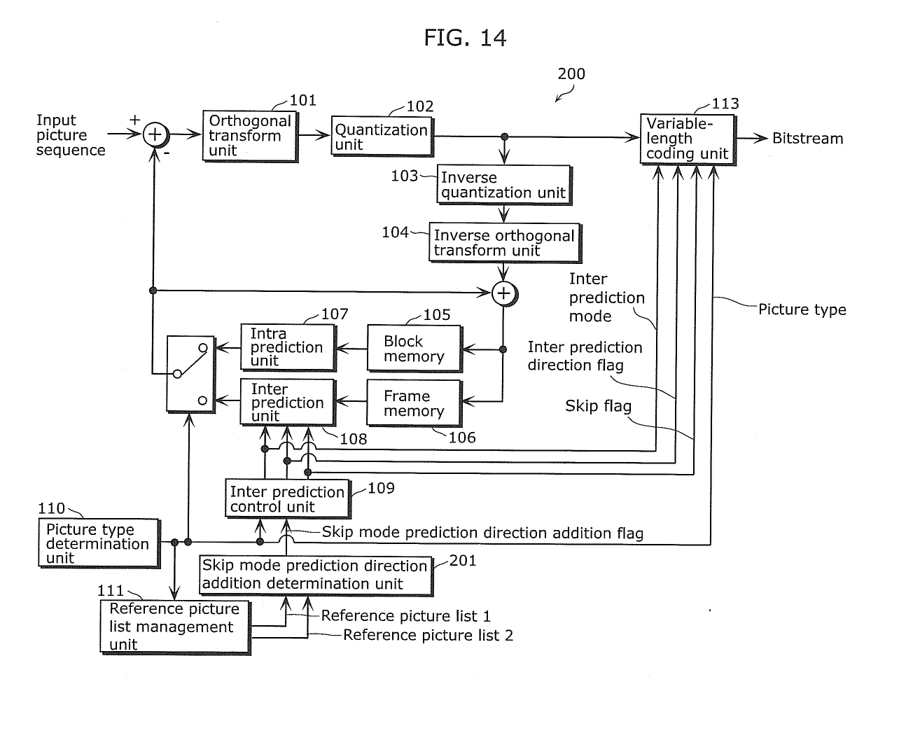

FIG. 14 is a block diagram showing a configuration of a moving picture coding apparatus using a moving picture coding method according to Embodiment 2 of the present invention. A moving picture coding apparatus 200 according to this embodiment includes a skip mode prediction direction addition determination unit instead of the skip mode prediction direction determination unit in Embodiment 1. A configuration of this embodiment differs from that of Embodiment 1 in that when a skip mode prediction direction addition flag is ON, an inter prediction direction is added for each current block to be coded even in the skip mode. It is to be noted that the same reference signs are assigned to the same elements as in Embodiment 1, and a description thereof is omitted.

A skip mode prediction direction addition determination unit 201 determines, through a method to be described later, whether or not an inter prediction direction is to be added for each current block to be coded even in the skip mode using the reference picture lists 1 and 2 created by the reference picture list management unit 111.

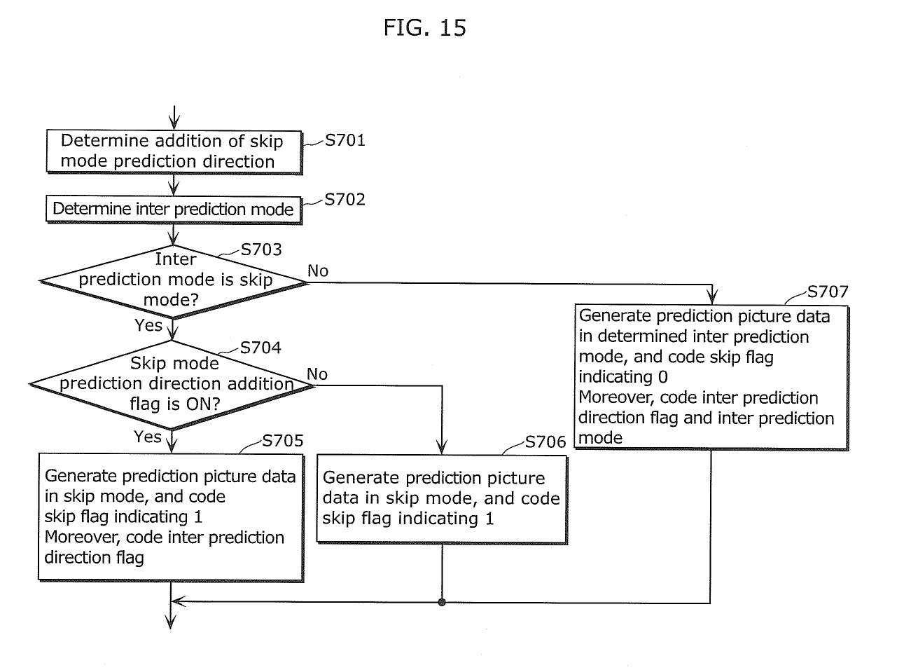

FIG. 15 is a flow chart showing an outline of a process flow of the moving picture coding method according to the implementation of the present invention.

The skip mode prediction direction addition determination unit 201 determines whether or not a prediction direction is to be added when a current block to be coded is coded in the skip mode, and turns a skip mode prediction direction addition flag ON when it is determined that the prediction direction is to be added. The inter prediction control unit 109 compares a cost of the motion vector estimation mode in which a prediction picture is generated using a motion vector obtained by motion estimation, a cost of the direct mode in which a prediction picture is generated using a predicted motion vector generated from an adjacent block or the like, and a cost of the skip mode in which a prediction picture is generated using a predicted motion vector generated according to the prediction direction added by the skip mode prediction direction addition determination unit 201, and determines a more efficient inter prediction mode from among the three modes (Step S702). Here, Equation 1 or the like is used for the method for calculating a cost. Next, the inter prediction control unit 109 determines whether or not the determined inter prediction mode is the skip mode (Step S703). When it is determined that the inter prediction mode is the skip mode (Yes in Step S703), the inter prediction control unit 109 determines whether or not the skip mode prediction direction addition flag is ON (Step S704). When it is determined that the skip mode prediction direction addition flag is ON (Yes in Step S704), the inter prediction control unit 109 generates a prediction picture in the skip mode and sets a skip flag to indicate 1. Then, the inter prediction control unit 109 sends the skip flag to the variable-length coding unit 113 so that the skip flag is added to a bitstream of the current block. Furthermore, the inter prediction control unit 109 sends an inter prediction direction flag of the skip mode to the variable-length coding unit 113 so that the inter prediction direction flag is also added to the bitstream (Step S705). On the other hand, when it is determined that the inter prediction mode is not the skip mode (No in Step S704), the inter prediction control unit 109 generates the prediction picture in the skip mode and sets the skip flag to indicate 1. Then, the inter prediction control unit 109 sends the skip flag to the variable-length coding unit 113 so that the skip flag is added to a bitstream of the current block (Step S706). Moreover, when it is determined in Step S703 that the skip mode prediction direction addition flag is not ON (No in Step S703), the inter prediction control unit 109 performs inter prediction according to the determined inter prediction mode, generates prediction picture data, and sets the skip flag to indicate 0. Then, the inter prediction control unit 109 sends the skip flag to the variable-length coding unit 113 so that the skip flag is added to the bitstream of the current block. Moreover, the inter prediction control unit 109 sends, to the variable-length coding unit 113, the inter prediction mode indicating the motion vector estimation mode or the direct mode so that the inter prediction mode is added to the bitstream of the current block (Step S707).

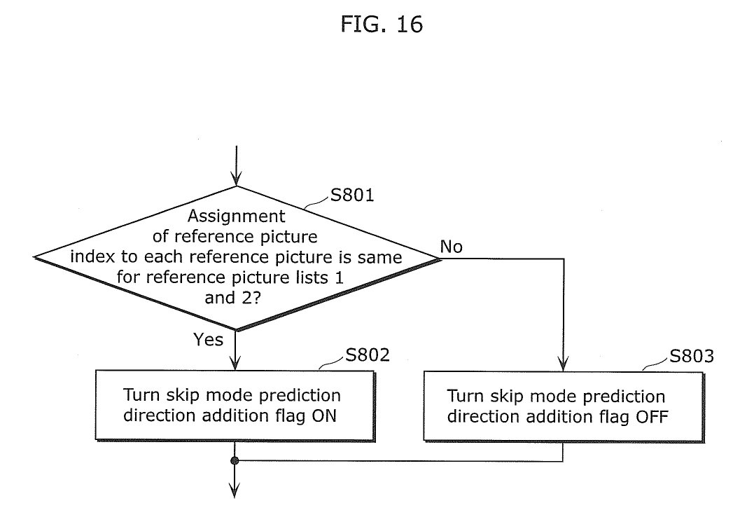

FIG. 16 is a flow chart showing a flow of determining a skip mode prediction direction addition flag which is performed by a skip mode prediction direction addition determination unit 201.

In general, when the assignment of the reference picture index to each reference picture is the same for the reference picture lists 1 and 2, although the motion vectors in the prediction directions 1 and 2 are selected in the bidirectional prediction, there are a case where only the motion vector in the prediction direction 1 is used in the unidirectional prediction and a case where the motion vector in the prediction direction 2 is overall reduced. For instance, when the assignment of the reference picture index to each reference picture is the same for the reference picture lists 1 and 2, unidirectional prediction using the reference picture list 2 is prohibited, and thus it is possible to increase the coding efficiency by reducing an amount of coded data of an inter prediction direction flag. In this case, only the motion vector in the prediction direction 1 is used in the unidirectional prediction, and thus the motion vector in the prediction direction 2 is overall reduced. Here, if the bidirectional prediction is selected as the prediction direction in the skip mode, there is a tendency that the motion vector in the predicted direction 2 of an adjacent block which can be used in generating a predicted motion vector in the prediction direction 2 is reduced, and thus there is a possibility that the accuracy of the predicted motion vector in the prediction direction 2 becomes low. For this reason, when the assignment of the reference picture index to each reference picture is the same for the reference picture lists 1 and 2, by adding the prediction direction in the skip mode to the stream, it is possible to select the unidirectional prediction when the accuracy of the predicted motion vector in the prediction direction 2 is low, and select the bidirectional prediction when the accuracy of the predicted motion vector in the prediction direction 2 is high. As a result, it is possible to increase the coding efficiency.

The skip mode prediction direction addition determination unit 201 determines whether or not the assignment of the reference picture index to each reference picture is the same for the reference picture lists 1 and 2, using the reference picture lists 1 and 2 (Step S801). For example, the display orders of the reference pictures indicated by the respective reference picture indexes 1 are obtained from the reference picture list 1 and are compared to the display orders of the reference pictures indicated by the respective reference picture indexes 2 in the reference picture list 2. When the display orders are the same, it is possible to determine that the assignment is the same for the reference picture lists 1 and 2. When it is determined that the assignment of the reference picture index to each reference picture is the same for the reference picture lists 1 and 2 (Yes in Step S801), the skip mode prediction direction addition determination unit 201 turns a skip mode prediction direction addition flag ON (Step S802). On the other hand, when it is determined that the assignment of the reference picture index to each reference picture is not the same for the reference picture lists 1 and 2 (No in Step S801), the skip mode prediction direction addition determination unit 201 turns the skip mode prediction direction addition flag OFF (Step S803).

It is to be noted that although it is determined in Step 801 whether or not the assignment of the reference picture index to each reference picture is the same for the reference picture lists 1 and 2 in this embodiment, the determination may be made using coding order or the like.

Moreover, although the skip mode prediction direction addition flag is turned ON when it is determined that the assignment of the reference picture index to each reference picture is the same for the reference picture lists 1 and 2 in this embodiment, the skip mode prediction direction addition flag may be turned ON when a reference picture indicated by the reference picture index 1 of the prediction direction 1 is the same as a reference picture indicated by the reference picture index 2 of the prediction direction 2 in the skip mode corresponding to the current block. For example, the display order of the reference picture indicated by the reference picture index 1 is obtained from the reference picture list 1 and is compared to the display order of the reference picture indicated by the reference picture index 2 in the reference picture list 2. When the display orders are the same, it is possible to determine that the pictures are the same for the reference picture lists 1 and 2. Even in such a case, the motion vectors in the prediction directions 1 and 2 are selected in the bidirectional prediction. However, there is the case where only the motion vector in the prediction direction 1 is used in the unidirectional prediction and the motion vector in the prediction direction 2 is overall reduced. As a result, by adding the prediction direction in the skip mode to the stream, it is possible to select the unidirectional prediction when the accuracy of the predicted motion vector in the prediction direction 2 is low, and select the bidirectional prediction when the accuracy of the predicted motion vector in the prediction direction 2 is high. Consequently, it is possible to increase the coding efficiency.

Moreover, when a current picture to be coded is a B-picture coded by using a bidirectional prediction picture with reference to two coded pictures located before the current picture, the prediction direction in the skip mode may be fixed to the unidirectional prediction. For such a B-picture, there is a case where the assignment of the reference picture index to each reference picture is the same for the reference picture lists 1 and 2 or a case where the reference picture indicated by the reference picture index 1 of the prediction direction 1 is the same as the reference picture indicated by the reference picture index 2 of the prediction direction 2 in the skip mode corresponding to the current block. Even in such a case, the motion vectors in the prediction directions 1 and 2 are selected in the bidirectional prediction. However, there is the case where only the motion vector in the prediction direction 1 is used in the unidirectional prediction and the motion vector in the prediction direction 2 is overall reduced. As a result, by adding the prediction direction in the skip mode to the stream, it is possible to select the unidirectional prediction when the accuracy of the predicted motion vector in the prediction direction 2 is low, and select the bidirectional prediction when the accuracy of the predicted motion vector in the prediction direction 2 is high. Consequently, it is possible to increase the coding efficiency.

Moreover, when the current picture is a B-picture coded by using the bidirectional prediction picture with reference to two coded pictures located after the current picture, the prediction direction in the skip mode may be fixed to the unidirectional prediction. For such a B-picture, there is the case where the assignment of the reference picture index to each reference picture is the same for the reference picture lists 1 and 2 or the case where the reference picture indicated by the reference picture index 1 of the prediction direction 1 is the same as the reference picture indicated by the reference picture index 2 in the prediction direction 2 in the skip mode corresponding to the current block. Even in such a case, the motion vectors in the prediction directions 1 and 2 are selected in the bidirectional prediction. However, there is the case where only the motion vector in the prediction direction 1 is used in the unidirectional prediction and the motion vector in the prediction direction 2 is overall reduced. As a result, by adding the prediction direction in the skip mode to the stream, it is possible to select the unidirectional prediction when the accuracy of the predicted motion vector in the prediction direction 2 is low, and select the bidirectional prediction when the accuracy of the predicted motion vector in the prediction direction 2 is high. Consequently, it is possible to increase the coding efficiency.

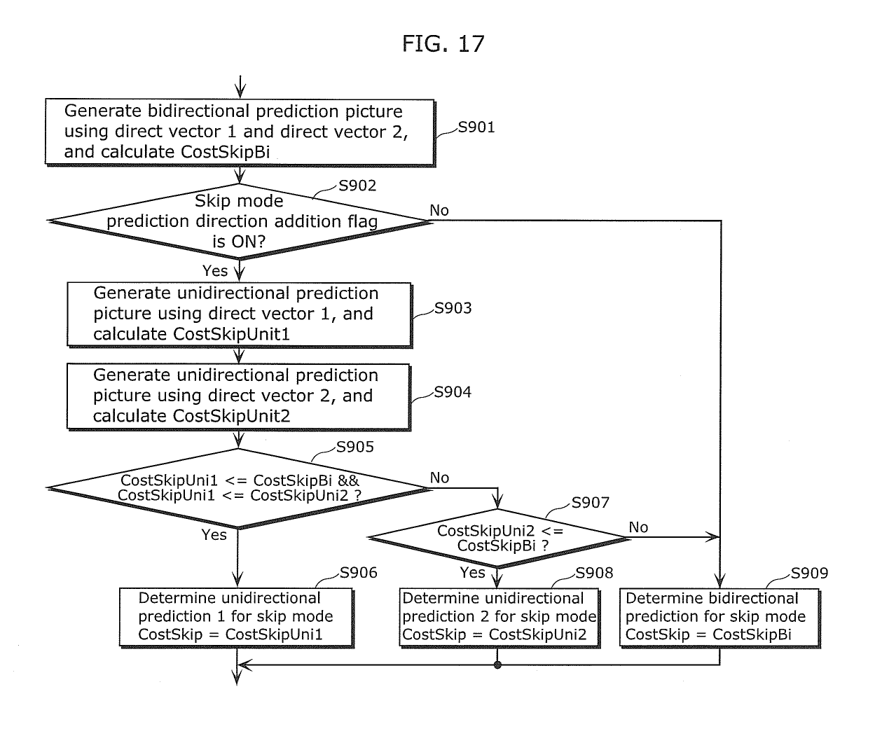

The following describes in detail the cost CostSkip calculation method in the skip mode in this embodiment, with reference to FIG. 17. FIG. 17 is a flow chart showing a process flow of cost CostSkip calculation in the skip mode. It is to be noted that the flow of determining an inter prediction mode, the cost CostInter calculation method in the motion vector estimation mode, and the cost CostDirect calculation method in the direct mode are the same as in FIG. 6, FIG. 7, and FIG. 8 in Embodiment 1, and thus descriptions thereof are omitted.

The inter prediction control unit 109 calculates, through the method described in Embodiment 1, the direct vector 1 in the prediction direction 1 and the direct vector 2 in the prediction direction 2. Then, the inter prediction control unit 109 generates a bidirectional prediction picture using the calculated direct vectors 1 and 2, and calculates cost CostSkipBi by Equation 1 (Step S901). Here, the bidirectional prediction picture is, for instance, a bidirectional prediction picture obtained by performing, for each pixel, averaging on the prediction picture generated using the motion vector 1 and the prediction picture generated using the motion vector 2. Next, the inter prediction control unit 109 determines whether or not the skip mode prediction direction addition flag is ON (Step S902). When it is determined that the skip mode prediction direction addition flag is ON (Yes in Step S902), the inter prediction control unit 109 generates a prediction picture in the prediction direction 1 using the direct vector, and calculate cost CostSkipUni1 of the prediction picture by Equation 1 (Step S903). The inter prediction control unit 109 generates a prediction picture in the prediction direction 2 using the direct vector 2, and calculates cost CostskipUni2 by Equation 1 (Step S904). The inter prediction control unit 109 compares a value of the cost CostSkipUni1, a value of the cost CostSkipUni2, and a value of the cost CostSkipBi, and determines whether or not the cost CostSkipUni1 is smallest (Step S905). When it is determined that the cost CostSkipUni1 is smallest (Yes in Step S905), the inter prediction control unit 109 determines unidirectional prediction 1 in the prediction direction 1 for the skip mode, and sets the cost CostSkipUni1 to the cost CostSkip in the skip mode (Step S906). On the other hand, when it is determined that the cost CostSkiUni1 is not smallest (No in Step S905), the inter prediction control unit 109 compares the cost CostSkipUni2 and the cost CostSkipBi, and determines whether or not the cost CostSkipUni2 is smaller (Step S907). When it is determined that the value of the cost CostSkipUni2 is smaller (Yes in Step S907), the inter prediction control unit 109 determines unidirectional prediction 2 in the prediction direction 2 for the skip mode, and sets the cost CostSkipUni2 to the cost CostSkip in the skip mode (Step S908). On the other hand, when it is determined that the value of the cost CostSkipUni2 is not smaller (No in Step S907) and when it is determined in Step S902 that the skip mode prediction direction addition flag is not ON (No in Step S902), the inter prediction control unit 109 determines bidirectional prediction for the skip mode, and sets the cost CostSkipBi to the cost CostSkip in the skip mode (Step S909).

As described above, according to this embodiment, it is possible to select the prediction direction most suitable for the current block when determining the prediction direction in the skip mode. As a result it is possible to increase the coding efficiency. In particular, when the assignment of the reference picture index to each reference picture is the same for the reference picture lists 1 and 2, it is possible to enhance the quality of the prediction picture by adding the prediction direction to the bitstream also in the skip mode and selecting the prediction direction most suitable for the current block, regardless of the prediction direction of the adjacent block. As a result, it is possible to increase the coding efficiency.

### Embodiment 3

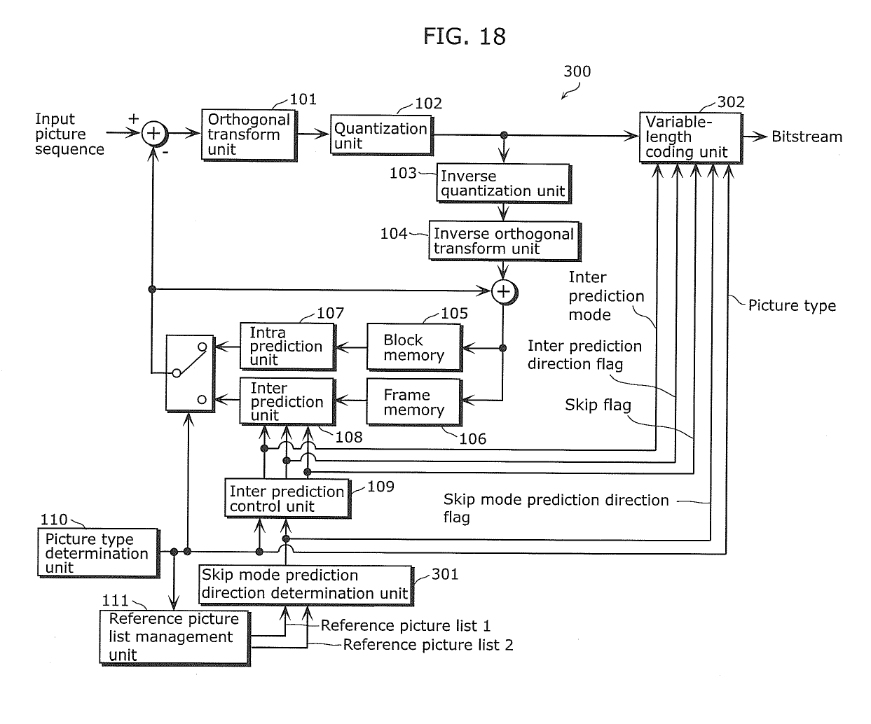

FIG. 18 is a block diagram showing a configuration of a moving picture coding apparatus using a moving picture coding method according to Embodiment 3 of the present invention. A moving picture coding apparatus 300 according to this embodiment differs from the moving picture coding apparatus according to Embodiment 1 in that a skip mode prediction direction flag generated by the skip mode prediction direction determination unit is added to header information (e.g., a picture parameter set or a slice header in H.264) which is given to a bitstream for each unit of processing such as a picture. It is to be noted that the same reference signs are assigned to the same elements as in Embodiment 1, and a description thereof is omitted.

As in Embodiment 1, a skip mode prediction direction determination unit 301 determines a skip mode prediction direction for a current block to be coded, and sets a skip mode prediction direction flag. In addition, the skip mode prediction direction determination unit 301 also sends the set skip mode prediction direction flag to a variable-length coding unit 302 in addition to the inter prediction control unit 109.

The variable-length coding unit 302 generates a bitstream by performing a variable length coding process on prediction error data on which a quantization process has been performed, an inter prediction mode, an inter prediction direction flag, a skip flag, and picture type information.

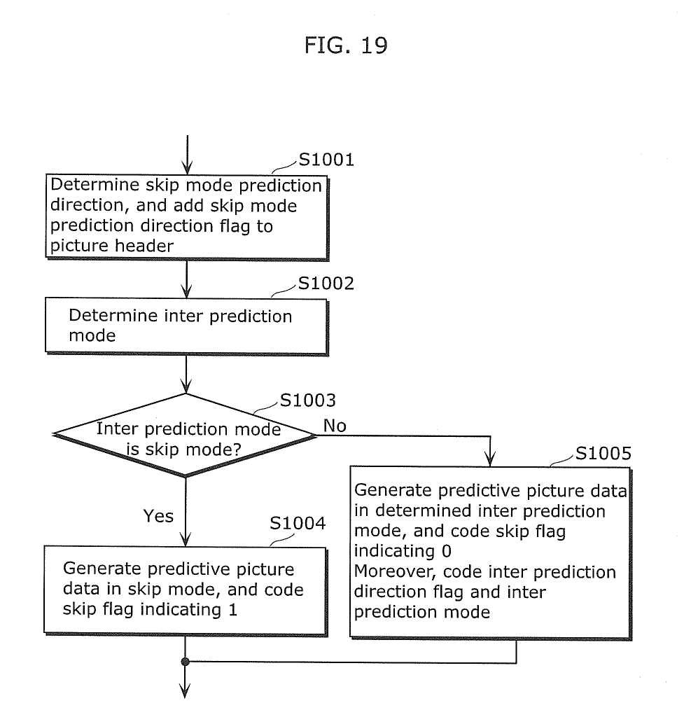

FIG. 19 is a flow chart showing an outline of a process flow of the moving picture coding method according to this embodiment of the present invention.

The skip mode prediction direction determination unit 301 determines a prediction direction in the case of coding a current block to be coded in the skip mode, and sends, to the variable-length coding unit 302, a determined skip mode prediction direction flag so that the skip mode prediction direction flag is added to a picture header or the like (Step S1001). Here, the method of determining a skip mode prediction direction is the same as in the flow or the like shown in FIG. 5 in Embodiment 1. The inter prediction control unit 109 compares a cost of the motion vector estimation mode in which a prediction picture is generated using a motion vector obtained by motion estimation, a cost of the direct mode in which a prediction picture is generated using a predicted motion vector generated from an adjacent block or the like, and a cost of the skip mode in which a prediction picture is generated using a predicted motion vector generated according to a prediction direction determined by the skip mode prediction direction determination unit 301, and determines a more efficient inter prediction mode from among the three modes (Step S1002). Here, Equation 1 or the like is used for the method for calculating a cost. Next, the inter prediction control unit 109 determines whether or not the determined inter prediction mode is the skip mode (Step S1003). When it is determined that the inter prediction mode is the skip mode (Yes in Step S1003), the inter prediction control unit 109 generates a prediction picture in the skip mode and sets a skip flag to indicate 1. Then, the inter prediction control unit 109 sends the skip flag to the variable-length coding unit 302 so that the skip flag is added to a bitstream of the current block (Step S1004). On the other hand, when it is determined that the inter prediction mode is not the skip mode (No in Step S1003), the inter prediction control unit 109 performs inter prediction according to the determined inter prediction mode, generates prediction picture data, and sets the skip flag to indicate 0. Then, the inter prediction control unit 109 sends the skip flag to the variable-length coding unit 302 so that the skip flag is added to the bitstream of the current block. Moreover, the inter prediction control unit 109 sends, to the variable-length coding unit 302, the inter prediction mode indicating the motion vector estimation mode or the direct mode so that the inter prediction mode is added to the bitstream of the current block (Step S1005). It is to be noted that the method of determining an inter prediction mode or the like is the same as Embodiment 1, and thus a description thereof is omitted.

As described above, according to this embodiment, explicitly giving the skip mode prediction direction flag to the picture header or the like allows the prediction direction in the skip mode to be flexibly switched for each picture. As a result, it is possible to increase the coding efficiency.

### Embodiment 4

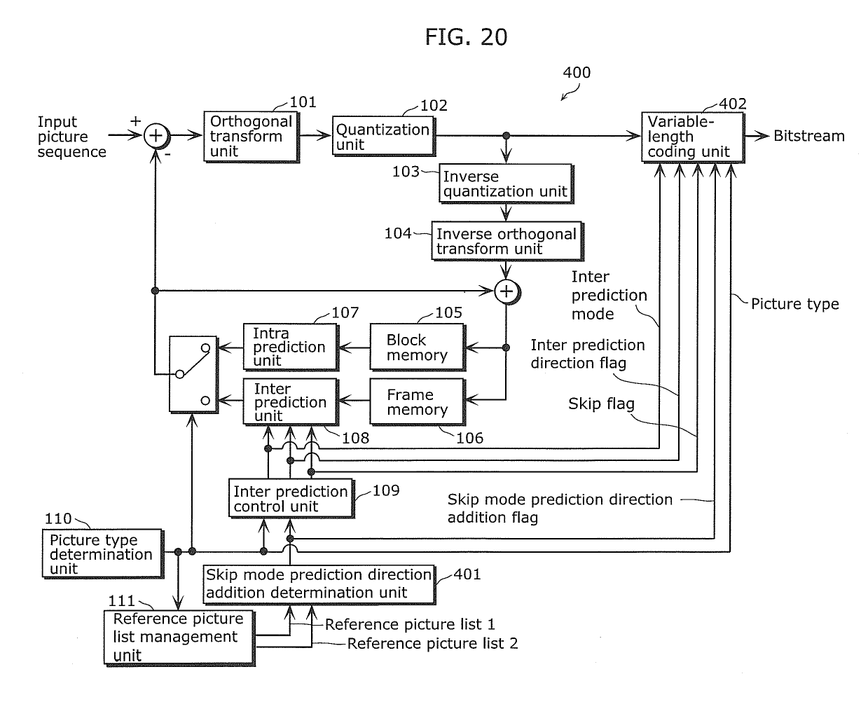

FIG. 20 is a block diagram showing a configuration of a moving picture coding apparatus using a moving picture coding method according to Embodiment 4 of the present invention. A moving picture coding apparatus 400 according to this embodiment differs from the moving picture coding apparatus according to Embodiment 3 in that a skip mode prediction direction addition flag generated by the skip mode prediction direction addition determination unit is added to header information (e.g., a picture parameter set or a slice header in H.264) which is given to a bitstream for each unit of processing such as a picture. It is to be noted that the same reference signs are assigned to the same elements as in Embodiment 3, and a description thereof is omitted.

As in Embodiment 3, a skip mode prediction direction addition determination unit 401 determines whether or not an inter prediction direction is to be added for each current block to be coded even in the skip mode, and sets a skip mode prediction direction addition flag. In addition, the skip mode prediction direction addition determination unit 401 also sends the set skip mode prediction direction addition flag to a variable-length coding unit 402 in addition to the inter prediction control unit 109.

The variable-length coding unit 402 generates a bitstream by performing a variable length coding process on prediction error data on which a quantization process has been performed, an inter prediction mode, an inter prediction direction flag, a skip flag, and picture type information.

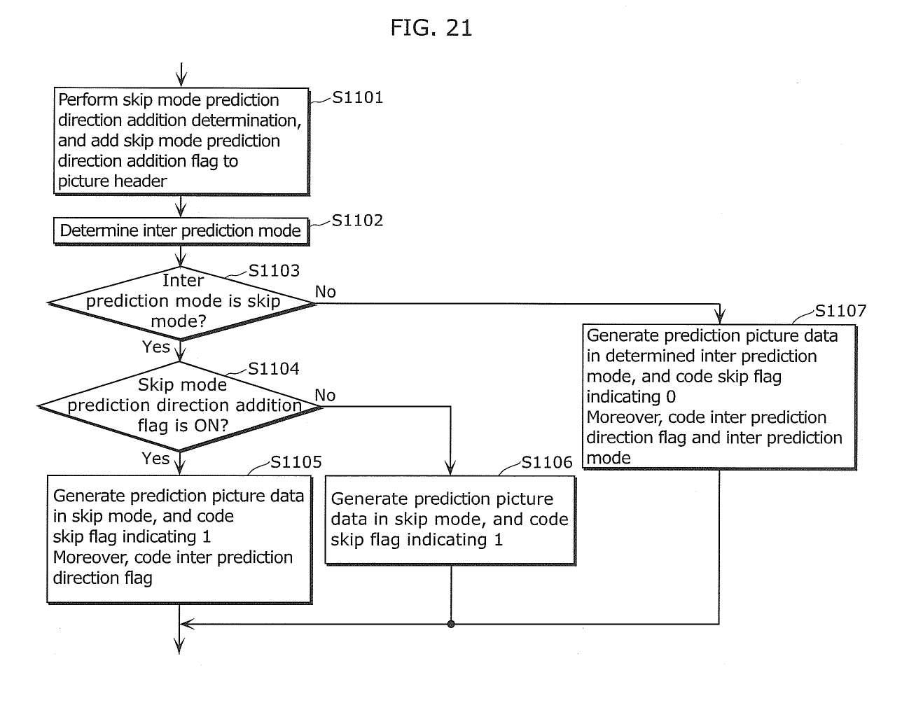

FIG. 21 is a flow chart showing an outline of a process flow of the moving picture coding method according to this embodiment of the present invention.

The skip mode prediction direction addition determination unit 401 determines whether or not a prediction direction is to be added when a current block to be coded is coded in the skip mode, and turns a skip mode prediction direction addition flag ON when it is determined that the prediction direction is to be added. Then, the skip mode prediction direction addition determination unit 401 sends the set skip mode prediction direction addition flag to the variable-length coding unit 402 so that the skip mode prediction direction addition flag is added to a picture header or the like (Step S1101). Here, the method of determining prediction direction addition is the same as in FIG. 16 or the like in Embodiment 2. The inter prediction control unit 109 compares a cost of the motion vector estimation mode in which a prediction picture is generated using a motion vector obtained by motion estimation, a cost of the direct mode in which a prediction picture is generated using a predicted motion vector generated from an adjacent block or the like, and a cost of the skip mode in which a prediction picture is generated using a predicted motion vector generated according to a prediction direction determined by the skip mode prediction direction addition determination unit 401, and determines a more efficient inter prediction mode from among the three modes (Step S1102). Here, Equation 1 or the like is used for the method for calculating a cost. Next, the inter prediction control unit 109 determines whether or not the determined inter prediction mode is the skip mode (Step S1103). When it is determined that the inter prediction mode is the skip mode (Yes in Step S1103), the inter prediction control unit 109 determines whether or not the skip mode prediction direction addition flag is ON (Step S1104). When it is determined that the skip mode prediction direction addition flag is ON (Yes in Step S1104), the inter prediction control unit 109 generates a prediction picture in the skip mode and sets a skip flag to indicate 1. Then, the inter prediction control unit 109 sends the skip flag to the variable-length coding unit 113 so that the skip flag is added to a bitstream of the current block. Furthermore, the inter prediction control unit 109 sends an inter prediction direction flag of the skip mode to the variable-length coding unit 113 so that the inter prediction direction flag is also added to the bitstream (Step S1105). On the other hand, when it is determined that the inter prediction mode is not the skip mode (No in Step S1104), the inter prediction control unit 109 generates the prediction picture in the skip mode and sets the skip flag to indicate 1. Then, the inter prediction control unit 109 sends the skip flag to the variable-length coding unit 402 so that the skip flag is added to the bitstream of the current block (Step S1106). Moreover, when it is determined in Step S1103 that the skip mode prediction direction addition flag is not ON (No in Step S1103), the inter prediction control unit 109 performs inter prediction according to the determined inter prediction mode, generates prediction picture data, and sets the skip flag to indicate 0. Then, the inter prediction control unit 109 sends the skip flag to the variable-length coding unit 402 so that the skip flag is added to the bitstream of the current block. Moreover, the inter prediction control unit 109 sends, to the variable-length coding unit 402, the inter prediction mode indicating the motion vector estimation mode or the direct mode and the inter prediction direction flag so that the inter prediction mode and the inter prediction direction flag are added to the bitstream of the current block (Step S1107). It is to be noted that the method of determining an inter prediction mode or the like is the same as Embodiment 2, and thus a description thereof is omitted.

As described above, according to this embodiment, explicitly giving the skip mode prediction direction addition flag to the picture header or the like enables flexibly switching, for each picture, whether or not the prediction direction in the skip mode is to be added. As a result, it is possible to increase the coding efficiency.

### Embodiment 5

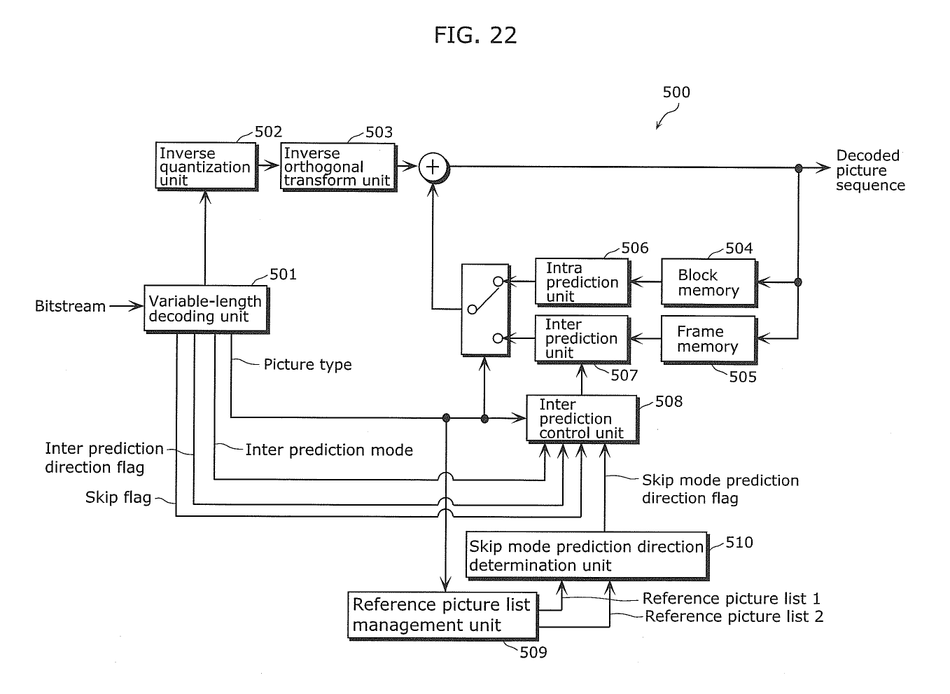

FIG. 22 is a block diagram showing a configuration of a moving picture decoding apparatus using a moving picture decoding method according to Embodiment 5 of the present invention.

As shown in FIG. 22, a moving picture decoding apparatus 500 includes a variable-length decoding unit 501, an inverse quantization unit 502, an inverse orthogonal transform unit 503, a block memory 504, a frame memory 505, an intra prediction unit 506, an inter prediction unit 507, an inter prediction control unit 508, a reference picture list management unit 509, and a skip mode prediction direction determination unit 510.

The variable-length decoding unit 501 performs a variable-length decoding process on an inputted bitstream, to generate picture type information, an inter prediction mode, an inter prediction direction, a skip flag, and a quantized coefficient on which the variable-length decoding process has been performed. The inverse quantization unit 502 performs an inverse quantization process on the quantized coefficient on which the variable-length decoding process has been performed. The inverse orthogonal transform unit 503 transforms, from frequency domain into image domain, an orthogonal transform coefficient on which the inverse quantization process has been performed, to generate prediction error picture data. The block memory 504 stores, in units of blocks, a picture sequence generated by adding the prediction error picture data and prediction picture data. The frame memory 505 stores the picture sequence in units of frames. The intra prediction unit 506 generates prediction picture data of a current block to be decoded, through intra prediction, using the picture sequence stored in the units of the blocks in the block memory 504. The inter prediction unit 507 generates prediction picture data of the current block through inter prediction, using the picture sequence stored in the units of the frames in the frame memory 505. The inter prediction control unit 508 controls motion vectors in the inter prediction and the method for generating prediction picture data, according to the inter prediction mode, the inter prediction direction flag, and the skip flag.

The reference picture list management unit 509 assigns reference picture indexes to coded reference pictures to be referred to in the inter prediction, and creates reference picture lists together with display order and so on. Two reference picture lists correspond to the B-picture which is used for coding with reference to two pictures.

It is to be noted that although the reference pictures are managed based on the reference picture indexes and the display order in this embodiment, the reference pictures may be managed based on the reference picture indexes, coding order, and so on.

The skip mode prediction direction determination unit 510 determines a prediction direction in the skip mode for the current block, using reference picture lists 1 and 2 created by the reference picture list management unit. It is to be noted that a flow of determining a skip mode prediction direction flag is the same as FIG. 5 in Embodiment 1, and thus a description thereof is omitted.

Lastly, a decoded picture sequence is generated by adding decoded prediction error picture data and the prediction picture data.

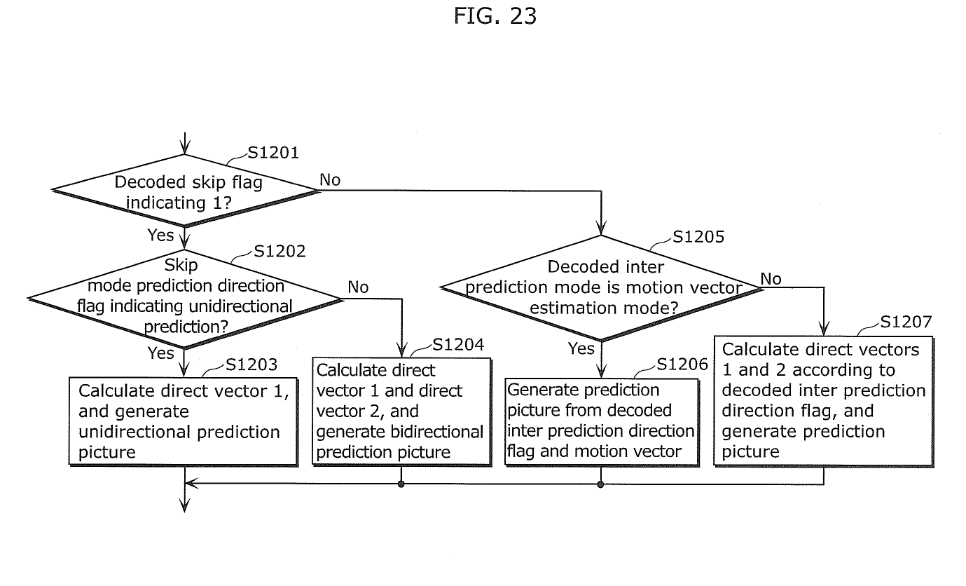

FIG. 23 is a flow chart showing an outline of a process flow of the moving picture decoding method according to this embodiment of the present invention.

The inter prediction control unit 508 determines whether or not a skip flag obtained by the variable-length decoding unit 501 decoding a bitstream indicates 1 (Step S1201). When it is determined that the skip flag indicates 1 (Yes in Step S1201), the inter prediction control unit 508 determines whether or not a skip mode prediction direction flag obtained by decoding performed by the variable-length decoding unit 501 indicates the unidirectional prediction (Step S1202). When it is determined that the skip mode prediction direction flag indicates the unidirectional prediction (Yes in Step S1202), the inter prediction control unit 508 calculates, using the same method as in Step S501 of FIG. 8, the direct vector 1, and generates a unidirectional prediction picture (Step S1203). On the other hand, when it is determined that the skip mode prediction direction flag does not indicate the unidirectional prediction (No in Step S1202), the inter prediction control unit 508 calculates, using the same method as in Step S501 of FIG. 8, the direct vector 1 and the direct vector 2, and generates a bidirectional prediction picture (Step S1204). In contrast, when it is determined in Step S1202 that the skip flag does not indicate 1, that is, the skip flag does not indicate the skip mode (No in Step S1201), the inter prediction control unit 508 determines whether or not the inter prediction mode obtained by decoding performed by the variable-length decoding unit 501 is the motion vector estimation mode (Step S1205). When it is determined that the inter prediction mode is the motion vector estimation mode (Yes in Step S1205), the inter prediction control unit 508 generates a prediction picture using an inter prediction direction flag and a motion vector obtained by decoding performed by the variable-length decoding unit 501 (Step S1206). On the other hand, when it is determined that the inter prediction mode is not the motion vector estimation mode, that is, the inter prediction mode is the direct mode (No in Step S1205), the inter prediction control unit 508 calculates, using the same method as S501 of FIG. 8, the direct vectors 1 and 2 and generates a prediction picture according to the inter prediction direction flag (Step S1208).

It is to be noted that although the unidirectional prediction picture in the skip mode is generated using the direct vector in Step S1203 in this embodiment, a unidirectional prediction picture may be generated using the direct vector 2 in the same manner as the moving picture coding method.

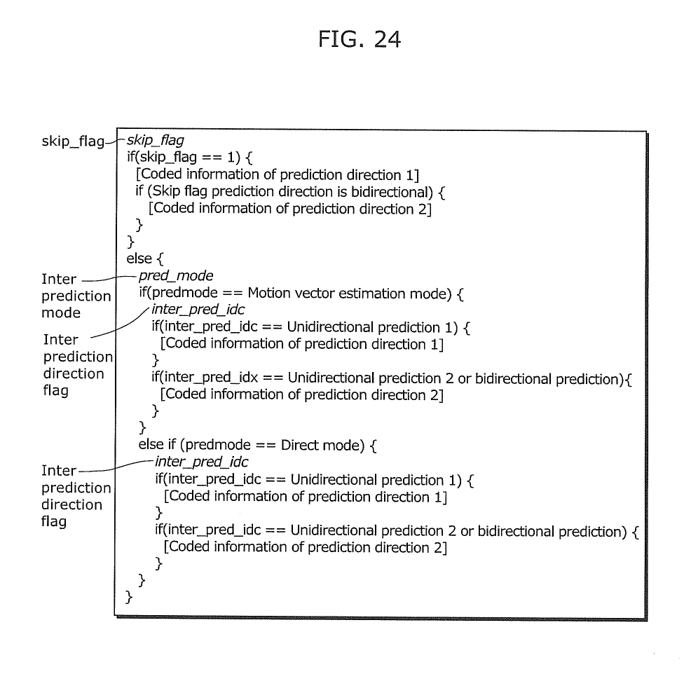

FIG. 24 is a diagram showing an example of syntax of a bitstream in the moving picture decoding method according to this embodiment of the present invention. In FIG. 24, skip_flag represents a skip flag, pred_mode represents an inter prediction mode, and inter_pred_idc represents an inter prediction direction flag.

It is to be noted that although the direct vectors are calculated by the same method as in S501 of FIG. 8 in this embodiment, a candidate list including candidate predicted motion vectors as shown in FIG. 11A may be created, a predicted motion vector index may be extracted from a stream, and, among the candidate predicted motion vectors on the candidate list, a candidate predicted motion vector indicated by the predicted motion vector index may be used as a direct vector to be used for decoding.

As described above, according to this embodiment, it is possible to properly decode the bitstream for which coding efficiency is increased by selecting the unidirectional prediction, regardless of the prediction direction of the adjacent block, when the assignment of the reference picture index to each reference picture is the same for the reference picture lists 1 and 2.

### Embodiment 6

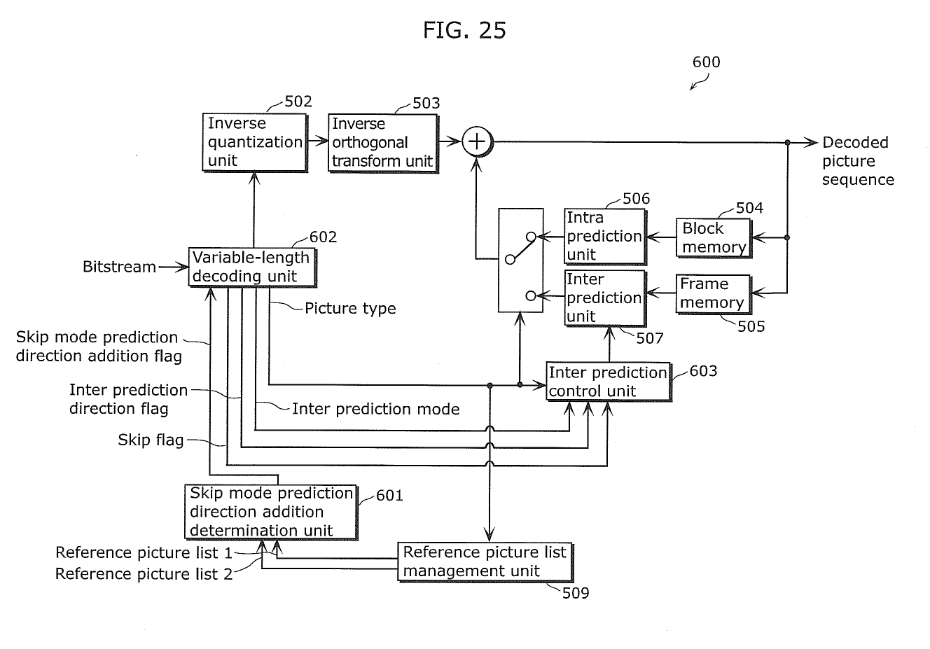

FIG. 25 is a block diagram showing a configuration of a moving picture decoding apparatus using a moving picture decoding method according to Embodiment 6 of the present invention. A moving picture decoding apparatus 600 according to this embodiment includes a skip mode prediction direction addition determination unit instead of the skip mode prediction direction determination unit in Embodiment 5. A configuration of this embodiment differs from that of Embodiment 5 in that when a skip mode prediction direction addition flag is ON, a bitstream in which an inter prediction direction is added for each current block to be coded can be decoded even in the skip mode. It is to be noted that the same reference signs are assigned to the same elements as in Embodiment 5, and a description thereof is omitted. It is to be noted that a flow of determining addition of a skip mode prediction direction is the same as in FIG. 16 in Embodiment 2, and thus a description thereof is omitted.

A skip mode prediction direction addition determination unit 601 determines, through a method to be described later, whether or not an inter prediction direction is to be added for each current block to be coded even in the skip mode using the reference picture lists 1 and 2 created by the reference picture list management unit 509.

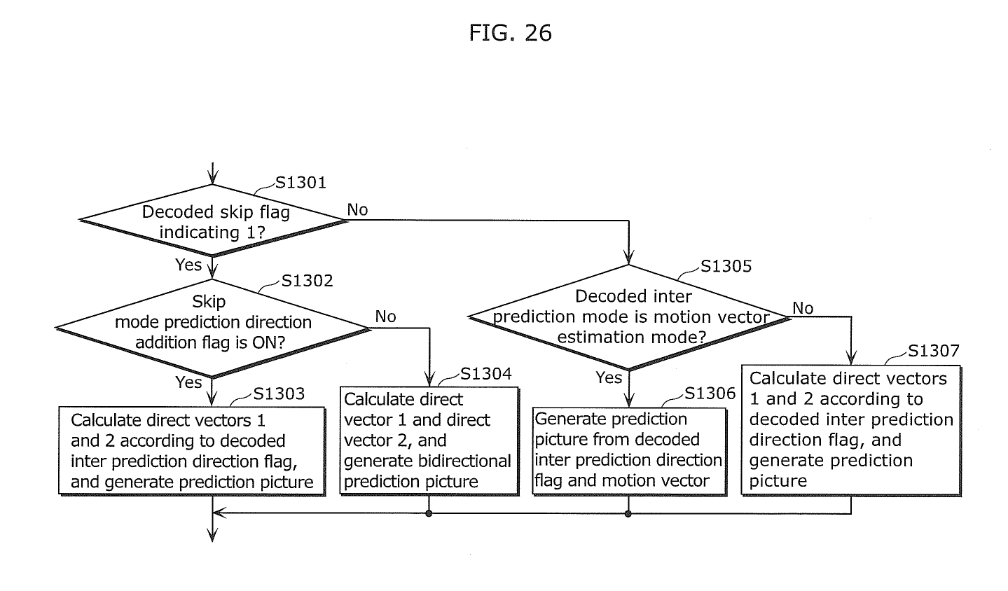

FIG. 26 is a flow chart showing an outline of a process flow of the moving picture decoding method according to this embodiment of the present invention.

An inter prediction control unit 603 determines whether or not a skip flag obtained by a variable-length decoding unit 602 decoding a bitstream indicates 1 (Step S1301). When it is determined that the skip flag indicates 1 (Yes in Step S1301), an inter prediction control unit 603 determines whether or not a skip mode prediction direction addition flag obtained by decoding performed by the variable-length decoding unit 602 is ON (Step S1302). When it is determined that the skip mode prediction direction addition flag is ON (Yes in Step S1302), the variable-length decoding unit 602 decodes an inter prediction direction flag. Then, the inter prediction control unit 603 calculates at least one of the direct vectors 1 and 2 according to the decoded inter prediction direction flag, and generates a unidirectional or bidirectional prediction picture (Step S1303). On the other hand, when it is determined that the skip mode prediction direction addition flag is not ON (No in Step S1302), the inter prediction control unit 603 calculates the direct vectors 1 and 2, and generates the bidirectional prediction picture (Step S1304). In contrast, when it is determined in Step S1301 that the skip flag does not indicate 1, that is, the skip flag does not indicate the skip mode (No in Step S1301), the inter prediction control unit 603 determines whether or not an inter prediction mode decoded by the variable-length decoding unit 602 is the motion vector estimation mode (Step S1305). When it is determined that the inter prediction mode is the motion vector estimation mode (Yes in Step S1305), the inter prediction control unit 603 generates a prediction picture using the inter prediction direction flag decoded by the variable-length decoding unit 602 and a motion vector (Step S1306). On the other hand, when it is determined that the inter prediction mode is not the motion vector estimation mode, that is, the inter prediction mode is the direct mode (No in Step S1305), the inter prediction control unit 603 calculates the direct vectors 1 and 2 according to the inter prediction direction flag, and generates a prediction picture (Step S1307).

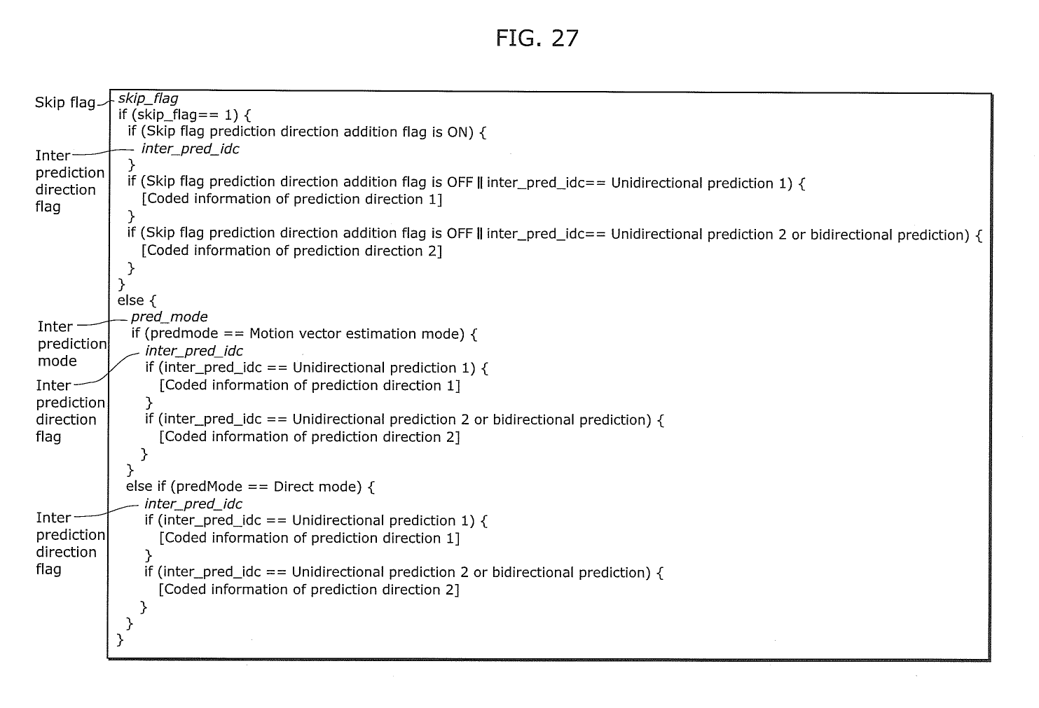

FIG. 27 is a diagram showing an example of syntax of a bitstream in the moving picture decoding method according to this embodiment of the present invention. In FIG. 27, skip_flag represents a skip flag, pred_mode represents an inter prediction mode, and inter_pred_idc represents an inter prediction direction flag.

As described above, according to this embodiment, it is possible to properly decode the bitstream for which coding efficiency is increased, by adding the prediction direction to the bitstream even in the skip mode, regardless of the prediction direction of the adjacent block, when the assignment of the reference picture index to each reference picture is the same for the reference picture lists 1 and 2.

### Embodiment 7

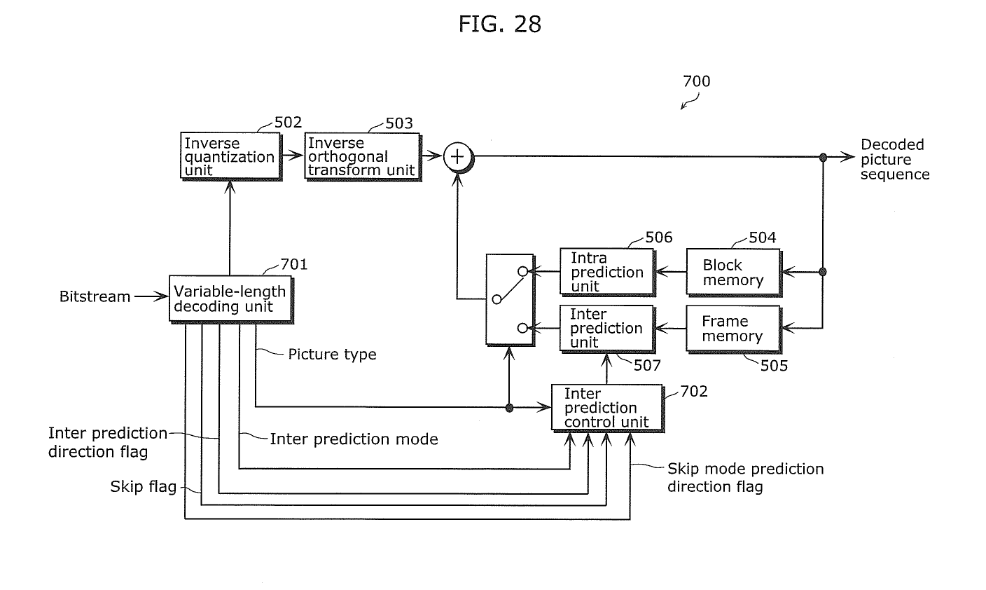

FIG. 28 is a block diagram showing a configuration of a moving picture decoding apparatus using a moving picture decoding method according to Embodiment 7 of the present invention. A moving picture decoding apparatus 700 according to this embodiment differs from the moving picture decoding apparatus according to Embodiment 5 in decoding a bitstream in which a skip mode prediction direction flag generated by the skip mode prediction direction determination unit is added to header information (e.g., a picture parameter set or a slice header in H.264) for each unit of processing such as a picture. It is to be noted that the same reference signs are assigned to the same elements as in Embodiment 5, and a description thereof is omitted.

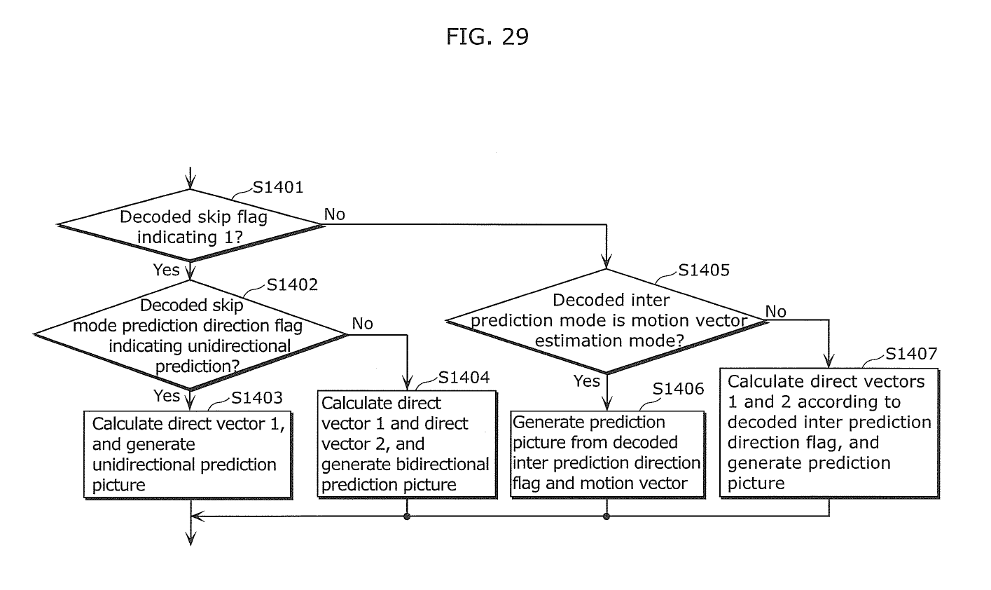

FIG. 29 is a flow chart showing an outline of a process flow of the moving picture decoding method according to this embodiment of the present invention.

An inter prediction control unit 702 determines whether or not a skip flag obtained by a variable-length decoding unit 701 decoding a bitstream indicates 1 (Step S1401). When it is determined that the skip flag indicates 1 (Yes in Step S1401), the inter prediction control unit 702 determines whether or not a skip mode prediction direction flag obtained by decoding performed by the variable-length decoding unit 701 indicates the unidirectional prediction (Step S1402). When it is determined that the skip mode prediction direction flag indicates the unidirectional prediction (Yes in Step S1402), the inter prediction control unit 702 calculates the direct vector 1, and generates a unidirectional prediction picture (Step S1403). On the other hand, when it is determined that the skip mode prediction direction flag does not indicate the unidirectional prediction (No in Step S1402), the inter prediction control unit 702 calculates the direct vector 1 and the direct vector 2, and generates a bidirectional prediction picture (Step S1404). In contrast, when it is determined in Step S1404 that the skip flag does not indicate 1, that is, the skip flag does not indicate the skip mode (No in Step S1401), the inter prediction control unit 702 determines whether or not an inter prediction mode obtained by decoding performed by the variable-length decoding unit 701 is the motion vector estimation mode (Step S1405). When it is determined that the inter prediction mode is the motion vector estimation mode (Yes in Step S1405), the inter prediction control unit 702 generates a prediction picture using an inter prediction direction flag decoded by the variable-length decoding unit 701 and a motion vector (Step S1406). On the other hand, when it is determined that the inter prediction mode is not the motion vector estimation mode, that is, the inter prediction mode is the direct mode (No in Step S1405), the inter prediction control unit 702 calculates the direct vectors 1 and 2 according to the inter prediction direction flag, and generates a prediction picture (Step S1408).

It is to be noted that although the unidirectional prediction picture in the skip mode is generated using the direct vector in Step S1403 of FIG. 29 in this embodiment, a unidirectional prediction picture may be generated using the direct vector 2 in the same manner as the moving picture coding method.

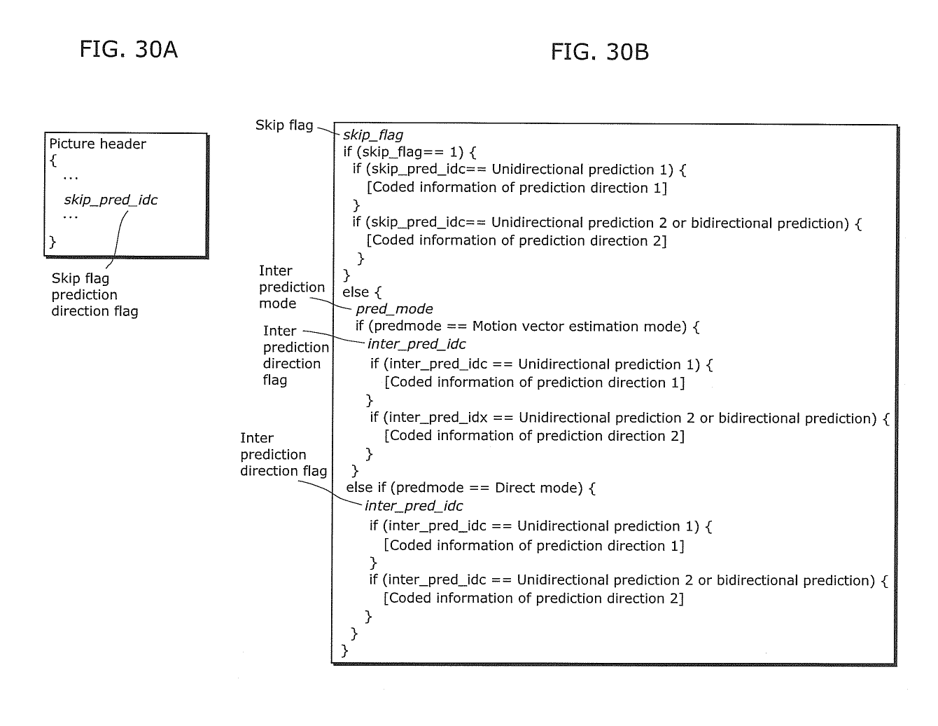

Each of FIGS. 30A and 30B is a diagram showing another example of syntax of a bitstream in the moving picture decoding method according to this embodiment of the present invention. In FIGS. 30A and 30B, skip_flag represents a skip flag, pred_mode represents an inter prediction mode, and inter_pred_idc represents an inter prediction direction flag. In addition, skip_pred_idc which is added to a picture header or the like represents a skip flag prediction direction flag.

As described above, according to this embodiment, explicitly giving the skip mode prediction direction flag to the picture header or the like allows the prediction direction in the skip mode to be flexibly switched for each picture. As a result, it is possible to properly decode the bitstream for which the coding efficiency is increased.

### Embodiment 8

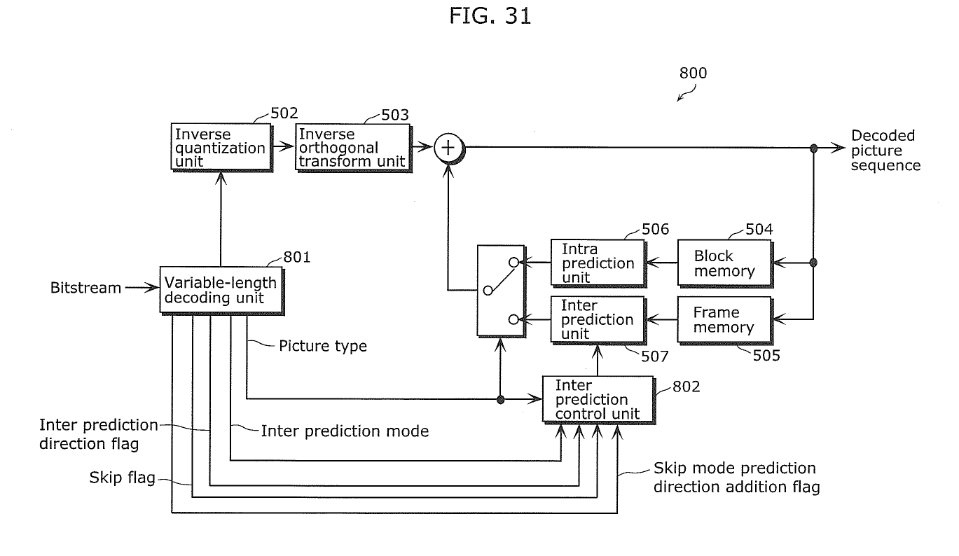

FIG. 31 is a block diagram showing a configuration of a moving picture decoding apparatus using a moving picture decoding method according to Embodiment 8 of the present invention. A moving picture decoding apparatus 800 according to this embodiment differs from the moving picture decoding apparatuses according to the other embodiments in decoding a bitstream in which a skip mode prediction direction addition flag generated by the skip mode prediction direction addition determination unit is added to header information (e.g., a picture parameter set or a slice header in H.264) for each unit of processing such as a picture. It is to be noted that the same reference signs are assigned to the same elements as in Embodiment 5, and a description thereof is omitted.

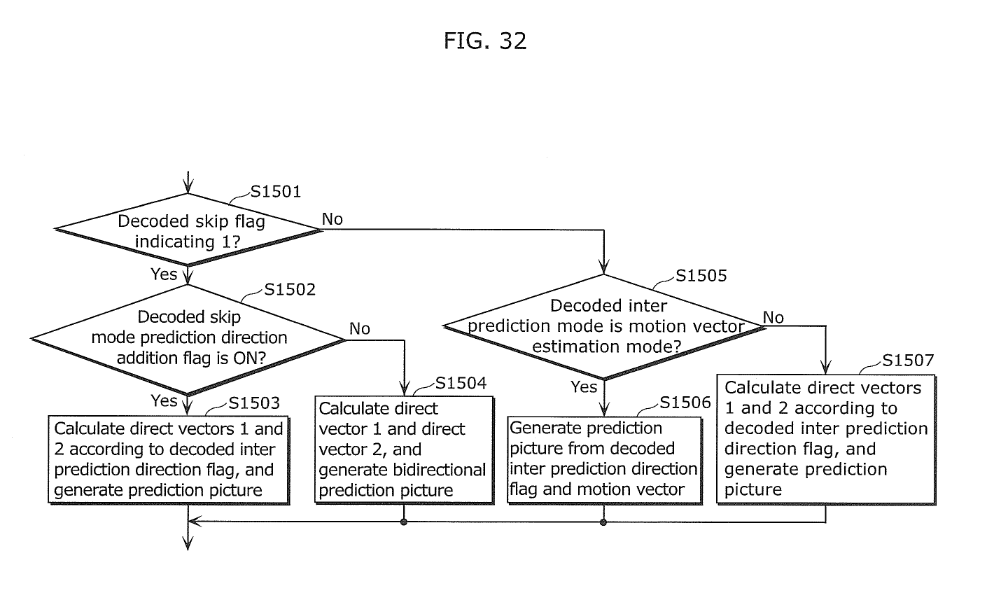

FIG. 32 is a flow chart showing an outline of a process flow of the moving picture decoding method according to this embodiment of the present invention.

An inter prediction control unit 802 determines whether or not a skip flag obtained by a variable-length decoding unit 801 decoding a bitstream indicates 1 (Step S1501). When it is determined that the skip flag indicates 1 (Yes in Step S1501), the inter prediction control unit 802 determines whether or not a skip mode prediction direction addition flag obtained by the variable-length decoding unit 801 is ON (Step S1502). When it is determined that the skip mode prediction direction addition flag is ON (Yes in Step S1502), the inter prediction control unit 802 decodes an inter prediction direction flag, calculates at least one of the direct vectors 1 and 2 according to the decoded inter prediction direction flag, and generates a unidirectional or bidirectional prediction picture (Step S1503). On the other hand, when it is determined that the skip mode prediction direction addition flag is not ON (No in Step S1502), the inter prediction control unit 802 calculates the direct vectors 1 and 2, and generates the bidirectional prediction picture (Step S1504). In contrast, when it is determined in Step S1505 that the skip flag does not indicate 1, that is, the skip flag does not indicate the skip mode (No in Step S1501), the inter prediction control unit 802 determines whether or not an inter prediction mode obtained by decoding performed by the variable-length decoding unit 801 is the motion vector estimation mode (Step S1505). When it is determined that the inter prediction mode is the motion vector estimation mode (Yes in Step S1505), the inter prediction control unit 802 generates a prediction picture using the inter prediction direction flag decoded by the variable-length decoding unit 801 and a motion vector (Step S1506). On the other hand, when it is determined that the inter prediction mode is not the motion vector estimation mode, that is, the inter prediction mode is the direct mode (No in Step S1505), the inter prediction control unit 802 calculates the direct vectors 1 and 2 according to the inter prediction direction flag, and generates a prediction picture (Step S1507).

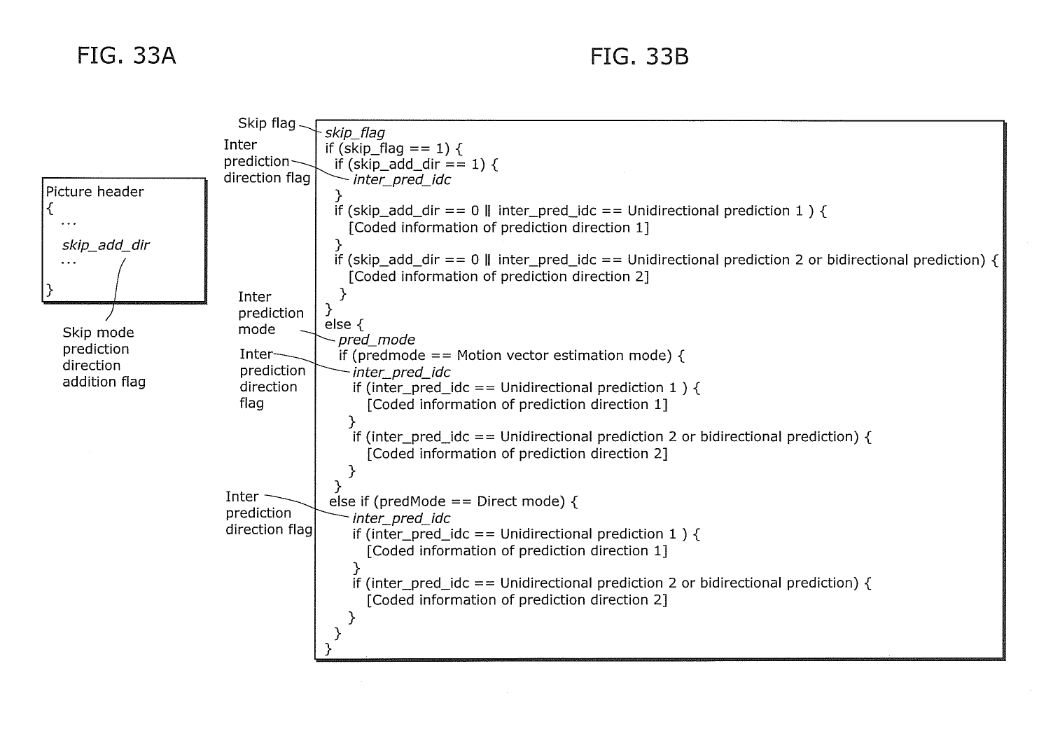

Each of FIGS. 33A and 33B is a diagram showing another example of syntax of a bitstream in the moving picture decoding method according to this embodiment of the present invention. In FIGS. 33A and 33B, skip_flag represents a skip flag, pred_mode represents an inter prediction mode, and inter_pred_idc represents an inter prediction direction flag. In addition, skip_add_dir that is added to a picture header or the like represents a skip flag prediction direction addition flag.

As described above, according to this embodiment, explicitly giving the skip mode prediction direction addition flag to the picture header or the like enables flexibly switching, for each picture, whether or not the prediction direction in the skip mode is to be added. As a result, it is possible to properly decode the bitstream for which the coding efficiency is increased.

### Embodiment 9

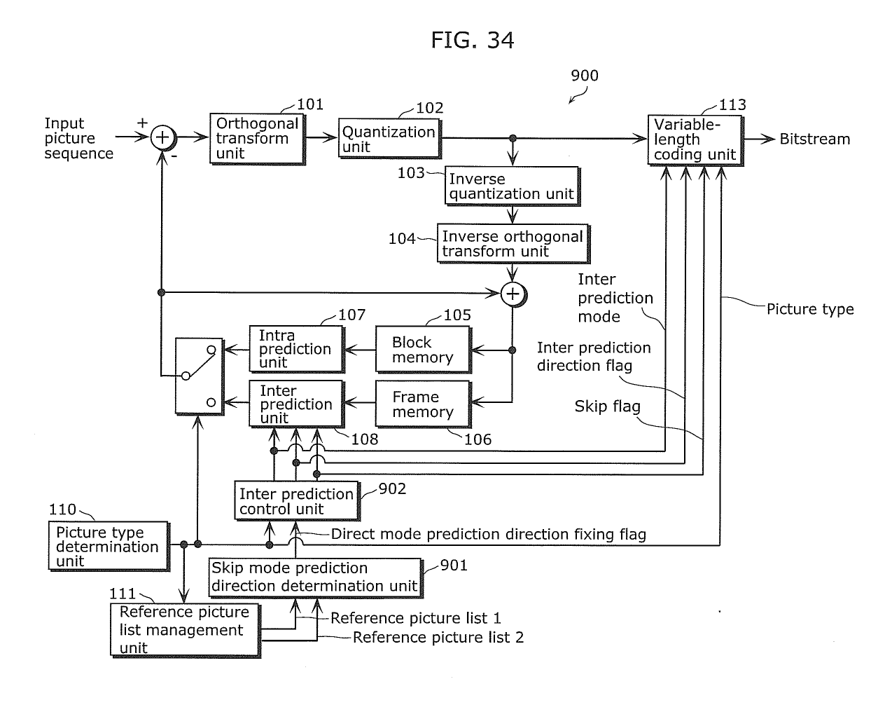

FIG. 34 is a block diagram showing a configuration of a moving picture coding apparatus using a moving picture coding method according to Embodiment 9 of the present invention.

A moving picture coding apparatus 900 includes, as shown in FIG. 34, the orthogonal transform unit 101, the quantization unit 102, the inverse quantization unit 103, the inverse orthogonal transform unit 104, the block memory 105, the frame memory 106, the intra prediction unit 107, the inter prediction unit 108, an inter prediction control unit 902, the picture type determination unit 110, the reference picture list management unit 111, a direct mode prediction direction determination unit 901, and the variable-length coding unit 113.

The orthogonal transform unit 101 transforms, from image domain into frequency domain, prediction error data between prediction picture data generated by a unit to be described later and an input picture sequence. The quantization unit 102 performs a quantization process on the prediction error data transformed into the frequency domain. The inverse quantization unit 103 performs an inverse quantization process on the prediction error data on which the quantization unit 102 has performed the quantization process. The inverse orthogonal transform unit 104 transforms, from frequency domain into image domain, the prediction error data on which the inverse quantization process has been performed. The block memory 105 stores, in units of blocks, a decoded picture obtained from the prediction picture data and the prediction error data on which the inverse quantization process has been performed. The frame memory 106 stores the decoded picture in units of frames. The picture type determination unit 110 determines which one of the picture types, I-picture, B-picture, and P-picture, is used to code the input picture sequence, and generates picture type information. The intra prediction unit 107 generates prediction picture data by performing intra prediction on a current block to be coded, using the decoded picture stored in the units of blocks in the block memory 105. The inter prediction unit 108 generates prediction picture data by performing inter prediction on the current block, using the decoded picture stored in the units of frames in the block memory 106.

The reference picture list management unit 111 assigns reference picture indexes to coded reference pictures to be referred to in the inter prediction, and creates reference picture lists together with display order and so on. Two reference picture lists correspond to the B-picture which is used for coding with reference to two pictures. It is to be noted that although the reference pictures are managed based on the reference picture indexes and the display order in this embodiment, the reference pictures may be managed based on the reference picture indexes, coding order, and so on.

The direct mode prediction direction determination unit 901 determines, through a method to be described later, a prediction direction in the direct mode for the current block, using reference picture lists 1 and 2 created by the reference picture list management unit 111.

The variable-length coding unit 113 generates a bitstream by performing a variable length coding process on the prediction error data on which the quantization process has been performed, an inter prediction mode, an inter prediction direction flag, a skip flag, and picture type information.

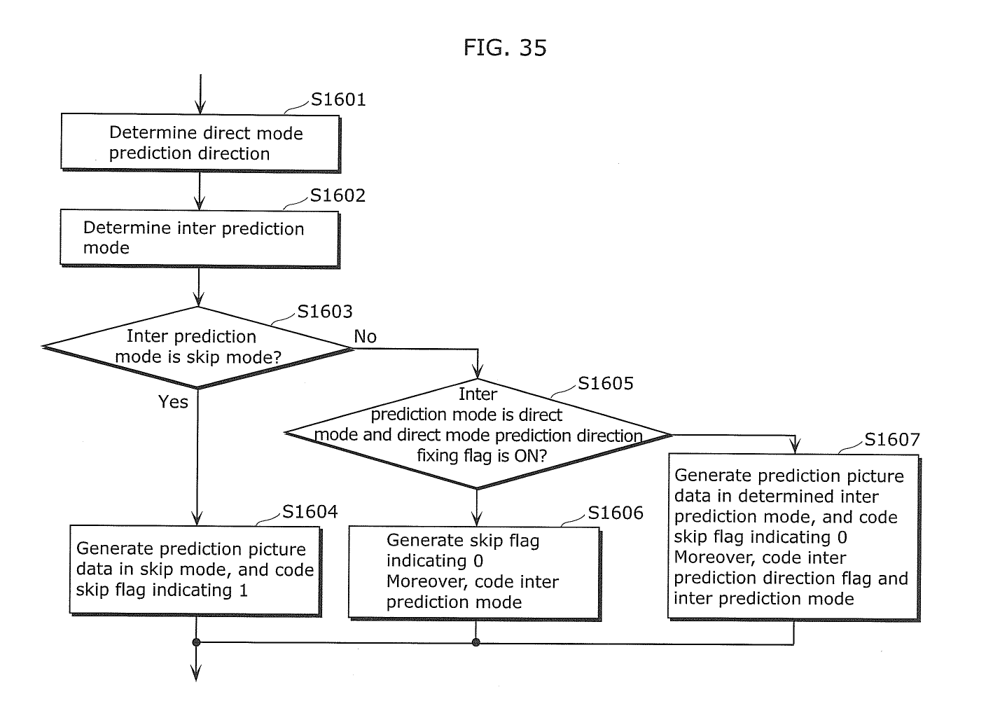

FIG. 35 is a flow chart showing an outline of a process flow of the moving picture coding method according to this embodiment of the present invention.

The direct mode prediction direction determination unit 901 determines a prediction direction in the case of coding a current block to be coded in the direct mode (Step S1601). The inter prediction control unit 902 compares a cost of the motion vector estimation mode in which a prediction picture is generated using a motion vector obtained by motion estimation, a cost of the direct mode in which a prediction picture is generated using a predicted motion vector generated from an adjacent block or the like, and a cost of the skip mode in which a prediction picture is generated using a predicted motion vector generated according to a prediction direction determined by the direct mode prediction direction determination unit 901, and determines a more efficient inter prediction mode from among the three modes (Step S1602). The method for calculating a cost is to be described later. Next, the inter prediction control unit 902 determines whether or not the determined inter prediction mode is the skip mode (Step S1603). When it is determined that the inter prediction mode is the skip mode (Yes in Step S1603), the inter prediction control unit 902 generates a prediction picture in the skip mode and sets a skip flag to indicate 1. Then, the inter prediction control unit 902 sends the skip flag to the variable-length coding unit 113 so that the skip flag is added to a bitstream of the current block (Step S1604). On the other hand, when it is determined that the inter prediction mode is not the skip mode (No in Step S1603), the inter prediction control unit 902 determines whether or not the determined inter prediction mode is the direct mode and whether or not a direct mode prediction direction fixing flag determined through a method to be described later is ON (Step S1605). When it is determined that the inter prediction mode is the direct mode and the direct mode prediction direction fixing flag is ON (Yes in Step S1605), the inter prediction control unit 902 generates a bidirectional prediction picture in the direct mode, and sets the skip flag to indicate 0. Then, the inter prediction control unit 902 sends the skip flag to the variable-length coding unit 113 so that the skip flag is added to the bitstream of the current block. Moreover, the inter prediction control unit 902 sends, to the variable-length coding unit 113, the inter prediction mode indicating the motion vector estimation mode or the direct mode so that the inter prediction mode is added to the bitstream of the current block (Step S1606). On the other hand, when it is determined that the inter prediction mode is not the direct mode and the direct mode prediction direction fixing flag is not ON (No in Step S1605), the inter prediction control unit 902 performs inter prediction according to the determined inter prediction mode, generates prediction picture data, and sets the skip flag to indicate 0. Then, the inter prediction control unit 902 sends the skip flag to the variable-length coding unit 113 so that the skip flag is added to the bitstream of the current block. Furthermore, the inter prediction control unit 902 sends, to the variable-length coding unit 113, the inter prediction mode and the inter prediction direction flag so that the inter prediction mode and the inter prediction direction flag are added to the bitstream of the current block, the inter prediction mode indicating the motion vector estimation mode or the direct mode, and the inter prediction direction flag indicating whether the inter prediction direction is the unidirectional prediction of the prediction direction 1, the unidirectional prediction of the prediction direction 2, or the bidirectional prediction using the prediction directions 1 and 2 (Step S1608).

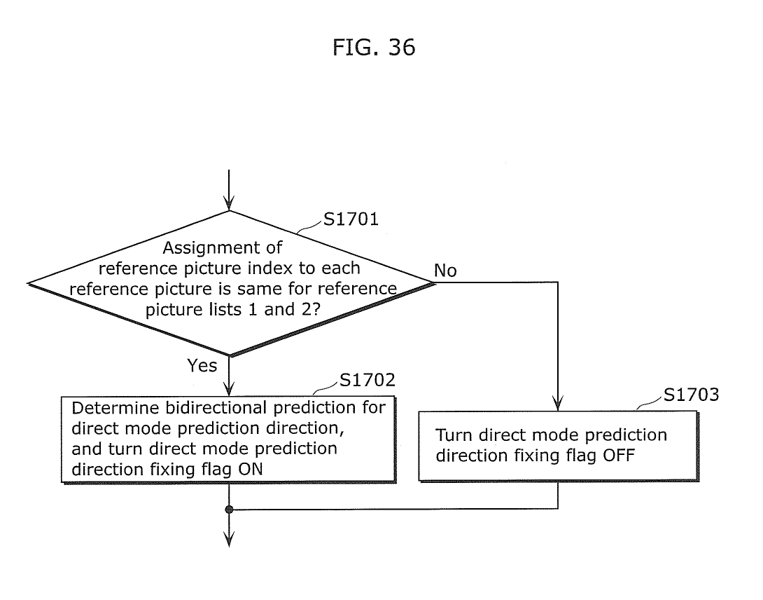

FIG. 36 is a flow chart showing a flow of determining a direct mode prediction direction which is performed by the direct mode prediction direction determination unit.

In general, when the assignment of the reference picture index to each reference picture is the same for the reference picture lists 1 and 2, there is a tendency that the costs of the bidirectional prediction and the unidirectional prediction are relatively similar to each other. As a result, it is not necessary to add the inter prediction direction flag for each current block by fixing a prediction direction to one of the bidirectional prediction and the unidirectional prediction. In this embodiment, the following gives a description using an example of fixing a prediction direction to the bidirectional prediction by which a prediction picture having relatively little noise due to the influence of the averaging or the like can be generated. It is to be noted that in the case of a picture having small effects of noise or the like, the prediction direction may be fixed to the unidirectional prediction from the point of the view of an amount of processing or the like.

The direct mode prediction direction determination unit 901 determines whether or not the assignment of the reference picture index to each reference picture is the same for the reference picture lists 1 and 2, using the reference picture lists 1 and 2 (Step S1701). For example, the display orders of the reference pictures indicated by the respective reference picture indexes 1 are obtained from the reference picture list 1 and are compared to the display orders of the reference pictures indicated by the respective reference picture indexes 2 in the reference picture list 2. When the display orders are the same, it is possible to determine that the assignment is the same for the reference picture lists 1 and 2. When it is determined that the assignment of the reference picture index to each reference picture is the same for the reference picture lists 1 and 2 (Yes in Step S1701), the direct mode prediction direction determination unit 901 determines bidirectional prediction for a prediction direction in the direct mode, and turns a direct mode prediction direction fixing flag ON (Step S1702). On the other hand, when it is determined that the assignment of the reference picture index to each reference picture is not the same for the reference picture lists 1 and 2 (No in Step S1701), the direct mode prediction direction determination unit 901 turns the direct mode prediction direction fixing flag OFF (Step S1703).

It is to be noted that although, by using the display order, it is determined in Step 1701 whether or not the assignment of the reference picture index to each reference picture is the same for the reference picture lists 1 and 2 in this embodiment, the determination may be made using coding order or the like.

Moreover, although the bidirectional prediction is determined for the prediction direction in the direct mode and the direct mode prediction direction fixing flag is turned ON when it is determined that the assignment of the reference picture index to each reference picture is the same for the reference picture lists 1 and 2 in this embodiment, the bidirectional prediction may be determined for the prediction direction in the direct mode and the direct mode prediction direction fixing flag may be turned ON when a reference picture indicated by the reference picture index 1 of the prediction direction 1 is the same as a reference picture indicated by the reference picture index 2 of the prediction direction 2 in the direct mode corresponding to the current block. For example, the display order of the reference picture indicated by the reference picture index 1 is obtained from the reference picture list 1 and is compared to the display order of the reference picture indicated by the reference picture index 2 in the reference picture list 2. When the display orders are the same, it is possible to determine that the pictures are the same for the reference picture lists 1 and 2. Even in such a case, there is the tendency that the costs of the bidirectional prediction and the unidirectional prediction are relatively similar to each other. As a result, it is not necessary to add the inter prediction direction flag for each current block by fixing the prediction direction to one of the bidirectional prediction and the unidirectional prediction. Consequently, it is possible to increase the coding efficiency.

Furthermore, when a current picture to be coded is a B-picture coded by using a bidirectional prediction picture with reference to two coded pictures located before the current picture, the bidirectional prediction may be determined for the prediction direction in the direct mode and the direct mode prediction direction fixing flag may be turned ON. For such a B-picture, there is the case where the assignment of the reference picture index to each reference picture is the same for the reference picture lists 1 and 2 or the case where the reference picture indicated by the reference picture index 1 of the prediction direction 1 is the same as the reference picture indicated by the reference picture index 2 of the prediction direction 2 in the direct mode corresponding to the current block. Even in such a case, there is the tendency that the costs of the bidirectional prediction and the unidirectional prediction are relatively similar to each other. As a result, it is not necessary to add the inter prediction direction flag for each current block by fixing the prediction direction to one of the bidirectional prediction and the unidirectional prediction. Consequently, it is possible to increase the coding efficiency.

Furthermore, when a current picture to be coded is a B-picture coded by using a bidirectional prediction picture with reference to two coded pictures located after the current picture, the bidirectional prediction may be determined for the prediction direction in the direct mode and the direct mode prediction direction fixing flag may be turned ON. For such a B-picture, there is the case where the assignment of the reference picture index to each reference picture is the same for the reference picture lists 1 and 2 or the case where the reference picture indicated by the reference picture index 1 of the prediction direction 1 is the same as the reference picture indicated by the reference picture index 2 of the prediction direction 2 in the direct mode corresponding to the current block. Even in such a case, there is the tendency that the costs of the bidirectional prediction and the unidirectional prediction are relatively similar to each other. As a result, it is not necessary to add the inter prediction direction flag for each current block by fixing the prediction direction to one of the bidirectional prediction and the unidirectional prediction. Consequently, it is possible to increase the coding efficiency.

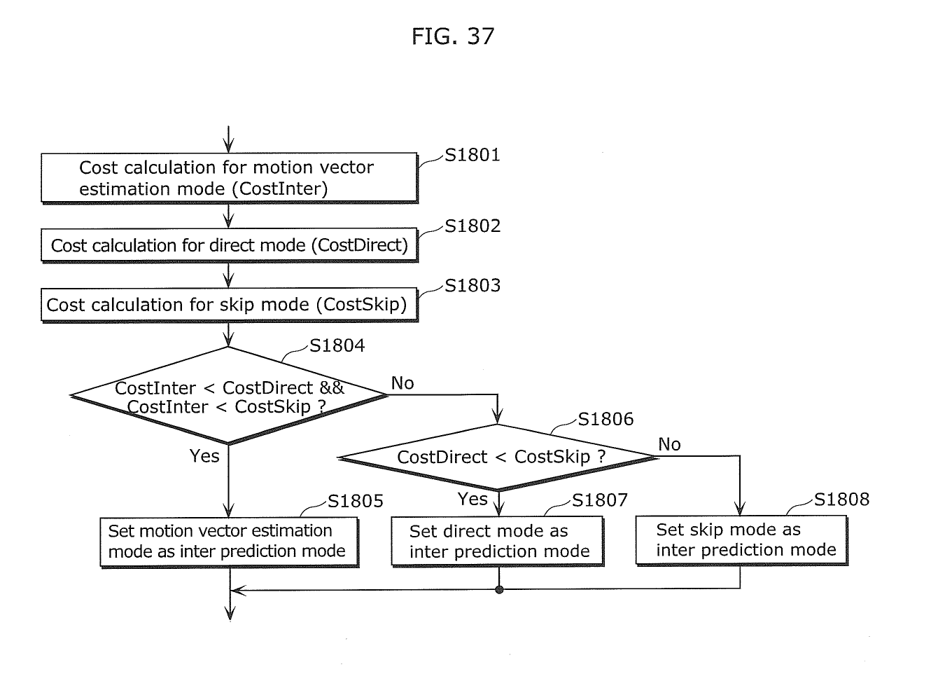

FIG. 37 is a flow chart showing a flow of determining an inter prediction mode which is performed by the inter prediction control unit.

The inter prediction control unit 902 calculates, through a method to be described later, cost CostInter of the motion vector estimation mode in which the prediction picture is generated using the motion vector obtained by the motion estimation (Step S1801). The inter prediction control unit 902 generates a predicted motion vector using a motion vector of an adjacent block or the like according to a direct mode prediction direction fixing flag determined by the direct mode prediction direction determination unit 901, and calculates, through a method to be described later, cost CostDirect of the direct mode in which the prediction picture is generated using the predicted motion vector (Step S1802). The inter prediction control unit 902 calculates, through a method to be described later, cost CostSkip of the skip mode in which a prediction picture at a position indicated by a motion vector predicted from the adjacent block or the like is directly used as a decoded picture (Step S1803). The inter prediction control unit 902 compares the cost CostInter of the motion vector estimation mode, the cost CostDirect of the direct mode, and the cost CostSkip of the skip mode, and determines whether or not the cost CostInter of the motion vector estimation mode is smallest (Step S1804). When it is determined that the cost CostInter of the motion vector estimation mode is smallest (Yes in Step S1804), the inter prediction control unit 902 determines and sets the motion vector estimation mode as the inter prediction mode (Step S1805). On the other hand, when it is determined that the cost CostInter of the motion vector estimation mode is not smallest (No in Step S1804), the inter prediction control unit 902 compares the cost CostDirect of the direct mode and the cost CostSkip of the skip mode, and determines whether or not the cost CostDirect of the direct mode is smaller (Step S1806). When it is determined that the cost CostDirect of the direct mode is smaller (Yes in Step S1806), the inter prediction control unit 902 determines and sets the direct mode as the inter prediction mode (Step S1807). On the other hand, when it is determined that the cost CostDirect of the direct mode is not smaller, the inter prediction control unit 902 determines and sets the skip mode as the inter prediction mode (Step S1808).

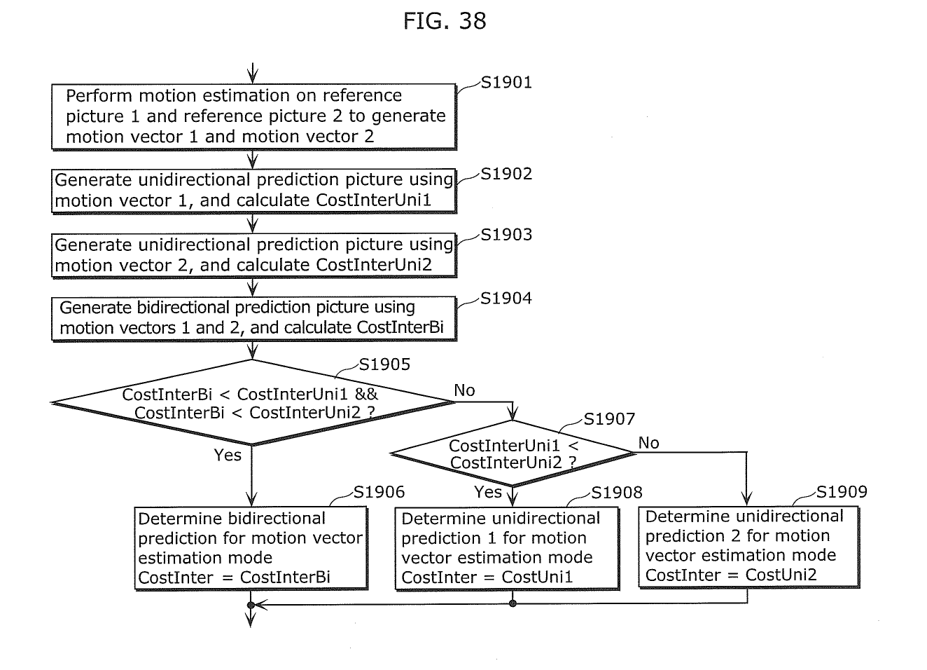

The following describes in detail the cost CostInter calculation method used in Step S1801 shown in FIG. 37, with reference to FIG. 38. FIG. 38 is a flow chart showing a process flow of cost CostInter calculation in the motion vector estimation mode.

The inter prediction control unit 902 performs motion estimation on a reference picture 1 indicated by a reference picture index 1 of the prediction direction 1 and a reference picture 2 indicated by a reference picture index 2 of the prediction direction 2, so as to generate the motion vector 1 and the motion vector 2 corresponding to the respective reference pictures (Step S1901). Here, the motion estimation refers to calculating a difference value between a current block to be coded in a picture to be coded and a block in a reference picture, using a block having the smallest difference value in the reference picture as a reference block, and calculating a motion vector based on a position of the current block and a position of the reference block. Next, the inter prediction control unit 902 generates a prediction picture in the prediction direction 1 using the generated motion vector 1, and calculates cost CostInterUni1 of the prediction picture by, for instance, the equation of the R-D optimization model (Step S1902).

The inter prediction control unit 902 generates a prediction picture in the prediction direction 2 using the generated motion vector 2, and calculates cost CostInterUni2 of the prediction picture by Equation 1 (Step S1903). The inter prediction control unit 902 generates a bidirectional prediction picture using the generated motion vectors 1 and 2, and calculates cost CostInterBi of the bidirectional prediction picture by Equation 1 (Step S1904). Here, the bidirectional prediction picture is, for instance, a bidirectional prediction picture obtained by performing, for each pixel, averaging on the prediction picture generated using the motion vector 1 and the prediction picture generated using the motion vector 2. Next, the inter prediction control unit 902 compares the values of the cost CostInterUni1, the cost CostInterUni2, and the cost CostInterBi, and determines whether or not the cost CostInterBi is smallest (Step S1905). When it is determined that the cost CostInterBi is smallest (Yes in Step S1905), the inter prediction control unit 902 determines the bidirectional prediction for the prediction direction in the motion vector estimation mode, and sets the cost CostInterBi to the cost CostInter of the motion vector estimation mode (Step S1906). On the other hand, when it is determined that the cost CostInterBi is not smallest (No in Step S1905), the inter prediction control unit 902 compares the cost CostInterUni1 and the cost CostInterUni2, and determines whether or not the value of the cost CostInterUni1 is smaller (Step S1907). When it is determined that the value of the cost CostInterUni1 is smaller (Yes in Step S1907), the inter prediction control unit 902 determines unidirectional prediction 1 of the prediction direction for the motion vector estimation mode, and sets the cost CostInterUni1 to the cost CostInter of the motion vector estimation mode (Step S1908). On the other hand, when it is determined that the value of the cost CostInterUni1 is not smaller (No in Step S1907), the inter prediction control unit 902 determines unidirectional prediction 2 of the prediction direction 2 for the motion vector estimation mode, and sets the cost CostInterUni2 to the cost CostInter of the motion vector estimation mode (Step S1909).

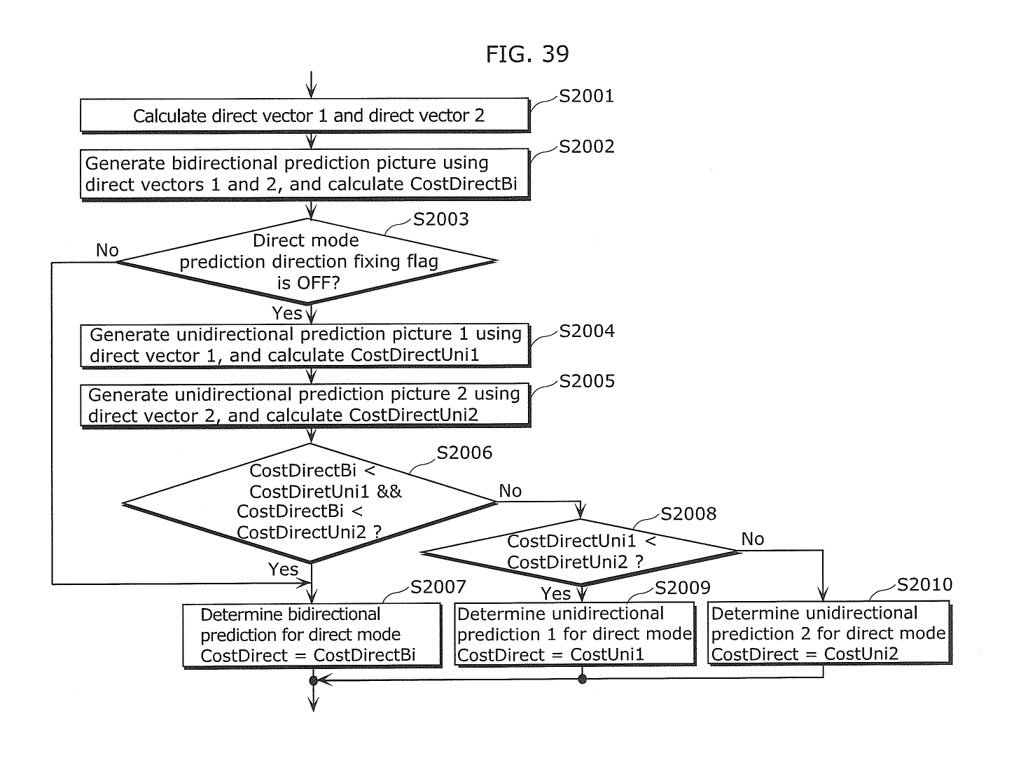

It is to be noted that although the averaging is performed for each pixel when the bidirectional prediction picture is generated in this embodiment, weighted averaging may be performed. The following describes in detail the cost CostDirect calculation method used in Step S1802 shown in FIG. 37, with reference to FIG. 39. FIG. 39 is a flow chart showing a process flow of cost CostDirect calculation in the direct mode.

The inter prediction control unit 902 calculates the direct vector 1 in the prediction direction 1 and the direct vector 2 in the prediction direction 2 (Step S2001). Here, the direct vectors are calculated by, for instance, the method described in Step S501 of FIG. 8 in Embodiment 1. Then, the inter prediction control unit 902 generates a bidirectional prediction picture using the calculated direct vectors 1 and 2, and calculates cost CostDirectBi of the bidirectional prediction picture by Equation 1 (Step S2002). Here, the bidirectional prediction picture is, for instance, a bidirectional prediction picture obtained by performing, for each pixel, averaging on the prediction picture generated using the motion vector 1 and the prediction picture generated using the motion vector 2. Next, the inter prediction control unit 902 determines whether or not a direct mode prediction direction fixing flag is OFF (Step S2003). When it is determined that the direct mode prediction direction fixing flag is OFF (Yes in Step S2003), the inter prediction control unit 902 generates a prediction picture in the prediction direction 1 using the direct vector 1, and calculates cost CostDirectUni1 of the prediction picture by Equation 1 (Step S2004). The inter prediction control unit 902 generates a prediction picture in the prediction direction 2 using the calculated direct vector 2, and calculates cost CostDirectUni2 of the prediction picture by Equation 1 (Step S2005). Next, the inter prediction control unit 902 compares a value of the cost CostDirectUni1, a value of the cost CostDirectUni2, and a value of the cost CostDirectBi, and determines whether or not the cost CostDirectBi is smallest (Step S2006). When it is determined that the cost CostDirectBi is smallest (Yes in Step S2006), the inter prediction control unit 902 determines the bidirectional prediction for the prediction direction in the direct mode, and sets the cost CostDirectBi to the cost CostDirect in the direct mode (Step S2007). On the other hand, when it is determined that the cost CostDirectBi is not smallest (No in Step S2006), the inter prediction control unit 902 compares the cost CostDirectUni1 and the cost CostDirectUni2, and determines whether or not the value of the cost CostDirectUni1 is smaller (Step S2008). When it is determined that the value of the cost CostDirectUni1 is smaller (Yes in Step S2008), the inter prediction control unit 902 determines the unidirectional prediction 1 in the prediction direction 1 for the direct mode, and sets the cost CostDirectUni1 to the cost CostDirect in the direct mode (Step S2009). On the other hand, when it is determined that the value of the cost CostDirectUni1 is not smaller (No in Step S2008), the inter prediction control unit 902 determines the unidirectional prediction 2 in the prediction direction 2 for the direct mode, and sets the cost CostDirectUni2 to the cost CostDirect in the direct mode (Step S2010). Moreover, when it is determined in Step S2003 that the direct prediction direction fixing flag is ON (No in Step S2003), the inter prediction control unit 902 determines the bidirectional prediction for the prediction direction in the direct mode, and sets the cost CostDirectBi to the cost CostDirect in the direct mode (Step S2007).

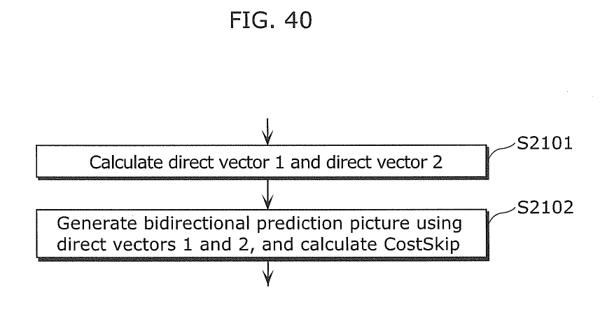

The following describes in detail the cost CostSkip calculation method used in Step S1803 shown in FIG. 37, with reference to FIG. 40. FIG. 40 is a flow chart showing a process flow of cost CostSkip calculation in the skip mode.

The inter prediction control unit 902 calculates the direct vector 1 in the prediction direction 1 and the direct vector 2 in the prediction direction 2 (Step S2101). Here, the direct vectors are calculated by, for instance, the method described in Step S501 of FIG. 8 in Embodiment 1. Next, the inter prediction control unit 902 generates a bidirectional prediction picture using the direct vectors 1 and 2, and calculates cost CostSkip in the skip mode by Equation 1 (Step S2102). Here, the bidirectional prediction picture is, for instance, a bidirectional prediction picture obtained by performing, for each pixel, averaging on the prediction picture generated using the motion vector 1 and the prediction picture generated using the motion vector 2.

As described above, according to this embodiment, when the prediction direction in the direct mode is determined, it is possible to enhance the quality of the prediction picture in the direct mode by selecting the prediction direction most suitable for the current block and adding the selected prediction direction to the bitstream, regardless of the prediction direction of the adjacent block. As a result, it is possible to increase the coding efficiency.

Moreover, when the assignment of the reference picture index to each reference picture is the same for the reference picture lists 1 and 2, there is the tendency that the costs of the bidirectional prediction and the unidirectional prediction are relatively similar to each other. As a result, the prediction direction in the direction mode is fixed to the bidirectional prediction by which the prediction picture having relatively little noise can be generated. With this, it is not necessary to always add the prediction direction flag in the direct mode for each current block, and thus it is possible to increase the coding efficiency by reducing an unnecessary amount of information.

### Embodiment 10

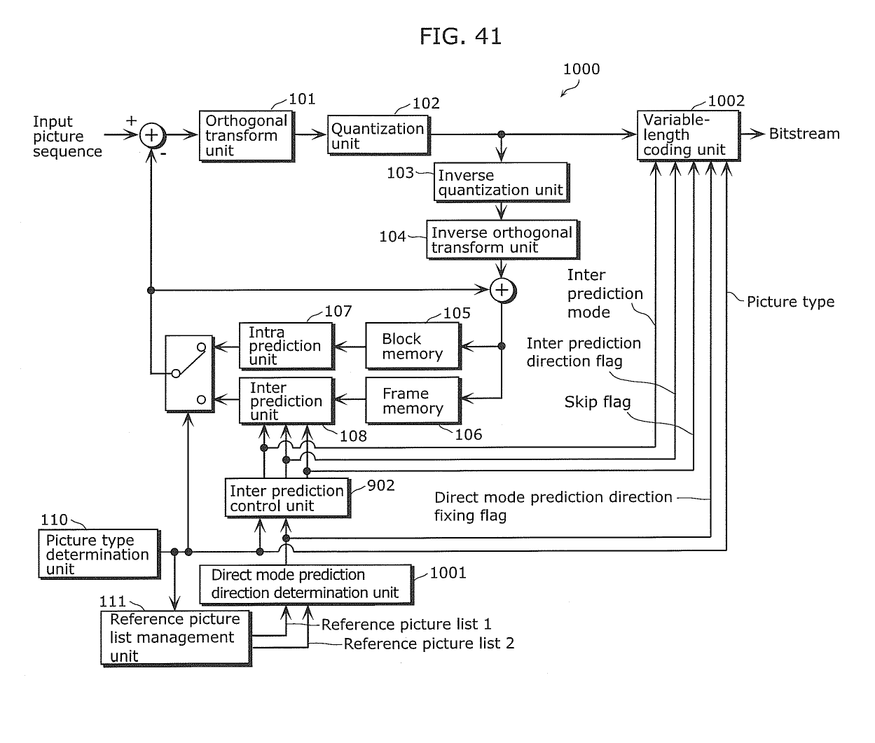

FIG. 41 is a block diagram showing a configuration of a moving picture coding apparatus using a moving picture coding method according to Embodiment 10 of the present invention. A moving picture coding apparatus 1000 according to this embodiment differs from the moving picture coding apparatus according to Embodiment 9 in that a direct mode prediction direction fixing flag generated by the direct mode prediction direction determination unit is added to header information (e.g., a picture parameter set or a slice header in H.264) which is given to a bitstream for each unit of processing such as a picture. It is to be noted that the same reference signs are assigned to the same elements as in Embodiment 9, and a description thereof is omitted.

A direct mode prediction direction determination unit 1001 determines a prediction direction in the direct mode of a current block to be coded, using the reference picture lists 1 and 2 as in Embodiment 1. Moreover, the direct mode prediction direction determination unit 1001 sends a set direct mode prediction direction fixing flag to a variable-length coding unit 1002 in addition to the inter prediction control unit 902.

A variable-length coding unit 1002 generates a bitstream by performing a variable length coding process on prediction error data on which the quantization process has been performed, an inter prediction mode, an inter prediction direction flag, a skip flag, picture type information, and a direct mode prediction direction fixing flag.

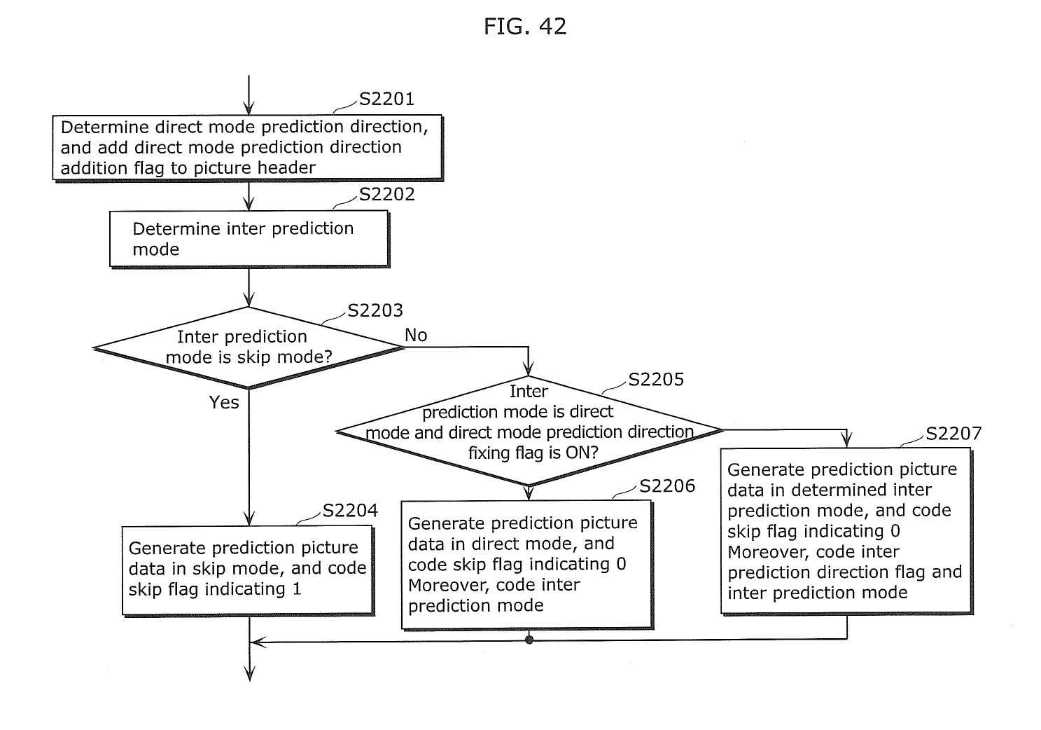

FIG. 42 is a flow chart showing an outline of a process flow of the moving picture coding method according to this embodiment of the present invention.

The direct mode prediction direction determination unit 1001 determines a prediction direction in the case of coding a current block to be coded in the direct mode, and sends a determined direct mode prediction direction fixing flag to the variable-length coding unit 1002 so that the direct mode prediction direction fixing flag is added to a picture header or the like (Step S2201). Here, the method of determining a direct mode prediction direction is the same as in the flow or the like shown in FIG. 36 in Embodiment 9. The inter prediction control unit 902 compares a cost of the motion vector estimation mode in which a prediction picture is generated using a motion vector obtained by motion estimation, a cost of the direct mode in which a prediction picture is generated using a predicted motion vector generated from an adjacent block or the like, and a cost of the skip mode in which a prediction picture is generated using a predicted motion vector generated according to a prediction direction determined by the direct mode prediction direction determination unit 1001, and determines a more efficient inter prediction mode from among the three modes (Step S2202). Here, Equation 1 or the like is used for the method for calculating a cost. Next, the inter prediction control unit 902 determines whether or not the determined inter prediction mode is the skip mode (Step S2203). When it is determined that the inter prediction mode is the skip mode (Yes in Step S2203), the inter prediction control unit 902 generates a prediction picture in the skip mode and sets a skip flag to indicate 1. Then, the inter prediction control unit 902 sends the skip flag to the variable-length coding unit 1002 so that the skip flag is added to a bitstream of the current block (Step S2204). On the other hand, when it is determined that the inter prediction mode is not the skip mode (No in Step S2203), the inter prediction control unit 902 determines whether or not the determined inter prediction mode is the direct mode and whether or not the direct mode prediction direction fixing flag is ON (Step S2205). When it is determined that the inter prediction mode is the direct mode and the direct mode prediction direction fixing flag is ON (Yes in Step S2205), the inter prediction control unit 902 generates a bidirectional prediction picture in the direct mode, and sets the skip flag to indicate 0. Then, the inter prediction control unit 902 sends the skip flag to the variable-length coding unit 1002 so that the skip flag is added to the bitstream of the current block. Moreover, the inter prediction control unit 902 sends, to the variable-length coding unit 1002, the inter prediction mode indicating the motion vector estimation mode or the direct mode so that the inter prediction direction mode is added to the bitstream of the current block (Step S2206). On the other hand, when it is determined that the inter prediction mode is not the direct mode and the direct mode prediction direction fixing flag is not ON (No in Step S2205), the inter prediction control unit 902 performs inter prediction according to the determined inter prediction mode, generates prediction picture data, and sets the skip flag to indicate 0. Then, the inter prediction control unit 902 sends the skip flag to the variable-length coding unit 1002 so that the skip flag is added to the bitstream of the current block. Furthermore, the inter prediction control unit 902 sends, to the variable-length coding unit 1002, the inter prediction mode and the inter prediction direction flag so that the inter prediction mode and the inter prediction direction flag are added to the bitstream of the current block, the inter prediction mode indicating the motion vector estimation mode or the direct mode, and the inter prediction direction flag indicating whether the inter prediction direction is the unidirectional prediction of the prediction direction 1, the unidirectional prediction of the prediction direction 2, or the bidirectional prediction using the prediction directions 1 and 2 (Step S2207). It is to be noted that the method of determining an inter prediction mode or the like is the same as Embodiment 9, and thus a description thereof is omitted.

As described above, according to this embodiment, explicitly giving the direct mode prediction direction fixing flag to the picture header or the like enables flexibly switching, for each picture, whether or not the prediction direction in the direct mode is to be fixed to the bidirectional prediction. As a result, it is possible to increase the coding efficiency.

### Embodiment 11

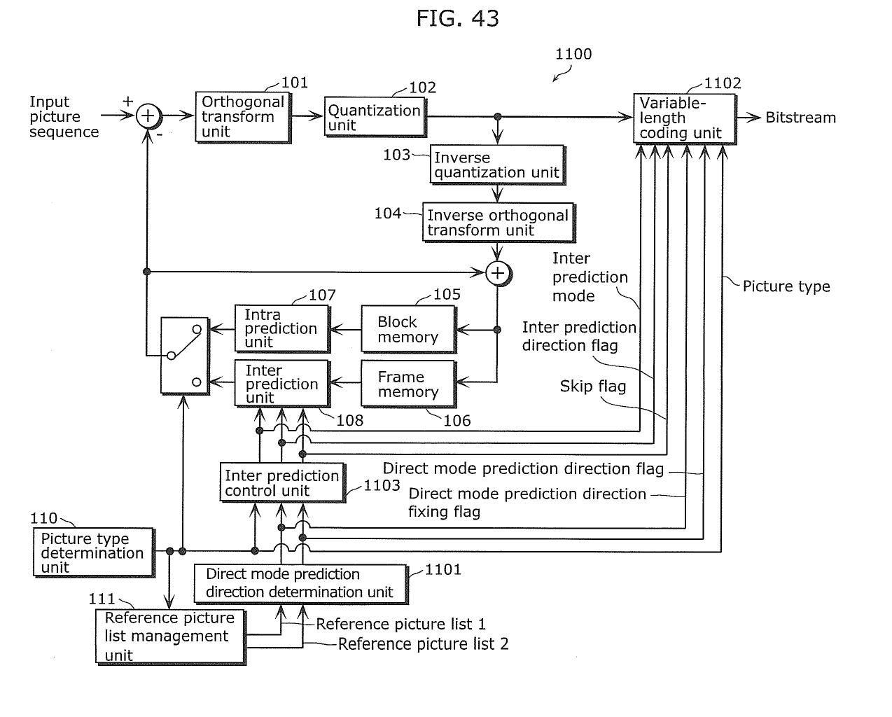

FIG. 43 is a block diagram showing a configuration of a moving picture coding apparatus using a moving picture coding method according to Embodiment 11 of the present invention. A moving picture coding apparatus 1100 according to this embodiment differs from the moving picture coding apparatus according to Embodiment 9 in that a direct mode prediction direction flag generated by the direct mode prediction direction determination unit and a direct mode prediction direction fixing flag are added to header information (e.g., a picture parameter set or a slice header in H.264) which is given to a bitstream for each unit of processing such as a picture. It is to be noted that the same reference signs are assigned to the same elements as in Embodiment 9, and a description thereof is omitted.

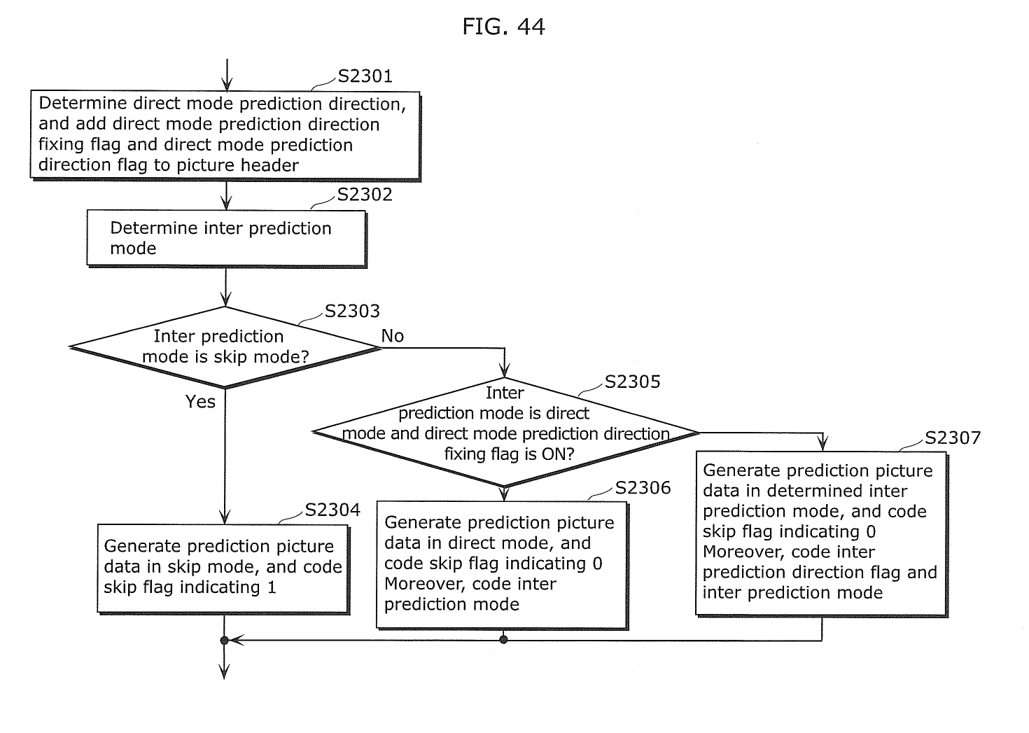

FIG. 44 is a flow chart showing an outline of a process flow of the moving picture coding method according to this embodiment of the present invention.

A direct mode prediction direction determination unit 1101 determines a prediction direction in the case of coding a current block to be coded in the direct mode, and sends a determined direct mode prediction direction fixing flag and a direct prediction direction flag to a variable-length coding unit 1102 so that the direct mode prediction direction fixing flag and the direct prediction direction flag are added to a picture header or the like (Step S2301). Here, the method of determining a direct mode prediction direction is the same as in the flow or the like shown in FIG. 36 in Embodiment 9. An inter prediction control unit 1103 compares a cost of the motion vector estimation mode in which a prediction picture is generated using a motion vector obtained by motion estimation, a cost of the direct mode in which a prediction picture is generated using a predicted motion vector generated from an adjacent block or the like, and a cost of the skip mode in which a prediction picture is generated using a predicted motion vector generated according to a prediction direction determined by the direct mode prediction direction determination unit 1101, and determines a more efficient inter prediction mode from among the three modes (Step S2302). Here, Equation 1 or the like is used for the method for calculating a cost. Next, the inter prediction control unit 1103 determines whether or not the determined inter prediction mode is the skip mode (Step S2303). When it is determined that the inter prediction mode is the skip mode (Yes in Step S2303), the inter prediction control unit 1103 generates a prediction picture in the skip mode and sets a skip flag to indicate 1. Then, the inter prediction control unit 1103 sends the skip flag to the variable-length coding unit 1102 so that the skip flag is added to a bitstream of the current block (Step S2304). On the other hand, when it is determined that the inter prediction mode is not the skip mode, the inter prediction control unit 1103 determines whether or not the determined inter prediction mode is the direct mode and whether or not the direct mode prediction direction fixing flag is ON (Step S2305). When it is determined that the inter prediction mode is the direct mode and the direct mode prediction direction fixing flag is ON (Yes in Step S2305), the inter prediction control unit 1103 generates a prediction picture according to the determined prediction direction in the direct mode, and sets the skip flag to indicate 0. Then, the inter prediction control unit 1103 sends the skip flag to the variable-length coding unit 1102 so that the skip flag is added to the bitstream of the current block. Moreover, the inter prediction control unit 1103 sends, to the variable-length coding unit 1102, the inter prediction mode indicating the motion vector estimation mode or the direct mode so that the inter prediction mode is added to the bitstream of the current block (Step S2306). On the other hand, when it is determined that the inter prediction mode is not the direct mode and the direct mode prediction direction fixing flag is not ON (No in Step S2305), the inter prediction control unit 1103 performs inter prediction according to the determined inter prediction mode, generates prediction picture data, and sets the skip flag to indicate 0. Then, the inter prediction control unit 1103 sends the skip flag to the variable-length coding unit 1102 so that the skip flag is added to the bitstream of the current block. Moreover, the inter prediction control unit 1103 sends, to the variable-length coding unit 1102, the inter prediction mode indicating the motion vector estimation mode or the direct mode and the inter prediction direction flag so that the inter prediction mode and the inter prediction direction flag are added to the bitstream of the current block (Step S2307). It is to be noted that the method of determining an inter prediction mode or the like is the same as Embodiment 9, and thus a description thereof is omitted.

As described above, according to this embodiment, explicitly giving the direct mode prediction direction fixing flag and the direct prediction direction flag to the picture header or the like enables flexibly switching, for each picture, whether or not the prediction direction in the direct mode is to be fixed to a prediction direction. As a result, it is possible to increase the coding efficiency.

### Embodiment 12

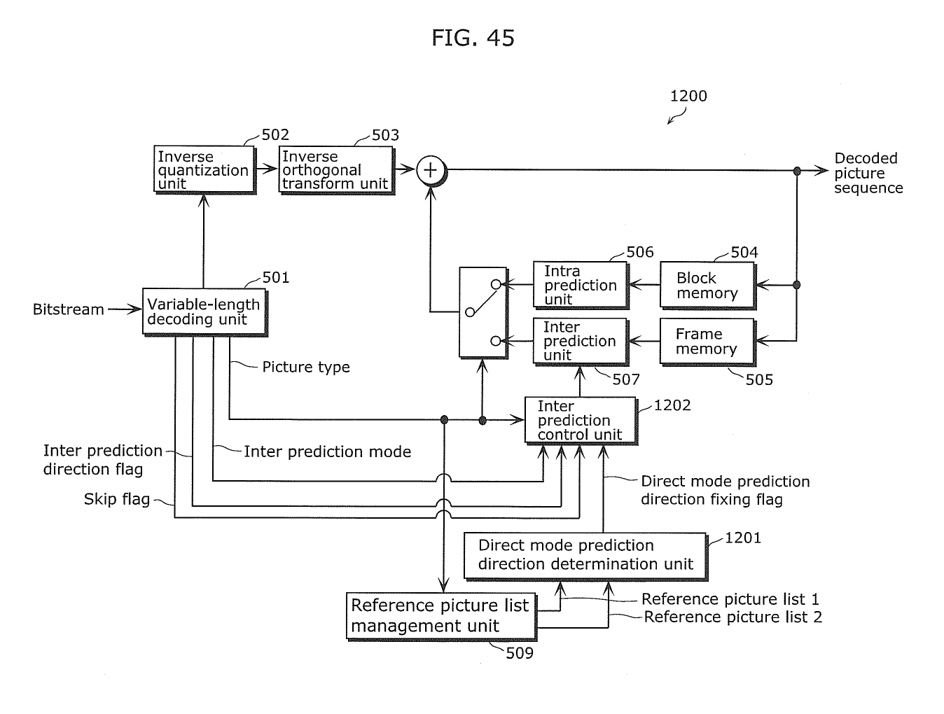

FIG. 45 is a block diagram showing a configuration of a moving picture decoding apparatus using a moving picture decoding method according to Embodiment 12 of the present invention.

As shown in FIG. 45, a moving picture decoding apparatus 1200 includes the variable-length decoding unit 501, the inverse quantization unit 502, the inverse orthogonal transform unit 503, the block memory 504, the frame memory 505, the intra prediction unit 506, the inter prediction unit 507, an inter prediction control unit 1202, the reference picture list management unit 509, and a direct mode prediction direction determination unit 1201.

The variable-length decoding unit 501 performs a variable-length decoding process on an inputted bitstream, to generate picture type information, an inter prediction mode, an inter prediction direction flag, a skip flag, and a quantized coefficient on which the variable-length decoding process has been performed. The inverse quantization unit 502 performs an inverse quantization process on the quantized coefficient on which the variable-length decoding process has been performed. The inverse orthogonal transform unit 503 transforms, from frequency domain into image domain, an orthogonal transform coefficient on which the inverse quantization process has been performed, to generate prediction error picture data. The block memory 504 stores, in units of blocks, a picture sequence generated by adding the prediction error picture data and prediction picture data. The frame memory 505 stores the picture sequence in units of frames. The intra prediction unit 506 generates prediction picture data of a current block to be decoded, through intra prediction, using the picture sequence stored in the units of the blocks in the block memory 504. The inter prediction unit 507 generates prediction picture data of the current block through inter prediction, using the picture sequence stored in the units of the frames in the frame memory 505. The inter prediction control unit 1202 controls motion vectors in the inter prediction and the method for generating prediction picture data, according to the inter prediction mode, the inter prediction direction, and the skip flag.

The reference picture list management unit 509 assigns reference picture indexes to coded reference pictures to be referred to in the inter prediction, and creates reference picture lists together with display order and so on. Two reference picture lists correspond to the B-picture which is used for coding with reference to two pictures.

It is to be noted that although the reference pictures are managed based on the reference picture indexes and the display order in this embodiment, the reference pictures may be managed based on the reference picture indexes, coding order, and so on.

The direct mode prediction direction determination unit 1201 determines a prediction direction in the direct mode for the current block, using reference picture lists 1 and 2 created by the reference picture list management unit 509, and sets a direct mode prediction direction fixing flag. It is to be noted that a flow of determining a skip mode prediction direction flag is the same as FIG. 36 in Embodiment 9, and thus a description thereof is omitted.

Lastly, a decoded picture sequence is generated by adding decoded prediction error picture data and the prediction picture data.

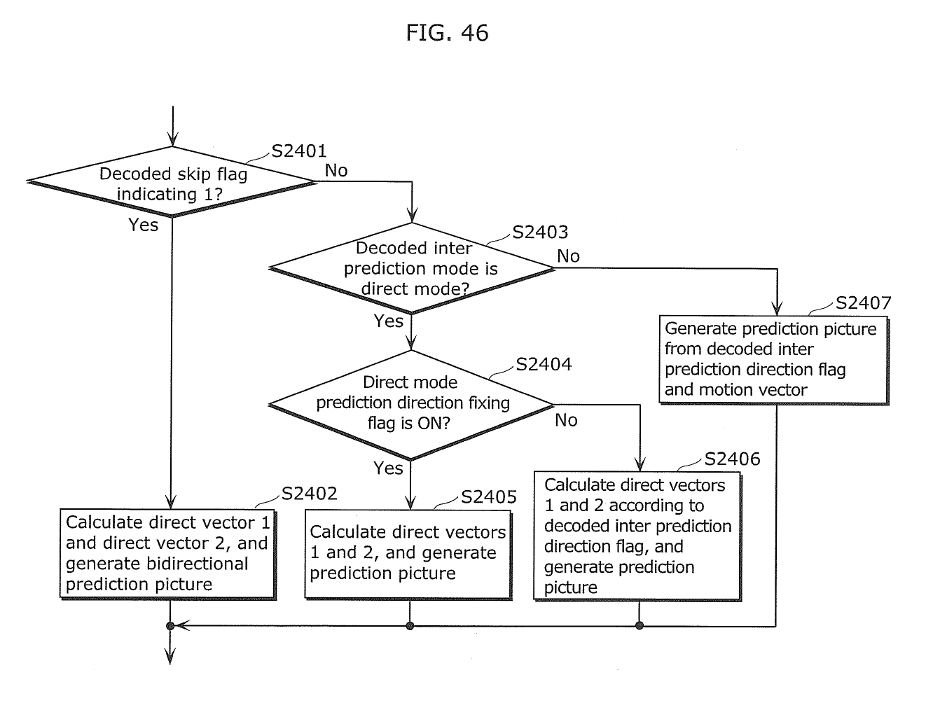

FIG. 46 is a flow chart showing an outline of a process flow of the moving picture decoding method according to this embodiment of the present invention.

The inter prediction control unit 1202 determines whether or not a skip flag obtained by the variable-length decoding unit 501 decoding a bitstream indicates 1 (Step S2401). When it is determined that the skip flag indicates 1 (Yes in Step S2401), the inter prediction control unit 1202 calculates direct vectors 1 and 2, and generates a bidirectional prediction picture (Step S2402). Here, the direct vectors are calculated by, for instance, the method described in Step S501 of FIG. 8 in Embodiment 1. On the other hand, when it is determined that the skip flag does not indicate 1, that is, the skip flag does not indicate the skip mode (No in Step S2401), the inter prediction control unit 1202 determines whether or not an inter prediction mode obtained by decoding performed by the variable-length decoding unit 501 is the direct mode (Step S2403). When it is determined that the inter prediction mode is the direct mode (Yes in Step S2403), the inter prediction control unit 1202 determines whether or not a direct mode prediction direction fixing flag is ON (Step S2404). When it is determined that the direct mode prediction direction fixing flag is ON (Yes in Step S2404), the inter prediction control unit 1202 calculates the direct vectors 1 and 2, and generates the bidirectional prediction picture (Step S2405). On the other hand, when it is determined that the direct mode prediction direction fixing flag is not ON (No in Step S2404), the inter prediction control unit 1202 calculates the direct vectors 1 and 2 according to the inter prediction direction obtained by decoding performed by the variable-length decoding unit 501, and generates a prediction picture (Step S2406). In contrast, when it is determined in Step S2403 that the inter prediction mode is not the direct mode, that is, the inter prediction mode is the motion vector estimation mode (No in Step S2403), the inter prediction control unit 1202 generates the prediction picture using a motion vector and the inter prediction direction obtained by decoding performed by the variable-length decoding unit 501 (Step S2407). It is to be noted that although the bidirectional prediction picture is generated when the direct mode prediction direction fixing flag is ON in Step S2405 in this embodiment, for instance, a unidirectional prediction picture may be generated in the same manner as the coding method.

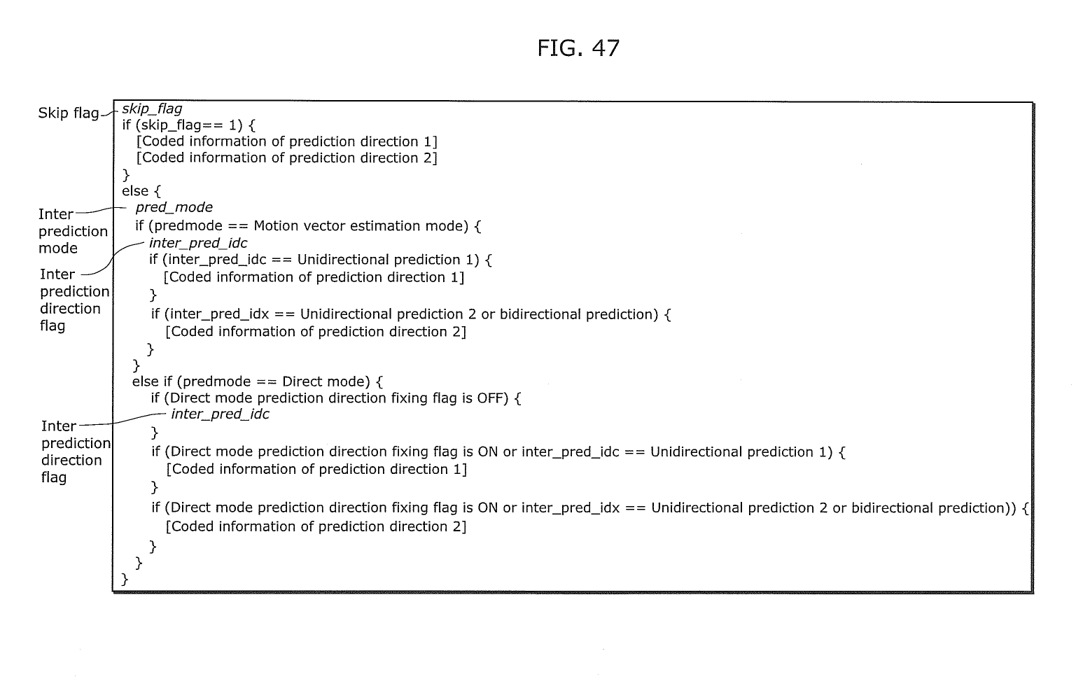

FIG. 47 is a diagram showing an example of syntax of a bitstream in the moving picture decoding method according to this embodiment of the present invention. In FIG. 47, skip_flag represents a skip flag, pred_mode represents an inter prediction mode, and inter_pred_idc represents an inter prediction direction flag

As described above, according to this embodiment, it is possible to properly decode the bitstream for which the coding efficiency is increased, by selecting the prediction direction most suitable for the current block and adding the selected prediction direction to the bitstream, regardless of the prediction direction of the adjacent block, when the prediction direction in the direct mode is determined.

Moreover, when the assignment of the reference picture index to each reference picture is the same for the reference picture lists 1 and 2, the prediction direction in the direct mode is fixed to the bidirectional prediction and the direct mode prediction direction flag is not added to the bitstream. As a result, it is possible to properly decode the bitstream for which the coding efficiency is increased by reducing the unnecessary amount of information.

### Embodiment 13

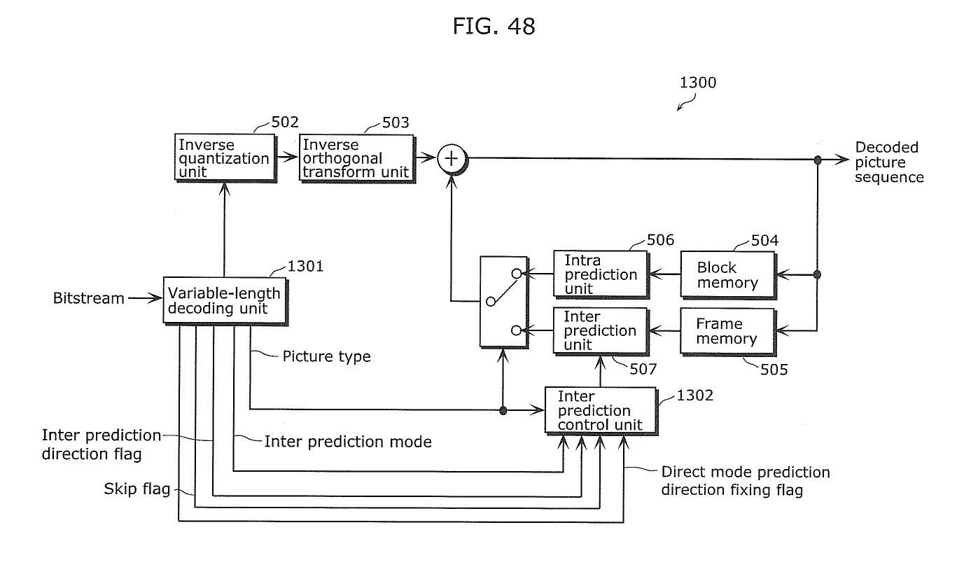

FIG. 48 is a block diagram showing a configuration of a moving picture decoding apparatus using a moving picture decoding method according to Embodiment 13 of the present invention. A moving picture decoding apparatus 1300 according to this embodiment differs from the moving picture decoding apparatus according to Embodiment 12 in decoding a bitstream in which a direct mode prediction direction fixing flag generated by the direct mode prediction direction determination unit is added to header information (e.g., a picture parameter set or a slice header in H.264) for each unit of processing such as a picture. It is to be noted that the same reference signs are assigned to the same elements as in Embodiment 12, and a description thereof is omitted.

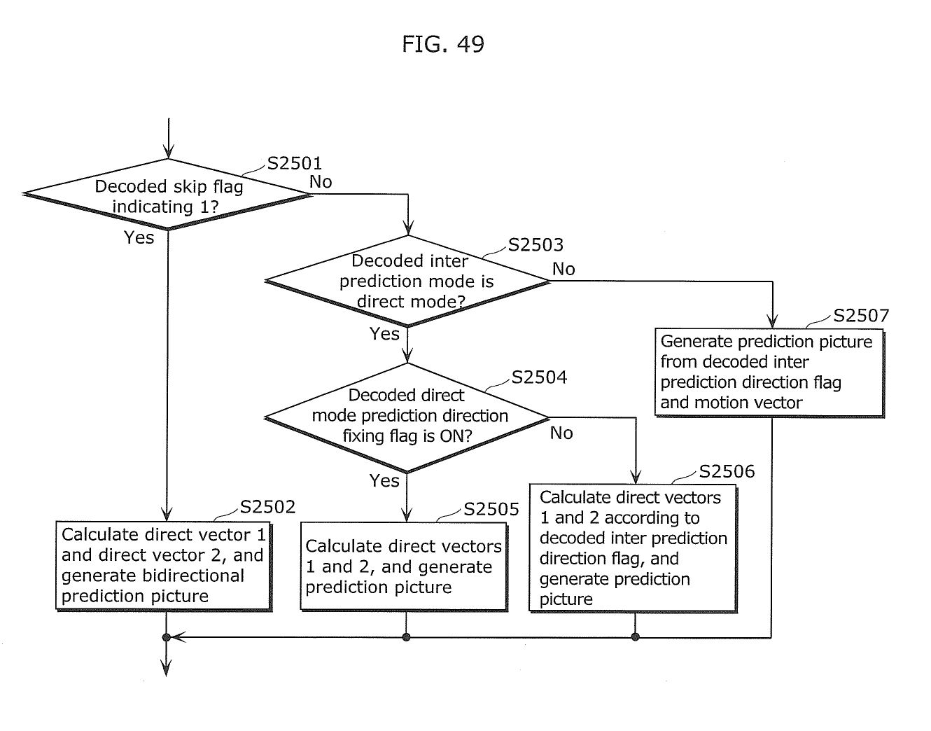

FIG. 49 is a flow chart showing an outline of a process flow of the moving picture decoding method according to this embodiment of the present invention.

An inter prediction control unit 1302 determines whether or not a skip flag obtained by a variable-length decoding unit 1301 decoding a bitstream indicates 1 (Step S2501). When it is determined that the skip flag indicates 1 (Yes in Step S2501), the inter prediction control unit 1302 calculates direct vectors 1 and 2, and generates a bidirectional prediction picture (Step S2502). On the other hand, when it is determined that the skip flag does not indicate 1, that is, the skip flag does not indicate the skip mode (No in Step S2501), the inter prediction control unit 1302 determines whether or not an inter prediction mode obtained by decoding performed by the variable-length decoding unit 1301 is the direct mode (Step S2503). When it is determined that the inter prediction mode is the direct mode (Yes in Step S2503), the inter prediction control unit 1302 determines whether or not a direct mode prediction direction fixing flag obtained by the variable-length decoding unit 1301 decoding a bitstream is ON (Step S2504). When it is determined that the direct mode prediction direction fixing flag is ON (Yes in Step S2504), the inter prediction control unit 1302 calculates the direct vectors 1 and 2, and generates the bidirectional prediction picture (Step S2505). On the other hand, when it is determined that the direct mode prediction direction fixing flag is not ON (No in Step S2404), the inter prediction control unit 1302 calculates the direct vectors 1 and 2 according to the inter prediction direction obtained by decoding performed by the variable-length decoding unit 1301, and generates a prediction picture (Step S2506). In contrast, when it is determined in Step S2503 that the inter prediction mode is not the direct mode, that is, the inter prediction mode is the motion vector estimation mode (No in Step S2503), the inter prediction control unit 1302 generates the prediction picture using a motion vector and the inter prediction direction flag obtained by decoding performed by the variable-length decoding unit 1301 (Step S2407). It is to be noted that although the bidirectional prediction picture is generated when the direct mode prediction direction fixing flag is ON in Step S2505 in this embodiment, for instance, a unidirectional prediction picture may be generated in the same manner as the coding method.

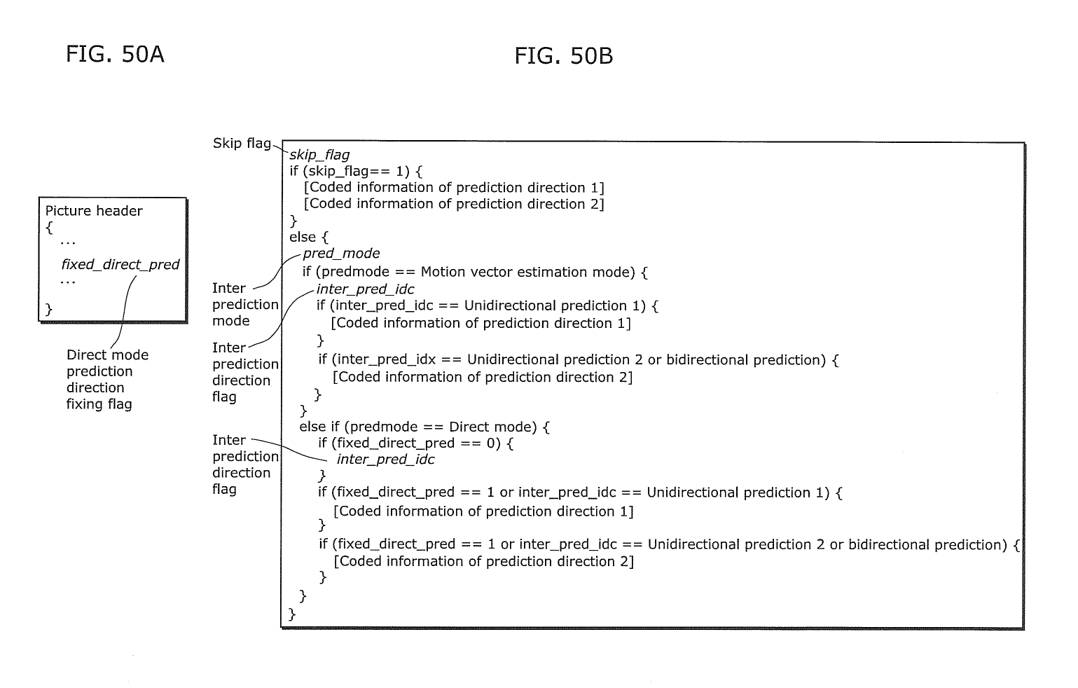

Each of FIGS. 50A and 50B is a diagram showing another example of syntax of a bitstream in the moving picture decoding method according to this embodiment of the present invention. In FIGS. 50A and 50B, skip_flag represents a skip flag, pred_mode represents an inter prediction mode, and inter_pred_idc represents an inter prediction direction flag. In addition, fixed_direct_pred that is added to a picture header or the like represents a direct mode prediction direction fixing flag.

As described above, according to this embodiment, explicitly giving the direction mode prediction direction fixing flag to the picture header or the like enables flexibly switching, for each picture, whether or not the prediction direction in the direct mode is to be fixed to the bidirectional prediction. As a result, it is possible to properly decode the bitstream for which the coding efficiency is increased.

### Embodiment 14

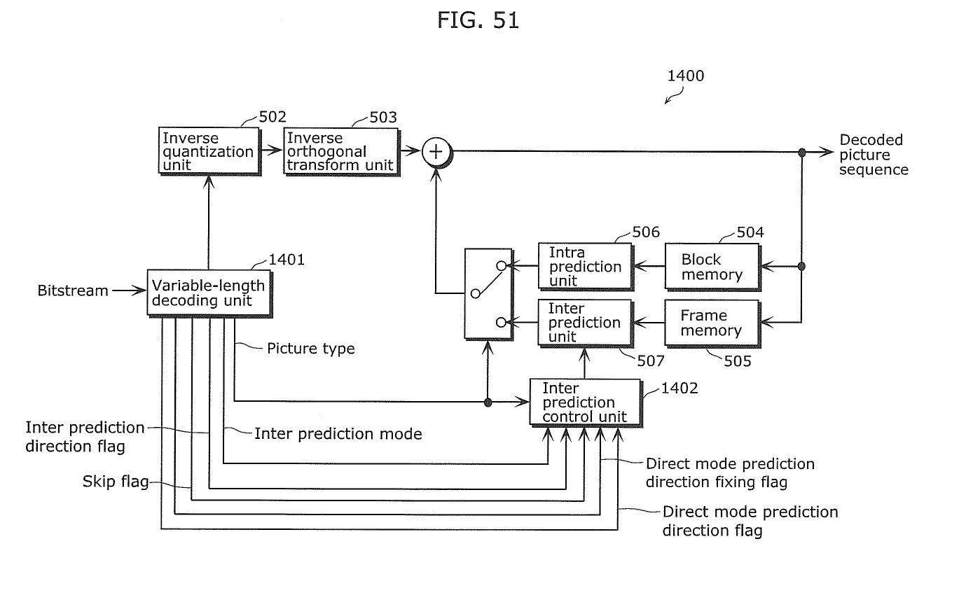

FIG. 51 is a block diagram showing a configuration of a moving picture decoding apparatus using a moving picture decoding method according to Embodiment 14 of the present invention. A moving picture decoding apparatus 1400 according to this embodiment differs from the moving picture decoding apparatus according to Embodiment 12 in decoding a bitstream in which a direct mode prediction direction fixing flag generated by the direct mode prediction direction determination unit is added to header information (e.g., a picture parameter set or a slice header in H.264) for each unit of processing such as a picture. It is to be noted that the same reference signs are assigned to the same elements as in Embodiment 12, and a description thereof is omitted.

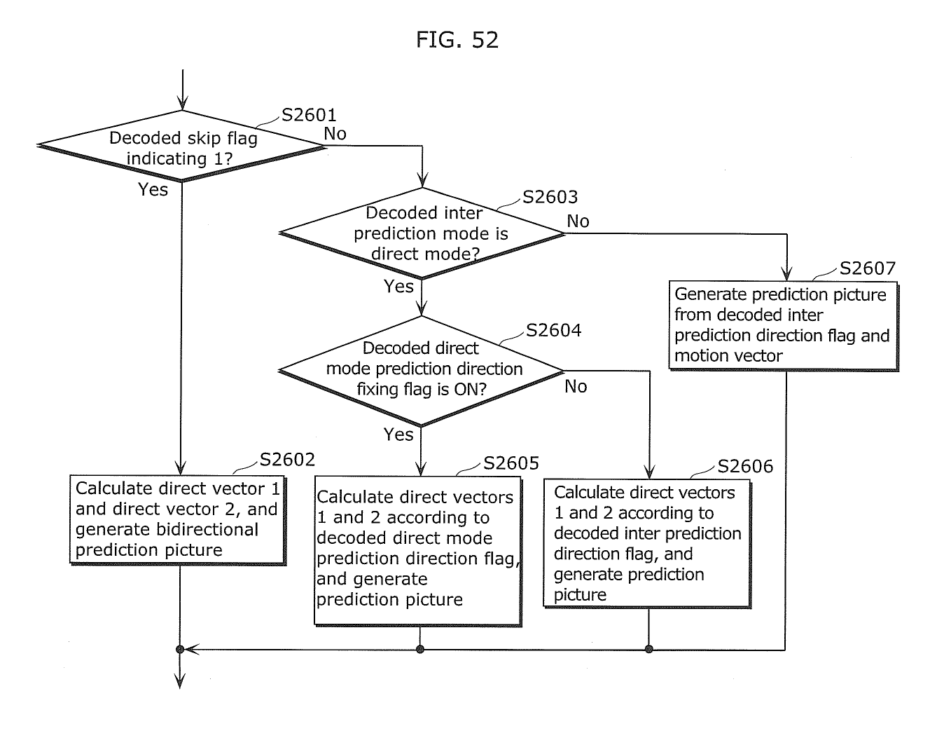

FIG. 52 is a flow chart showing an outline of a process flow of the moving picture decoding method according to this embodiment of the present invention.

An inter prediction control unit 1402 determines whether or not a skip flag obtained by a variable-length decoding unit 1401 decoding a bitstream indicates 1 (Step S2601). When it is determined that the skip flag indicates 1 (Yes in Step S2601), the inter prediction control unit 1402 calculates direct vectors 1 and 2, and generates a bidirectional prediction picture (Step S2602). On the other hand, when it is determined that the skip flag does not indicate 1, that is, the skip flag does not indicate the skip mode (No in Step S2601), the inter prediction control unit 1402 determines whether or not an inter prediction mode obtained by decoding performed by the variable-length decoding unit 1401 is the direct mode (Step S2603). When it is determined that the inter prediction mode is the direct mode (Yes in Step S2603), the inter prediction control unit 1402 determines whether or not a direct mode prediction direction fixing flag obtained by the variable-length decoding unit 1401 decoding the bitstream is ON (Step S2604). When it is determined that the direct mode prediction direction fixing flag is ON (Yes in Step S2604), the inter prediction control unit 1402 calculates the direct vectors 1 and 2 according to the direct mode prediction flag obtained by the variable-length decoding unit 1401 decoding the bitstream, and generates a prediction picture (Step S2605). On the other hand, when it is determined that the direct mode prediction direction fixing flag is not ON (No in Step S2404), the inter prediction control unit 1402 calculates the direct vectors 1 and 2 according to the inter prediction direction obtained by decoding performed by the variable-length decoding unit 1401, and generates the prediction picture (Step S2606). In contrast, when it is determined in Step S2603 that the inter prediction mode is not the direct mode, that is, the inter prediction mode is the motion vector estimation mode (No in Step S2603), the inter prediction control unit 1402 generates the prediction picture using a motion vector and the inter prediction direction flag obtained by decoding performed by the variable-length decoding unit 1401 (Step S2607).

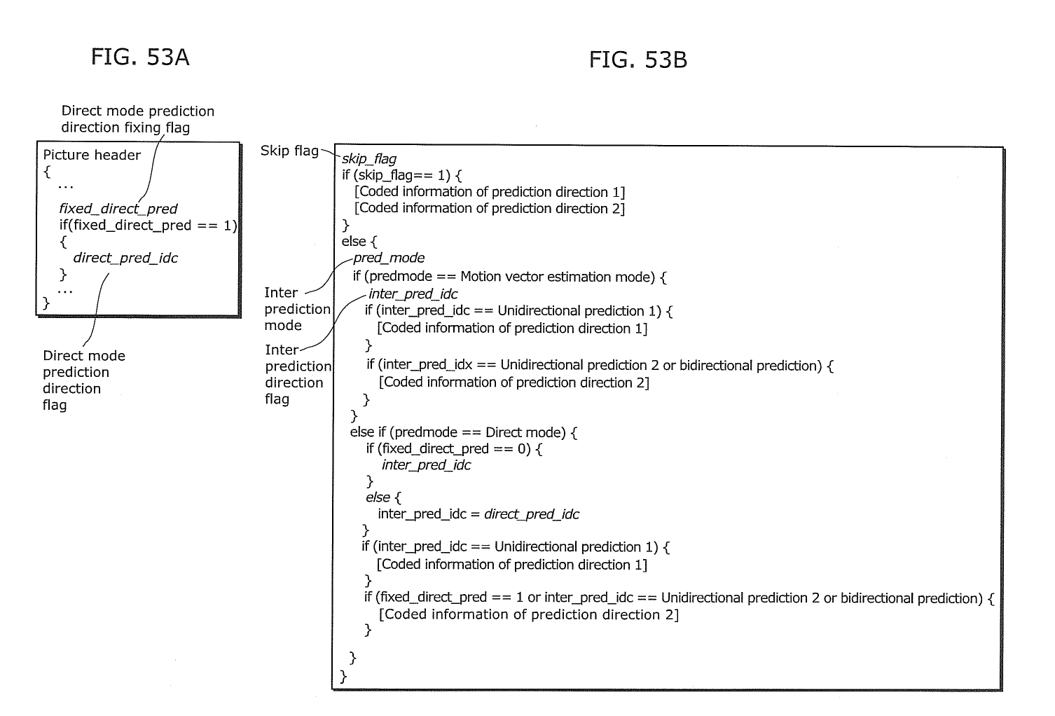

Each of FIGS. 53A and 53B is a diagram showing another example of syntax of a bitstream in the moving picture decoding method according to this embodiment of the present invention. In FIGS. 53A and 53B, skip_flag represents a skip flag, pred_mode represents an inter prediction mode, and inter_pred_idc represents an inter prediction direction flag. In addition, fixed_direct_pred that is added to a picture header or the like represents a direct mode prediction direction fixing flag, and direct_pred_idc represents a direct prediction direction flag.

As described above, according to this embodiment, explicitly giving the direction mode prediction direction fixing flag to the picture header or the like enables flexibly switching, for each picture, whether or not the prediction direction in the direct mode is to be fixed to the bidirectional prediction. As a result, it is possible to properly decode the bitstream for which the coding efficiency is increased.

### Embodiment 15

A case of combining Embodiments 1 and 9 is described in Embodiment 15. Embodiment 1 has described the example where when the assignment of the reference picture index to each reference picture is the same for the reference picture lists 1 and 2, it is possible to increase the coding efficiency by fixing the prediction direction in the skip mode to the unidirectional prediction.

Moreover, Embodiment 9 has described the example where when the assignment of the reference picture index to each reference picture is the same for the reference picture lists 1 and 2, since there is the tendency that the costs of the bidirectional prediction and the unidirectional prediction in the direct mode are relatively similar to each other, it is not necessary to add the prediction direction flag in the direct mode for each current block by fixing the prediction direction in the direct mode to one of the bidirectional prediction and the unidirectional prediction, and it is possible to increase the coding efficiency by reducing the unnecessary amount of information.

In the case of combining Embodiments 1 and 9, when the assignment of the reference picture index to each reference picture is the same for the reference picture lists 1 and 2, it is possible to increase the coding efficiency in the skip mode by fixing the prediction direction in the skip mode to the unidirectional prediction. On the other hand, some of current blocks to be coded which have a lower cost of the bidirectional prediction than that of the unidirectional prediction in the skip mode are coded using the bidirectional prediction in the direct mode. For this reason, it is not necessary to always add more prediction direction flags in the direct mode for each current block by fixing the prediction direction in the direct mode to the unidirectional prediction, and it is possible to increase the coding efficiency by reducing the unnecessary amount of information.

### Embodiment 16

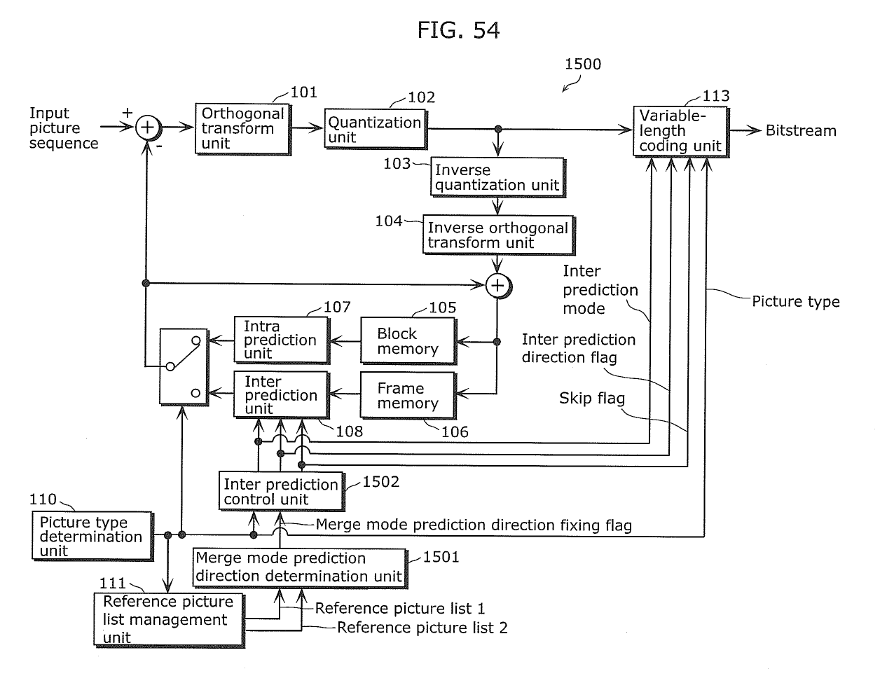

FIG. 54 is a block diagram showing a configuration of a moving picture coding apparatus using a moving picture coding method according to Embodiment 16 of the present invention.

As shown in FIG. 54, a moving picture coding apparatus 1500 includes the orthogonal transform unit 101, the quantization unit 102, the inverse quantization unit 103, the inverse orthogonal transform unit 104, the block memory 105, the frame memory 106, the intra prediction unit 107, the inter prediction unit 108, an inter prediction control unit 1502, the picture type determination unit 110, the reference picture list management unit 111, a merge mode prediction direction determination unit 1501, and the variable-length coding unit 113.

The orthogonal transform unit 101 transforms, from image domain into frequency domain, prediction error data between prediction picture data generated by a unit to be described later and an input picture sequence. The quantization unit 102 performs a quantization process on the prediction error data transformed into the frequency domain. The inverse quantization unit 103 performs an inverse quantization process on the prediction error data on which the quantization unit 102 has performed the quantization process. The inverse orthogonal transform unit 104 transforms, from frequency domain into image domain, the prediction error data on which the inverse quantization process has been performed. The block memory 105 stores, in units of blocks, a decoded picture obtained from the prediction picture data and the prediction error data on which the inverse quantization process has been performed, and the frame memory 106 stores the decoded picture in units of frames. The picture type determination unit 110 determines which one of the picture types, I-picture, B-picture, and P-picture, is used to code the input picture sequence, and generates picture type information. The intra prediction unit 107 generates prediction picture data by performing intra prediction on a current block to be coded, using the decoded picture stored in the units of blocks in the block memory 105. The inter prediction unit 108 generates prediction picture data by performing inter prediction on the current block, using the decoded picture stored in the units of frames in the block memory 106.

The reference picture list management unit 110 assigns reference picture indexes to coded reference pictures to be referred to in the inter prediction, and creates reference picture lists together with display order and so on. Two reference picture lists correspond to the B-picture which is used for coding with reference to two pictures. It is to be noted that although the reference pictures are managed based on the reference picture indexes and the display order in this embodiment, the reference pictures may be managed based on the reference picture indexes, coding order, and so on.

The merge mode prediction direction determination unit 1501 determines, through a method to be described later, a prediction direction in the merge mode of a current block to be coded, using the reference picture lists 1 and 2 created by the reference picture list management unit 110.

The variable-length coding unit 113 generates a bitstream by performing a variable length coding process on the prediction error data on which the quantization process has been performed, an inter prediction mode, an inter prediction direction flag, a skip flag, and picture type information.

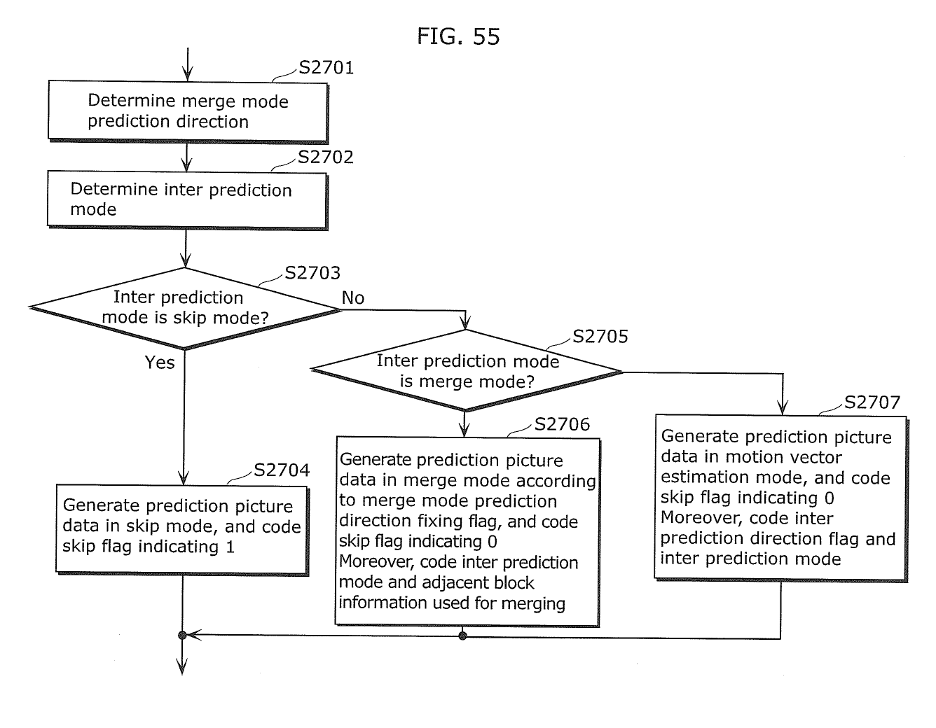

FIG. 55 is a flow chart showing an outline of a process flow of the moving picture coding method according to this embodiment of the present invention. The merge mode prediction direction determination unit 1501 determines a prediction direction in the case of coding a current block to be coded in the merge mode (Step S2701). The inter prediction control unit 1502 compares a cost of the motion vector estimation mode in which a prediction picture is generated using a motion vector obtained by motion estimation, a cost of the direct mode in which a prediction picture is generated using a predicted motion vector generated from an adjacent block or the like, and a cost of the skip mode in which a prediction picture is generated using a predicted motion vector generated according to a prediction direction determined by the direct mode prediction direction determination unit 1501, and determines a more efficient inter prediction mode from among the three modes (Step S2702). The method for calculating a cost is to be described later. Next, the inter prediction control unit 1502 determines whether or not the inter prediction mode determined in Step S2702 is the skip mode (Step S2703). When it is determined that the inter prediction mode is the skip mode (Yes in Step S2703), the inter prediction control unit 1502 generates a prediction picture in the skip mode and sets a skip flag to indicate 1. Then, the inter prediction control unit 1502 sends the skip flag to the variable-length coding unit 113 so that the skip flag is added to a bitstream of the current block (Step S2704). When it is determined that the inter prediction mode is not the skip mode (No in Step S2703), the inter prediction control unit 1502 determines whether or not the determined inter prediction mode is the merge mode (Step S2705). When it is determined that the inter prediction mode is the merge mode (Yes in Step S2705), the inter prediction control unit 1502 generates a prediction picture in the merge mode according to a merge mode prediction direction fixing flag obtained through a method to be described later, and sets the skip flag to indicate 0. Then, the inter prediction control unit 1502 sends the skip flag to the variable-length coding unit 113 so that the skip flag is added to the bitstream of the current block. Moreover, the inter prediction control unit 1502 sends, to the variable-length coding unit 113, (i) the inter prediction mode indicating the motion vector estimation mode or the merge mode and (ii) adjacent block information which is obtained through a method to be described later and used for merging so that the inter prediction mode and the adjacent block information are added to the bitstream of the current block (Step S2706). On the other hand, when it is determined in Step S2705 that the inter prediction mode is not the merge mode (No in Step S2705), the inter prediction control unit 1502 generates prediction picture data in the motion vector estimation mode, and sets the skip flag to indicate 0. Then, the inter prediction control unit 1502 sends the skip flag to the variable-length coding unit 113 so that the skip flag is added to the bitstream of the current block. Furthermore, the inter prediction control unit 1502 sends, to the variable-length coding unit 113, the inter prediction mode and the inter prediction direction flag so that the inter prediction mode and the inter prediction direction flag are added to the bitstream of the current block, the inter prediction mode indicating the motion vector estimation mode or the merge mode, and the inter prediction direction flag indicating whether the inter prediction direction is the unidirectional prediction of the prediction direction 1, the unidirectional prediction of the prediction direction 2, or the bidirectional prediction using the prediction directions 1 and 2 (Step S2707).

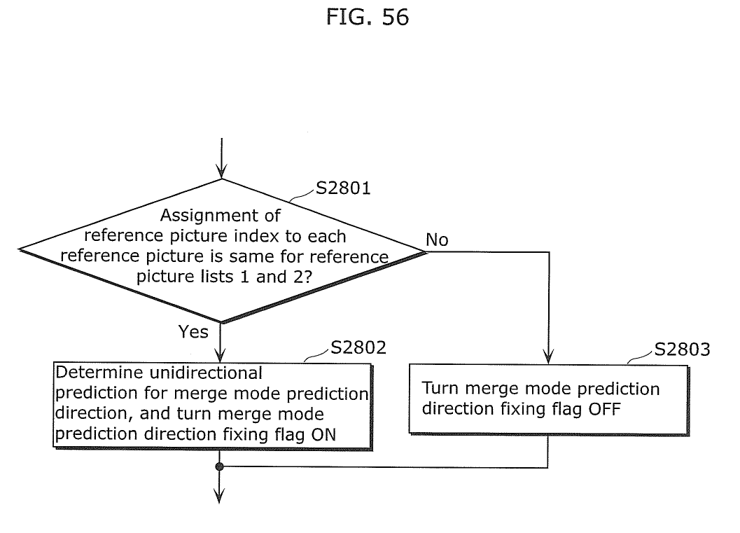

FIG. 56 is a flow chart showing a flow of determining a merge mode prediction direction which is performed by the merge mode prediction direction determination unit 1501. In general, when the assignment of the reference picture index to each reference picture is the same for the reference picture lists 1 and 2, although the motion vectors in the prediction directions 1 and 2 are selected in the bidirectional prediction, there are a case where only the motion vector in the prediction direction 1 is used in the unidirectional prediction and a case where the motion vector in the prediction direction 2 is overall reduced. For instance, when the assignment of the reference picture index to each reference picture is the same for the reference picture lists 1 and 2, unidirectional prediction using the reference picture list 2 is prohibited, and thus it is possible to increase the coding efficiency by reducing an amount of coded data of an inter prediction direction flag. In this case, only the motion vector in the prediction direction 1 is used in the unidirectional prediction, and thus there is a possibility that the motion vector in the prediction direction 2 is overall reduced and the accuracy of a predicted motion vector in the prediction direction 2 is reduced. For this reason, when the assignment of the reference picture index to each reference picture is the same for the reference picture lists 1 and 2, it is possible to increase the coding efficiency by fixing the prediction direction in the merge mode to the unidirectional prediction.

The merge mode prediction direction determination unit 1501 determines whether or not the assignment of the reference picture index to each reference picture is the same for the reference picture lists 1 and 2, using the reference picture lists 1 and 2 (Step S2801). For example, the display orders of the reference pictures indicated by the reference picture indexes 1 are obtained from the reference picture list 1 and are compared to the display orders of the reference pictures indicated by the reference picture indexes 2 in the reference picture list 2. When the display orders are the same, it is possible to determine that the assignment of the reference picture index is the same for the reference picture lists 1 and 2. When it is determined that the assignment of the reference picture index to each reference picture is the same for the reference picture lists 1 and 2 (Yes in Step S2801), the merge mode prediction direction determination unit 1501 determines the unidirectional prediction for the prediction direction in the merge mode, and turns the merge mode prediction direction fixing flag ON (Step S2802). On the other hand, when it is determined that the assignment of the reference picture index to each reference picture is not the same for the reference picture lists 1 and 2 (No in Step S2801), the merge mode prediction direction determination unit 1501 turns the merge mode prediction direction fixing flag OFF (Step S2803).

It is to be noted that although, by using the display order, it is determined in Step 2801 whether or not the assignment of the reference picture index to each reference picture is the same for the reference picture lists 1 and 2 in this embodiment, the determination may be made using coding order or the like.

Moreover, although the unidirectional prediction is determined for the prediction direction in the merge mode and the merge mode prediction direction fixing flag is turned ON when it is determined in Step S2801 that the assignment of the reference picture index to each reference picture is the same for the reference picture lists 1 and 2 in this embodiment, the bidirectional prediction may be determined for the prediction direction in the merge mode and the merge mode prediction direction fixing flag may be turned ON when a reference picture indicated by the reference picture index 1 of the prediction direction 1 is the same as a reference picture indicated by the reference picture index 2 of the prediction direction 2 in the merge mode corresponding to the current block. For example, the display order of the reference picture indicated by the reference picture index 1 is obtained from the reference picture list 1 and is compared to the display order of the reference picture indicated by the reference picture index 2 in the reference picture list 2. When the display orders are the same, it is possible to determine that the reference pictures are the same. Even in such a case, the motion vectors in the prediction directions 1 and 2 are selected in the bidirectional prediction. However, there is the case where only the motion vector in the prediction direction 1 is used in the unidirectional prediction and the motion vector in the prediction direction 2 is overall reduced. As a result, it is possible to increase the coding efficiency by fixing the prediction direction in the merge mode to the unidirectional prediction.

Moreover, when a current picture to be coded is a B-picture coded by using a bidirectional prediction picture with reference to two coded pictures located before the current picture, the prediction direction in the merge mode may be fixed to the unidirectional prediction. For such a B-picture, there is the case where the assignment of the reference picture index to each reference picture is the same for the reference picture lists 1 and 2 or the case where the reference picture indicated by the reference picture index 1 of the prediction direction 1 is the same as the reference picture indicated by the reference picture index 2 of the prediction direction 2 in the merge mode corresponding to the current block. Even in such a case, the motion vectors in the prediction directions 1 and 2 are selected in the bidirectional prediction. However, there is the case where only the motion vector in the prediction direction 1 is used in the unidirectional prediction and the motion vector in the prediction direction 2 is overall reduced. As a result, it is possible to increase the coding efficiency by fixing the prediction direction in the merge mode to the unidirectional prediction.

Moreover, when the current picture is a B-picture coded by using the bidirectional prediction picture with reference to two coded pictures located after the current picture, the bidirectional prediction may be determined for the prediction direction in the direct mode and the direct mode prediction direction fixing flag may be set ON. For such a B-picture, there is the case where the assignment of the reference picture index to each reference picture is the same for the reference picture lists 1 and 2 or the case where the reference picture indicated by the reference picture index 1 of the prediction direction 1 is the same as the reference picture indicated by the reference picture index 2 of the prediction direction 2 in the skip mode corresponding to the current block. Even in such a case, the motion vectors in the prediction directions 1 and 2 are selected in the bidirectional prediction. However, there is the case where only the motion vector in the prediction direction 1 is used in the unidirectional prediction and the motion vector in the prediction direction 2 is overall reduced. As a result, it is possible to increase the coding efficiency by fixing the prediction direction in the merge mode to the unidirectional prediction.

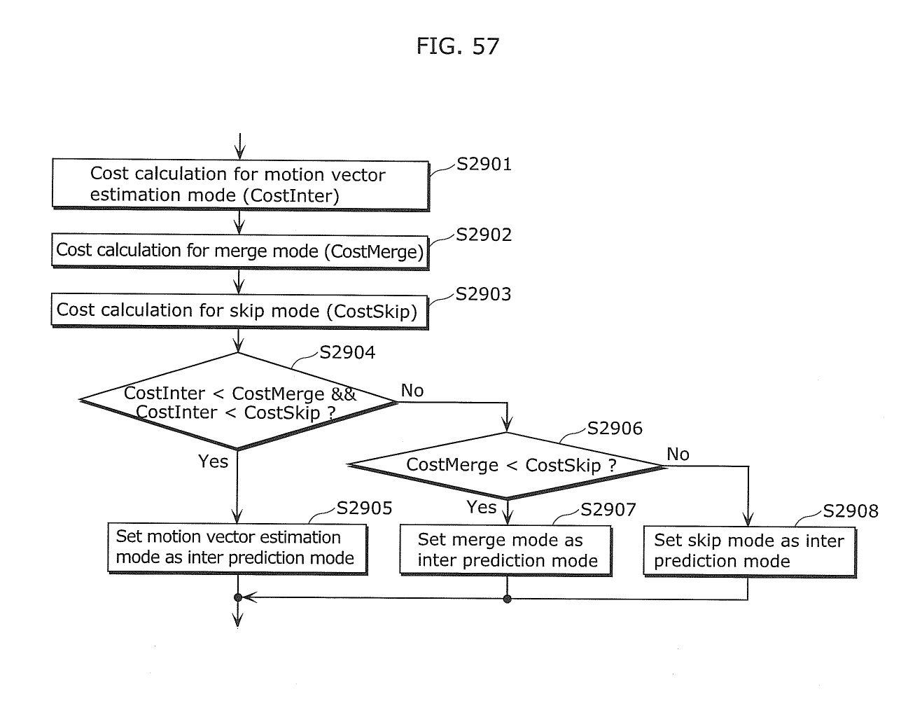

FIG. 57 is a flow chart showing a flow of determining an inter prediction mode which is performed by the inter prediction control unit 1502.

The inter prediction control unit 1502 calculates, through a method to be described later, cost CostInter of the motion vector estimation mode in which the prediction picture is generated using the motion vector obtained by the motion estimation (Step S2901). Next, the inter prediction control unit 1502 generates a predicted motion vector using the motion vector of the adjacent block or the like, and calculates, through a method to be described later, cost CostMerge of the merge mode in which the prediction picture is generated using the predicted motion vector (Step S2902). The inter prediction control unit 1502 calculates, through a method to be described later, cost CostSkip of the skip mode in which the prediction picture is generated according to a determined skip mode prediction direction flag (Step S2903). The inter prediction control unit 1502 compares the cost CostInter of the motion vector estimation mode, the cost CostMerge of the merge mode, and the cost CostSkip of the skip mode, and determines whether or not the cost CostInter of the motion vector estimation mode is smallest (Step S2904). When it is determined that the cost CostInter of the motion vector estimation mode is smallest (Yes in Step S2904), the inter prediction control unit 1502 determines and sets the motion vector estimation mode as the inter prediction mode (Step S2905). On the other hand, when it is determined in Step S2904 that the cost CostInter of the motion vector estimation mode is not smallest (No in Step S2904), the inter prediction control unit 1502 compares the cost CostMerge of the merge mode and the cost CostSkip of the skip mode, and determines whether or not the cost CostMerge of the merge mode is smaller (Step S2906). When it is determined that the cost CostMerge of the merge mode is smaller (Yes in Step S2906), the inter prediction control unit 1502 determines and sets the merge mode as the inter prediction mode (Step S2907). On the other hand, when it is determined that the cost CostMerge of the merge mode is not smaller (No in Step S2906), the inter prediction control unit 1502 determines and sets the skip mode as the inter prediction mode (Step S2908).

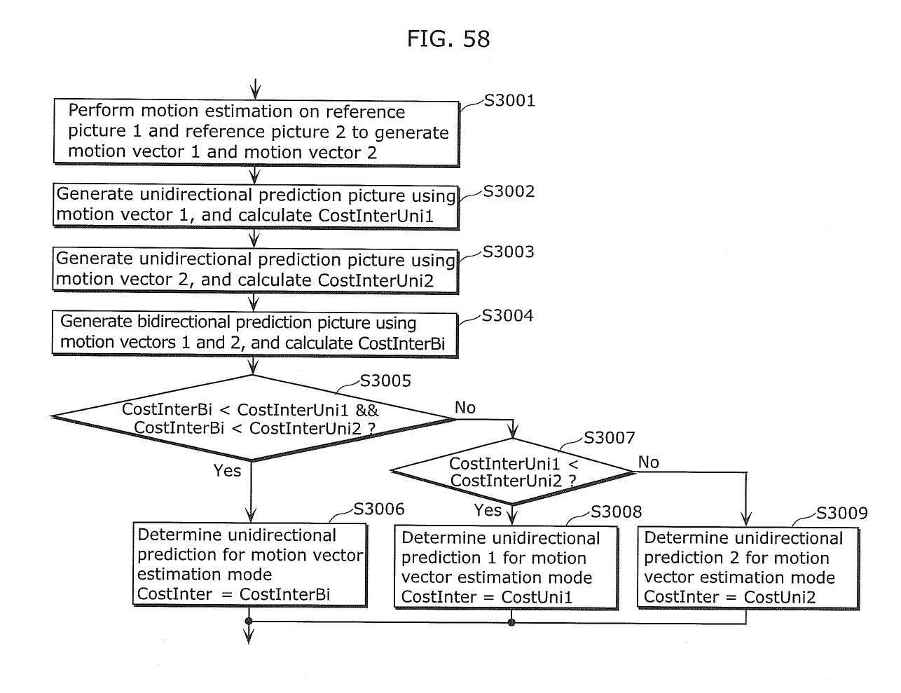

The following describes in detail the method of calculating the cost CostInter of the motion vector estimation mode in Step S2901 shown in FIG. 57, with reference to FIG. 58. FIG. 58 is a flow chart showing a process flow of cost CostInter calculation in the motion vector estimation mode.

The inter prediction control unit 1502 performs motion estimation on a reference picture 1 indicated by a reference picture index 1 of the prediction direction 1 and a reference picture 2 indicated by a reference picture index 2 of the prediction direction 2, so as to generate the motion vector 1 and the motion vector 2 corresponding to the respective reference pictures (Step S3001). Here, the motion estimation refers to calculating a difference value between a current block to be coded in a picture to be coded and a block in a reference picture, using a block having the smallest difference value in the reference picture as a reference block, and calculating a motion vector based on a position of the current block and a position of the reference block. Next, the inter prediction control unit 1502 generates a prediction picture in the prediction direction 1 using the generated motion vector 1, and calculates cost CostInterUni1 of the prediction picture by, for instance, the equation of the R-D optimization model (Step S3002). The inter prediction control unit 1502 generates a prediction picture in the prediction direction 2 using the generated motion vector 2, and calculates cost CostInterUni2 of the prediction picture by Equation 1 (Step S3003). The inter prediction control unit 1502 generates a bidirectional prediction picture using the generated motion vectors 1 and 2, and calculates cost CostInterBi of the bidirectional prediction picture by Equation 1 (Step S3004). Here, the bidirectional prediction picture is, for instance, a bidirectional prediction picture obtained by performing, for each pixel, averaging on the prediction picture generated using the motion vector 1 and the prediction picture generated using the motion vector 2. Next, the inter prediction control unit 1502 compares the values of the cost CostInterUni1, the cost CostInterUni2, and the cost CostInterBi, and determines whether or not the cost CostInterBi is smallest (Step S3005). When it is determined that the cost CostInterBi is smallest (Yes in Step S3005), the inter prediction control unit 1502 determines the bidirectional prediction for the prediction direction in the motion vector estimation mode, and sets the cost CostInterBi to the cost CostInter of the motion vector estimation mode (Step S3006). On the other hand, when it is determined in step S3005 that the cost CostInterBi is not smallest (No in Step S3005), the inter prediction control unit 1502 compares the cost CostInterUni1 and the cost CostInterUni2, and determines whether or not the cost CostInterUni1 is smaller (Step S3007). When it is determined that the value of the cost CostInterUni1 is smaller (Yes in Step S3007), the inter prediction control unit 1502 determines unidirectional prediction 1 of the prediction direction 1 for the motion vector estimation mode, and sets the cost CostInterUni1 to the cost CostInter of the motion vector estimation mode (Step S3008). On the other hand, when it is determined in step S3007 that the value of the cost CostInterUni1 is not smaller (No in Step S3007), the inter prediction control unit 1502 determines unidirectional prediction 2 of the prediction direction 2 for the motion vector estimation mode, and sets the cost CostInterUni2 to the cost CostInter of the motion vector estimation mode (Step S3009).

It is to be noted that although the averaging is performed for each pixel when the bidirectional prediction picture is generated in this embodiment, weighted averaging may be performed.

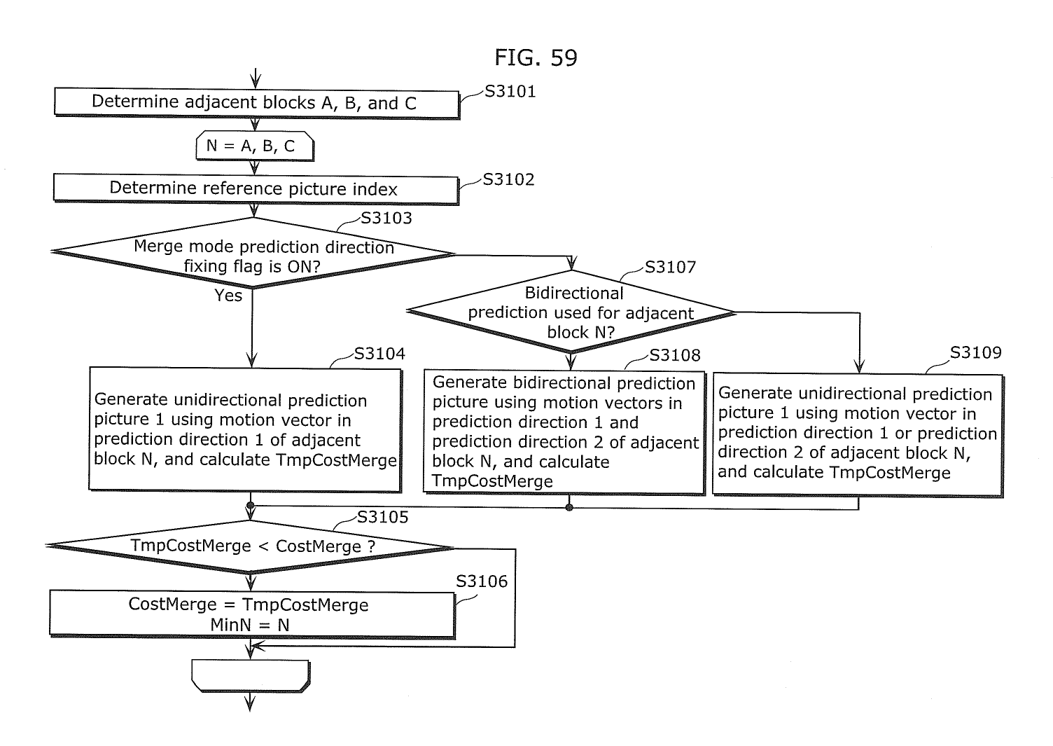

The following describes in detail the method of calculating the cost CostMerge of the merge mode in Step S2902 shown in FIG. 57, with reference to FIG. 59. FIG. 59 is a flow chart showing a process flow of cost CostMerge calculation in the merge mode.

The inter prediction control unit 1502 determines a left adjacent block A, a top adjacent block B, and a top right adjacent block C which are respectively adjacent to the left, the top, and the top right of a current block to be coded (Step S3101). For instance, a block to which a pixel adjacent to the left of a pixel in the most top left corner of the current block belongs to is the left adjacent block A, a block to which a pixel adjacent to the top of a pixel in the most top left corner of the current block belongs to is the top adjacent block B, a block to which a pixel adjacent to the top right of a pixel in the most top right corner of the current block belongs to is the top right adjacent block C, and so on. Then, subsequently, the following processes (Steps S3102 to S3109) are repeatedly performed on each adjacent block N (=A or B or C). The inter prediction control unit 1502 determines a reference picture index for the current block (Step S3102). For example, a reference picture index for the adjacent block N is set. Next, the inter prediction control unit 1502 determines whether or not a merge mode prediction direction fixing flag is ON (Step S3103). When it is determined that the merge mode prediction direction fixing flag is ON (Yes in Step S3103), the inter prediction control unit 1502 generates a unidirectional prediction picture using a motion vector in the prediction direction 1 of the adjacent block N, and calculates cost TmpCostMerge of the unidirectional prediction picture by Equation 1 (Step S3104). Next, the inter prediction control unit 1502 determines whether or not the cost TmpCostMerge is smaller than the cost CostMerge (Step S3105). When it is determined that the cost TmpCostMerge is smaller than the cost CostMerge, the inter prediction control unit 1502 copies the cost TmpCostMerge into the cost CostMerge, and updates adjacent block information MinN for merging which has generated the smallest cost (Step S3106). On the other hand, when it is determined in Step S3103 that the merge mode prediction direction fixing flag is OFF (No in Step S3103), the inter prediction control unit 1502 determines whether or not the prediction direction of the adjacent block N is the bidirectional prediction (Step S3107). When it is determined that the prediction direction is the bidirectional prediction (Yes in Step S3107), the inter prediction control unit 1502 generates a bidirectional prediction picture using motion vectors in the prediction directions 1 and 2 of the adjacent block N, and calculates cost TmpCostMerge of the bidirectional prediction picture by Equation 1 (Step S3108). On the other hand, when it is determined in Step S3107 that the prediction direction is not the bidirectional prediction (No in Step S3107), the inter prediction control unit 1502 generates a unidirectional prediction picture using the motion vector in the prediction direction 1 or 2 of the adjacent block N, and calculates cost TmpCostMerge of the unidirectional prediction picture by Equation 1 (Step S3109). By performing the processes between Steps S3102 and S3109 for each adjacent block, the cost CostMerge of the merge mode and the adjacent block information MinN used for merging which has generated the smallest cost are calculated.

It is to be noted that although the reference picture index for the adjacent block is used as the value of the reference picture index for the current block in the merge mode in this embodiment, a reference picture index indicating a reference picture which is more frequently referred to by an adjacent block may be calculated based on a value of a reference picture index for the adjacent block or the like. For example, in FIG. 9, when a value of each reference picture index can be “0” or “1”, it is conceivable that a median value Median (RefIdxL0_A, RefIdxL0_B, RefIdxL0_C) among RefIdxL0_A, RefIdxL0_B, and RefIdxL0_C is calculated as the reference picture index RefIdxL0 for the current block in the prediction direction 1. Here, the median value is calculated by Equation 2.

As stated above, the reference picture index indicating the reference picture which is more frequently referred to by the adjacent block is used as the reference picture index corresponding to the current block, and thus prediction accuracy of the direct vector is increased. As a result, it is possible to increase the coding efficiency. It is to be noted that although the above example of this embodiment shows the example where the reference picture index indicating the reference picture which is more frequently referred to by the adjacent block is calculated using the median value, the present invention is not limited to this. For instance, an identical relation between reference picture indexes for adjacent blocks may be examined and calculated. Furthermore, when all values of reference picture indexes for an adjacent block are different from each other, a reference picture index which indicates, among reference pictures indicated by the reference picture indexes, a reference picture closest to a current picture to be coded in display order may be used as the reference picture index for the current block.

Moreover, the reference picture index which indicates, among reference pictures referred to by the adjacent block, the reference picture closest to the current picture in display order may be assigned as the value of the reference picture index for the current block in the merge mode. For example, in the case shown in FIG. 9, it is conceivable that the smallest value Min (RefIdxL0_A, RefIdxL0_B, or RefIdxL0_C) among RefIdxL0_A, RefIdxL0_B, and RefIdxL0_C is calculated as the reference picture index RefIdxL0 for the current block in the prediction direction 1. Here, the smallest value is calculated by Equation 5.

In general, it is highly likely that a smaller value of a reference picture index is assigned to a reference picture that is closer to the current picture in display order, and thus it is possible to calculate a reference picture index which indicates a reference picture closest to the current picture in display order, by calculating the smallest value of the reference picture index. It is to be noted that the reference picture index which indicates the reference picture closest to the current picture in display order may be calculated by obtaining a display order of each reference picture from reference picture indexes for adjacent blocks and reference picture lists.

Moreover, when the reference picture index which indicates the reference picture more frequently referred to by the adjacent block or the reference picture index which indicates, among the reference pictures referred to by the adjacent block, the reference picture closest to the current picture in display order is used, the motion vector used in the merge mode may be scaled in accordance with a distance to the reference picture indicated by a determined reference picture index.

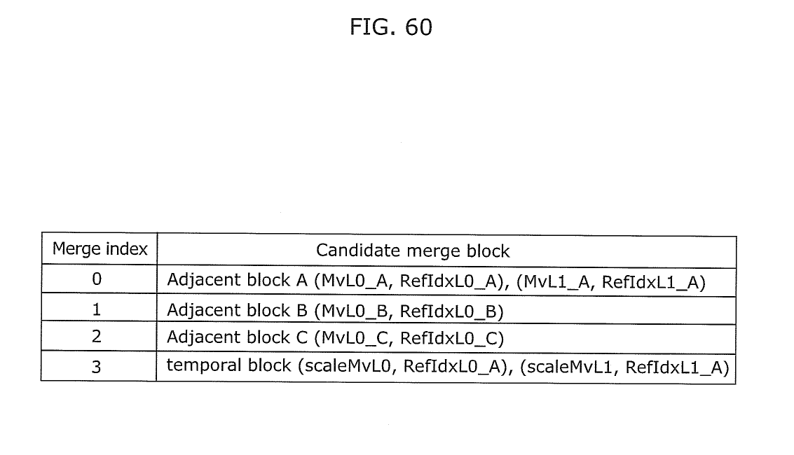

Here, the following describes an example where merge indexes (candidate indexes), adjacent block information MinN, are assigned to motion vectors and reference picture indexes which are used in the merge mode conceivable from the above. FIG. 60 is a table showing an example of assigning merge indexes to motion vectors and reference picture indexes used in the merge mode.

For instance, a case is assumed where, as shown in FIGS. 9 and 13 in Embodiment 1, the adjacent blocks A, B, and C, and the co-located block have the motion vectors and the reference picture indexes. In this case, for example, as shown in FIG. 60, the value “0” of the merge index is assigned to the motion vectors MvL0_A and MvL1_A and the reference picture indexes RefIdxL0_A and RefIdxL1_A of the adjacent block A. Moreover, the value “1” of the merge index is assigned to the motion vector MvL0_B and the reference picture index RefIdxL0_B of the adjacent block B. Furthermore, the value “2” of the merge index is assigned to the motion vector MvL0_C and the reference picture index RefIdxL0_C of the adjacent block C. Moreover, the value “3” of the merge index is assigned to motion vectors scaleMvL0 and scaleMvL1 obtained by scaling, according to reference distance, the motion vectors of the co-located block, the reference picture indexes RefIdxL0_A and RefIdL1_A of the adjacent block A.

Here, the motion vector scale MvL0 is scaled using a reference picture index RfIdxL0_Co1 for the co-located block in the prediction direction 1 and the reference picture index for the current block, to calculate the direct vector of the reference picture indicated by the reference picture index for the current block (the reference picture index RefIdxL0_A for the adjacent block A in the above example).

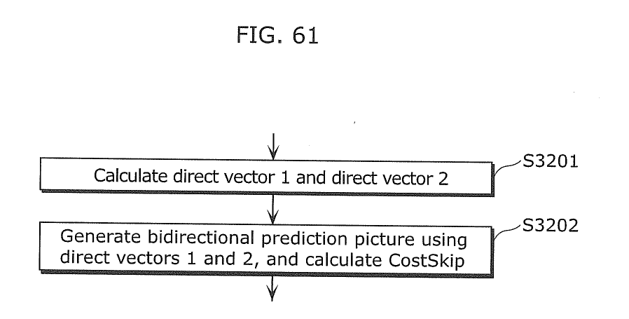

The following describes in detail the method of calculating cost CostSkip in the skip mode in Step S2903 shown in FIG. 57, with reference to FIG. 61. FIG. 61 is a flow chart showing a process flow of cost CostSkip calculation in the skip mode.

The inter prediction control unit 1502 calculates the direct vector 1 in the prediction direction 1 and the direct vector 2 in the prediction direction 2 (Step S3201). Here, the direct vectors are calculated by, for instance, the method described in Step S501 of FIG. 8 in Embodiment 1. Next, the inter prediction control unit 1502 generates a bidirectional prediction picture using the direct vectors 1 and 2, and calculates cost CostSkip in the skip mode by Equation 1 (Step S3202). Here, the bidirectional prediction picture is, for instance, a bidirectional prediction picture obtained by performing, for each pixel, averaging on the prediction picture generated using the motion vector 1 and the prediction picture generated using the motion vector 2.

It is to be noted that although this embodiment has described the example of generating the prediction picture in the prediction direction 1 when the merge mode prediction direction fixing flag is ON, the prediction picture in the prediction direction 2 may be generated throughout the whole embodiment.

It is also to be noted that although this embodiment has described, as the direct vector calculation method, the example of calculating the median value Median (MvL0_A, MvL0_B, MvL0_C) among the MvL0_A, the MvL0_B, and the MvL0_C, the present invention is not limited to this calculation method. For example, a predicted motion vector having the smallest Cost may be selected, as a direct vector to be used for coding, from among candidate predicted motion vectors, and a predicted motion vector index indicating the selected predicted motion vector may be added to a bitstream. Here, the Cost is calculated by Equation 1, for instance. As stated above, it is possible to derive a direct vector having smaller Cost, by selecting, from among the candidates, a direct vector to be used for coding. FIG. 11A is the table showing the examples of the candidate predicted motion vectors. The value of the predicted motion vector index corresponding to the Median (MvL0_A, MvL0_B, MvL0_C) is “0”, the value of the predicted motion vector index corresponding to the MvL0_A is “1”, the value of the predicted motion vector corresponding to the MvL0_B is “2”, and the value of the predicted motion vector corresponding to the MvL0_C is “3”. A method of assigning a predicted motion vector index is not limited to this example. FIG. 11B shows the example of the code table used in performing variable-length coding on the predicted motion vector index corresponding to the candidate predicted motion vector having the smallest Cost. A code having a shorter code length is assigned in ascending order of a value of a predicted motion vector index. Thus, it is possible to increase the coding efficiency by reducing a value of a predicted motion vector index corresponding to a candidate predicted motion vector that is highly likely to have high prediction accuracy.

Furthermore, although this embodiment has described the example of using, for the calculation of the reference picture index for the current block and the adjacent block to be used for merging, the reference picture indexes and the motion vectors corresponding to the respective adjacent blocks A, B, and C shown in FIG. 9, the present invention is not necessarily limited to the example. For example, as shown in FIG. 12, an adjacent block D or an adjacent block E may be used.

As described above, according to this embodiment, when the prediction direction in the merge mode is determined, it is possible to enhance the quality of the prediction picture in the merge mode, by selecting the prediction direction most suitable for the current block and adding the selected prediction direction to the bitstream, regardless of the prediction direction of the adjacent block. As a result, it is possible to increase the coding efficiency. In particular, when the assignment of a reference picture index to each reference picture is the same for the reference picture lists 1 and 2, it is possible to enhance the quality of the prediction picture by selecting the unidirectional prediction regardless of the prediction direction of the adjacent block, and increase the coding efficiency.

### Embodiment 17

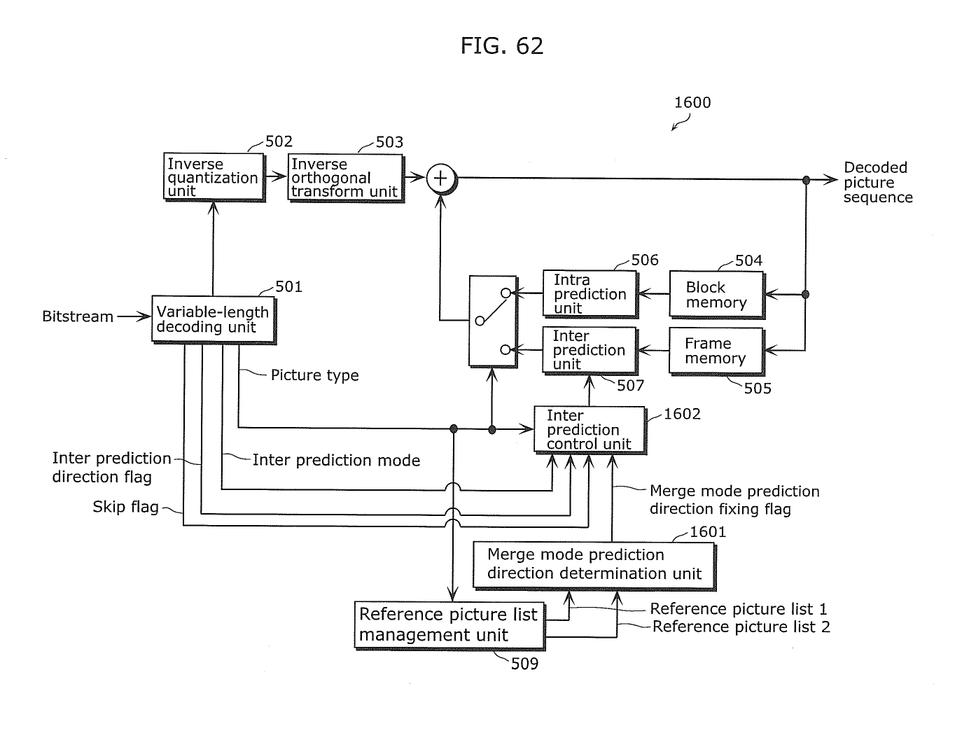

FIG. 62 is a block diagram showing a configuration of a moving picture decoding apparatus using a moving picture decoding method according to Embodiment 17 of the present invention.

As shown in FIG. 62, a moving picture decoding apparatus 1600 includes the variable-length decoding unit 501, the inverse quantization unit 502, the inverse orthogonal transform unit 503, the block memory 504, the frame memory 505, the intra prediction unit 506, the inter prediction unit 507, an inter prediction control unit 1602, the reference picture list management unit 509, and a merge mode prediction direction determination unit 1601.

The variable-length decoding unit 501 performs a variable-length decoding process on an inputted bitstream, to generate picture type information, an inter prediction mode, an inter prediction direction flag, a skip flag, and a quantized coefficient on which the variable-length decoding process has been performed. The inverse quantization unit 502 performs an inverse quantization process on the quantized coefficient on which the variable-length decoding process has been performed. The inverse orthogonal transform unit 503 transforms, from frequency domain into image domain, an orthogonal transform coefficient on which the inverse quantization process has been performed, to generate prediction error picture data. The block memory 504 stores, in units of blocks, a picture sequence generated by adding the prediction error picture data and prediction picture data. The frame memory 505 stores, in units of frames, a picture sequence obtained by adding prediction picture data. The intra prediction unit 506 generates prediction picture data of a current block to be decoded, through intra prediction, using the picture sequence stored in the units of the blocks in the block memory 504. The inter prediction unit 507 generates prediction picture data of the current block through inter prediction, using the picture sequence stored in the units of the frames in the frame memory 505. The inter prediction control unit 1602 controls motion vectors in the inter prediction and the method for generating prediction picture data, according to the inter prediction mode, the inter prediction direction, and the skip flag.

The reference picture list management unit 509 assigns reference picture indexes to coded reference pictures to be referred to in the inter prediction, and creates reference picture lists together with display order and so on. Two reference picture lists correspond to the B-picture which is used for decoding with reference to two pictures.

It is to be noted that although the reference pictures are managed based on the reference picture indexes and the display order in this embodiment, the reference pictures may be managed based on the reference picture indexes, decoding order, and so on.

The merge mode prediction direction determination unit 1601 determines a prediction direction in the merge mode of a current block to be decoded, using the reference picture lists 1 and 2 created by the reference picture list management unit 509, and sets a merge mode prediction direction fixing flag. It is to be noted that a flow of determining a merge mode prediction direction fixing flag is the same as FIG. 56 in Embodiment 16, and thus a description thereof is omitted.

Lastly, a decoded picture sequence is generated by adding decoded prediction error picture data and the prediction picture data.

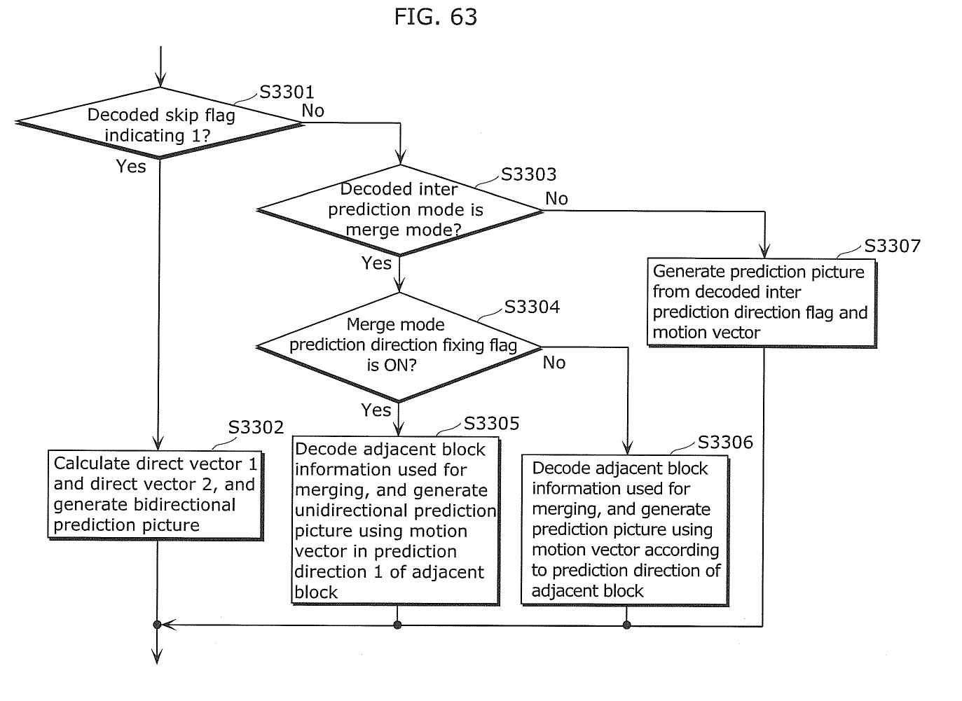

FIG. 63 is a flow chart showing an outline of a process flow of the moving picture decoding method according to this embodiment of the present invention.

The inter prediction control unit 1602 determines whether or not a skip flag obtained by decoding a bitstream indicates 1 (Step S3301). When it is determined that the skip flag indicates 1 (Yes in Step S3301), the inter prediction control unit 1602 calculates direct vectors 1 and 2, and generates a bidirectional prediction picture (Step S3302). Here, the direct vectors are calculated by, for instance, the method described in Step S501 of FIG. 8 in Embodiment 1. On the other hand, when it is determined that the skip flag does not indicate 1 (No in Step S3301), that is, the skip flag does not indicate the skip mode, the inter prediction control unit 1602 determines whether or not a decoded prediction mode is the merge mode (Step S3303). When it is determined that the prediction mode is the merge mode (Yes in Step S3303), the inter prediction control unit 1602 determines whether or not a merge mode prediction direction fixing flag is ON (Step S3304). When it is determined that the merge mode prediction direction fixing flag is ON, the inter prediction control unit 1602 decodes adjacent block information used for merging, and generates a unidirectional prediction picture using the motion vector of an adjacent block in the prediction direction 1 (Step S3305). On the other hand, when it is determined that the merge mode prediction direction fixing flag is OFF (No in Step S3304), the inter prediction control unit 1602 decodes the adjacent block information used for merging, and generates a prediction picture at least one of a motion vector in the prediction direction 1 and a motion vector in the prediction direction 2 according to the prediction direction of the adjacent block (Step S3306). Moreover, when it is determined in Step S3303 that the prediction mode is not the merge mode (No in Step S3303), that is, the prediction mode is the motion vector estimation mode, the inter prediction control unit 1602 generates the prediction picture using a decoded inter prediction direction and a motion vector (Step S3307).

It is to be noted that although the unidirectional prediction picture in the prediction direction 1 is generated when the merge mode prediction direction fixing flag is ON in Step S3305 in this embodiment, for instance, a unidirectional prediction picture in the prediction direction 2 may be generated in the same manner as the coding method.

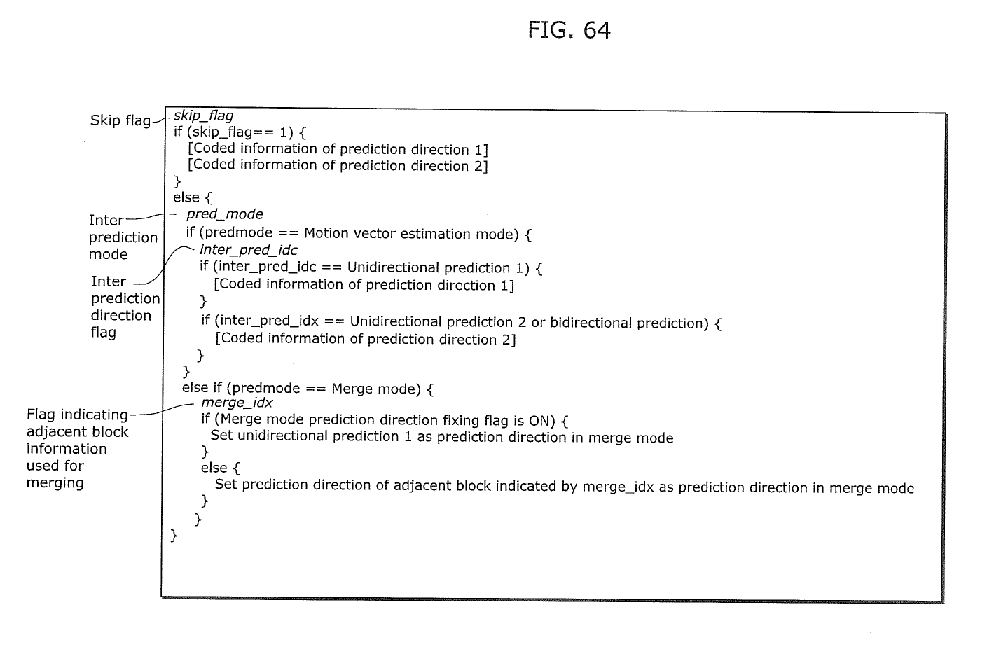

FIG. 64 is a diagram showing an example of syntax of a bitstream in the moving picture decoding method according to this embodiment of the present invention. In FIG. 64, skip_flag represents a skip flag, pred_mode represents an inter prediction mode, inter_pred_idc represents an inter prediction direction flag, and merge_idx represents adjacent block information used for merging. Here, in the example shown in FIG. 60, the value of merge_idx ranges from “0” to “3”. It is to be noted that the value of merge_idx described above is an example, and may range from, for instance, “0” to “4”.

As described above, according to this embodiment, it is possible to properly decode the bitstream for which coding efficiency is increased by selecting the unidirectional prediction in the merge mode, regardless of the prediction direction of the adjacent block, when the assignment of the reference picture index to each reference picture is the same for the reference picture lists 1 and 2.

### Embodiment 18

The processing described in each of Embodiments can be simply implemented in an independent computer system, by recording, in a recording medium, a program for implementing a configuration of the moving picture coding method (an image coding method) or the moving picture decoding method (an image decoding method) described in each of Embodiments. The recording media may be any recording media as long as the program can be recorded, such as a magnetic disk, an optical disk, a magnetic optical disk, an IC card, and a semiconductor memory.

Hereinafter, the applications to the moving picture coding method (the image coding method) and the moving picture decoding method (the image decoding method) described in each of Embodiments and systems using them will be described. The system includes an image coding and decoding apparatus which includes an image coding apparatus using the image coding method and an image decoding apparatus using the image decoding method. Other elements of the system can be appropriately changed depending on a situation.

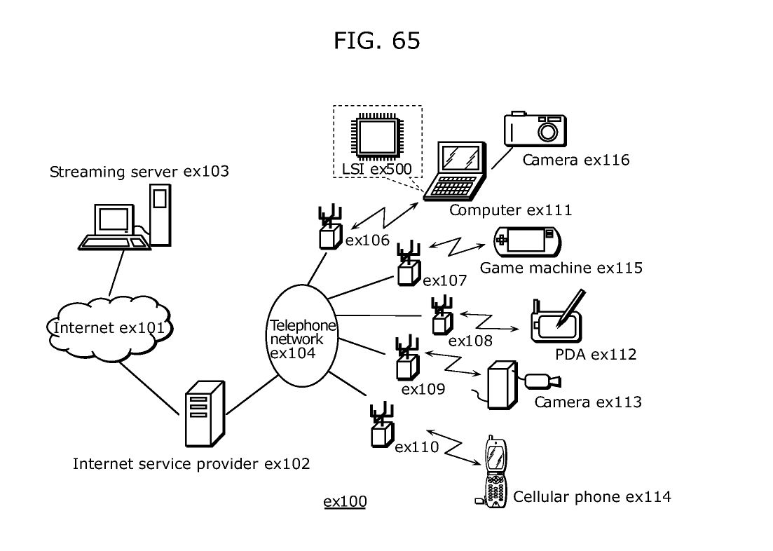

FIG. 65 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer exill, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 65, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital video camera, is capable of capturing both still images and video. Furthermore, the cellular phone ex114 may be the one that meets any of the standards such as Global System for Mobile Communications (GSM™), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded (that is, the content providing system ex100 functions as an image coding apparatus according to an implementation of the present invention) as described above in each of Embodiments, and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data (that is, the content providing system ex100 functions as an image decoding apparatus according to an implementation of the present invention).

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the image data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

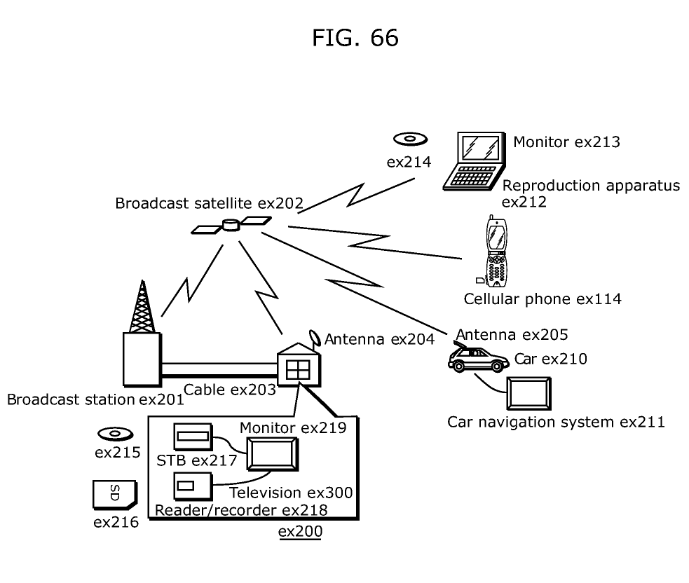

Aside from the example of the content providing system ex100, at least one of the moving picture coding apparatus (the image coding apparatus) and the moving picture decoding apparatus (the image decoding apparatus) described in each of Embodiments may be implemented in a digital broadcasting system ex200 illustrated in FIG. 66. More specifically, a broadcast station ex201 communicates or transmits, via radio waves to a broadcast satellite ex202, multiplexed data obtained by multiplexing audio data and others onto video data. The video data is data coded by the moving picture coding method described in each of Embodiments (that is, data coded by the image coding apparatus according to an implementation of the present invention). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (that is, the device functions as the image decoding apparatus according to an implementation of the present invention).

Furthermore, a reader/recorder ex218 (i) reads and decodes the multiplexed data recorded on a recording medium ex215, such as a DVD and a BD, or (ii) codes video signals in the recording medium ex215, and in some cases, writes data obtained by multiplexing an audio signal on the coded data. The reader/recorder ex218 can include the moving picture decoding apparatus or the moving picture coding apparatus as shown in each of Embodiments. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

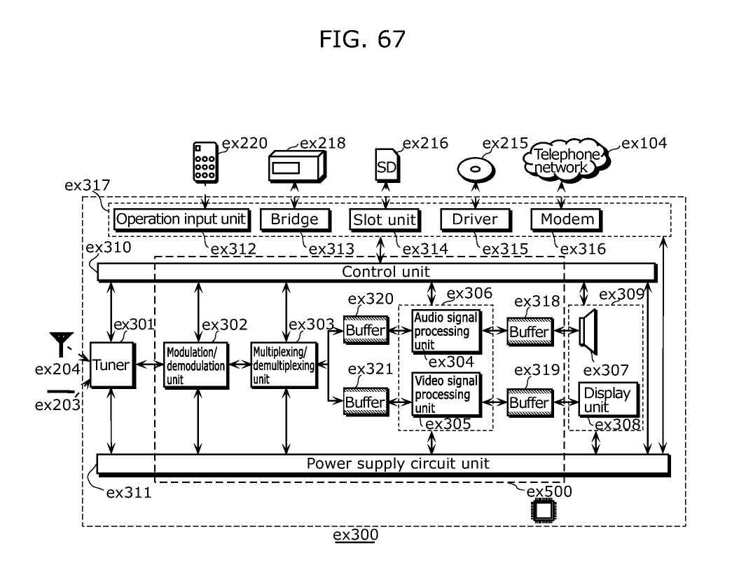

FIG. 67 illustrates the television (receiver) ex300 that uses the moving picture coding method and the moving picture decoding method described in each of Embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively (that function as the image coding apparatus and the image decoding apparatus, respectively, according to an implementation of the present invention); and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of Embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of Embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, although not illustrated, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

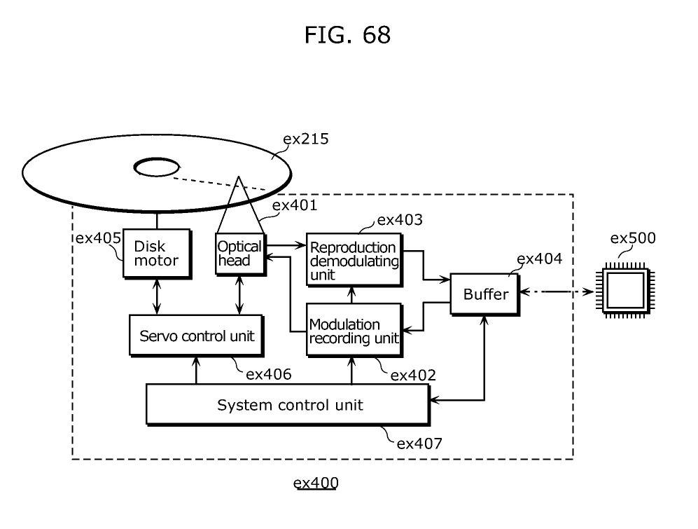

As an example, FIG. 68 illustrates a configuration of an information reproducing/recording unit ex400 when data is read or written from or on an optical disk. The information reproducing/recording unit ex400 includes constituent elements ex401 ex402, ex403, ex404, ex405, ex406, and ex407 to be described hereinafter. The optical head ex401 irradiates a laser spot on a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

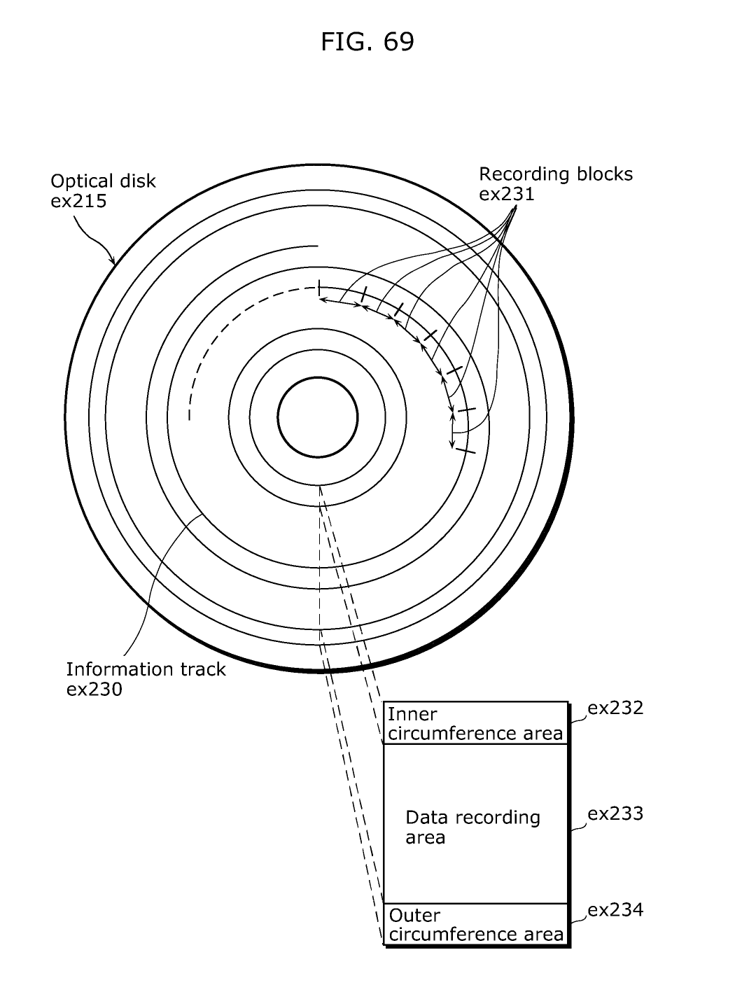

FIG. 69 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively, are for specific use except for recording the user data. The information reproducing/recording unit 400 reads and writes coded audio, coded video data, or multiplexed data obtained by multiplexing the coded audio and video data, from and in the data recording area ex233 of the recording medium ex215.

Although an optical disk having a single layer, such as a DVD and a BD, is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk, and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 67. The same will be true for the configuration of the computer ex111, the cellular phone ex114, and others.

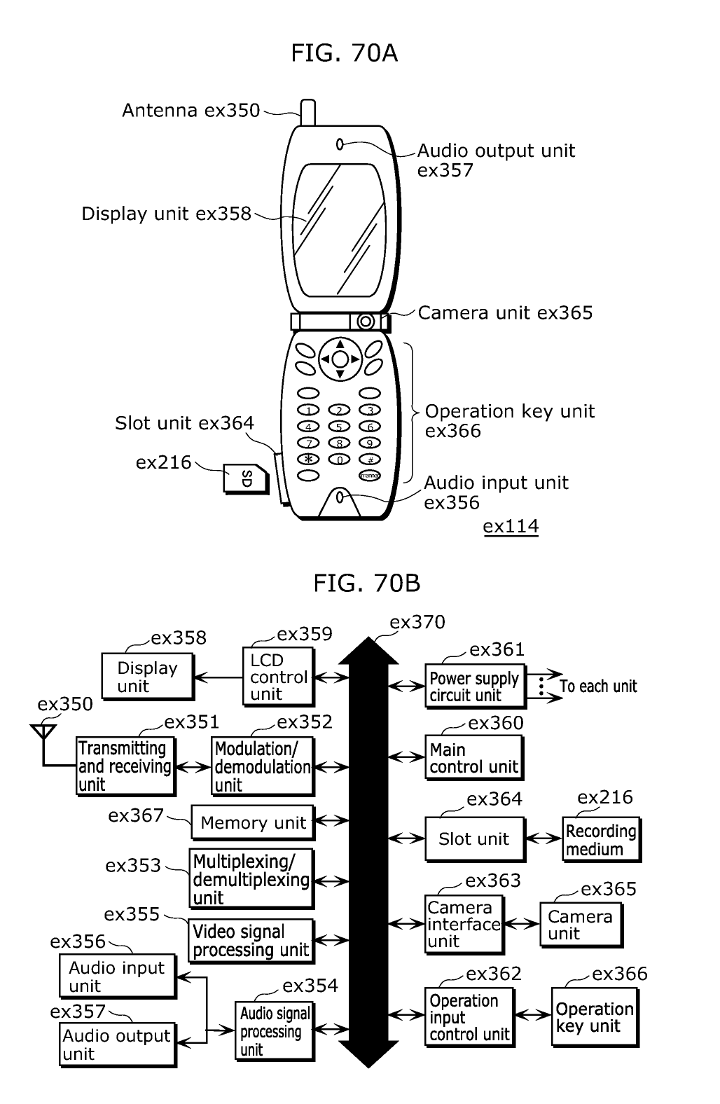

FIG. 70A illustrates the cellular phone ex114 that uses the moving picture coding method or the moving picture decoding method described in Embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 70B. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex356.

Furthermore, when an e-mail is transmitted in data communication mode, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio are transmitted in data communication mode, the video signal processing unit ex355 compresses and codes video signals supplied from the camera unit ex365 using the moving picture coding method shown in each of Embodiments (that is, functions as the image coding apparatus according to an implementation of the present invention), and transmits the coded video data to the multiplexing/demultiplexing unit ex353. In contrast, while the camera unit ex365 is capturing video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation circuit unit ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the coding method shown in each of Embodiments (that is, functions as the image decoding apparatus according to an implementation of the present invention), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably has 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in each of Embodiments can be used in any of the devices and systems described. Thus, the advantages described in each of Embodiments can be obtained.

Furthermore, the present invention is not limited to Embodiments, and various modifications and revisions are possible without departing from the scope of the present invention.

### Embodiment 19

Video data can be generated by switching, as necessary, between (i) the moving picture coding method or the moving picture coding apparatus shown in each of Embodiments and (ii) a moving picture coding method or a moving picture coding apparatus in conformity with a different standard, such as MPEG-2, MPEG4-AVC, and VC-1.

Here, when a plurality of video data that conforms to the different standards is generated and is then decoded, the decoding methods need to be selected to conform to the different standards. However, since to which standard each of the plurality of the video data to be decoded conforms cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in each of Embodiments will be hereinafter described. The multiplexed data is a digital stream in the MPEG2-Transport Stream format.

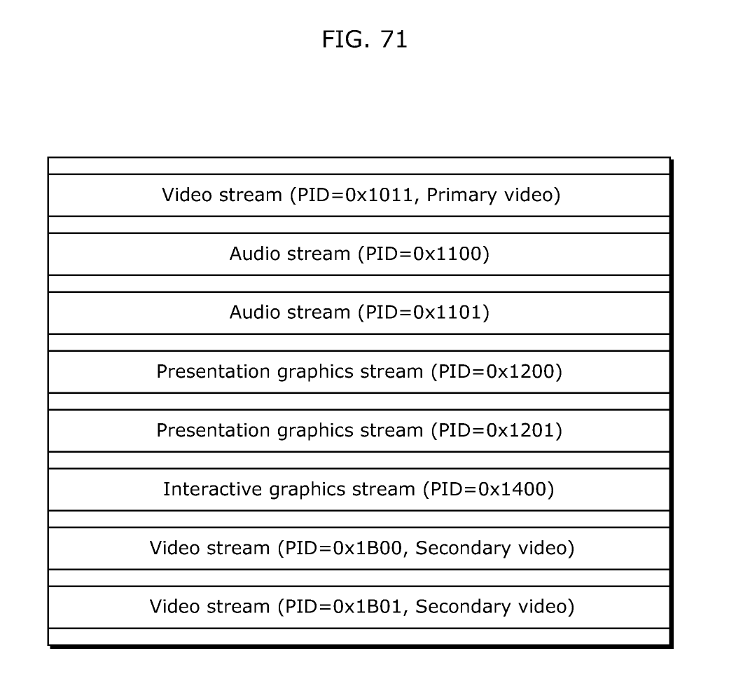

FIG. 71 is a diagram showing a structure of multiplexed data. As illustrated in FIG. 71, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the moving picture coding method or by the moving picture coding apparatus shown in each of Embodiments, or in a moving picture coding method or by a moving picture coding apparatus in conformity with a conventional standard, such as MPEG-2, MPEG4-AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary video to be mixed with the primary audio.

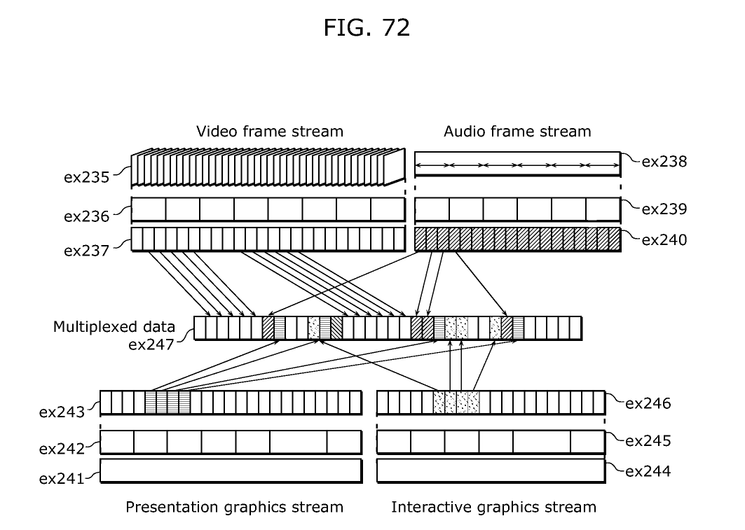

FIG. 72 schematically illustrates how data is multiplexed. First, a video stream ex235 composed of video frames and an audio stream ex238 composed of audio frames are transformed into a stream of PES packets ex236 and a stream of RES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

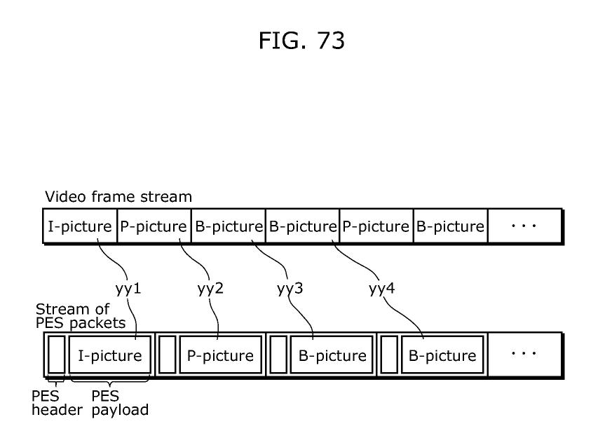

FIG. 73 illustrates how a video stream is stored in a stream of PES packets in more detail. The first bar in FIG. 73 shows a video frame stream in a video stream. The second bar shows the stream of PES packets. As indicated by arrows denoted as yy1, yy2, yy3, and yy4 in FIG. 73, the video stream is divided into pictures as I-pictures, B-pictures, and P-pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

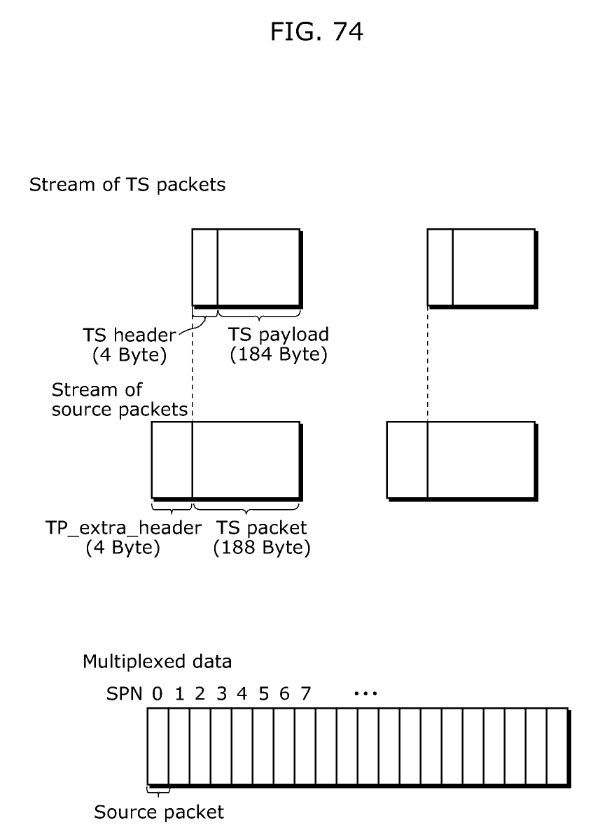

FIG. 74 illustrates a format of TS packets to be finally written on the multiplexed data. Each of the TS packets is a 188-byte fixed length packet including a 4-byte TS header having information, such as a PID for identifying a stream, and a 184-byte TS payload for storing data. The PES packets are divided, and stored in the TS payloads, respectively. When a BD-ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 74. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

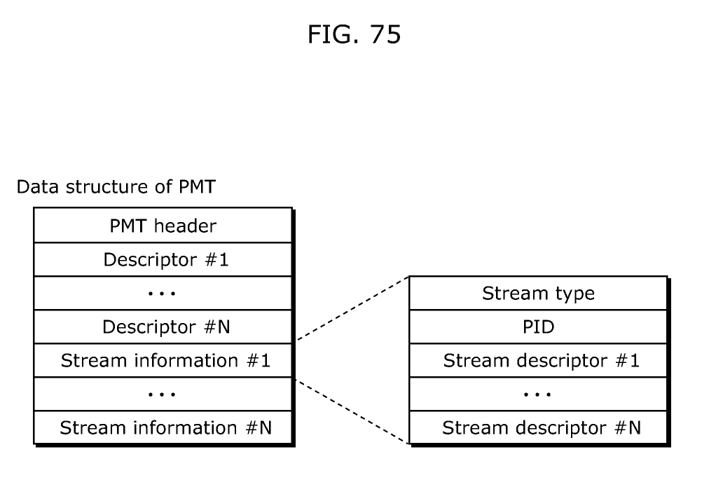

FIG. 75 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

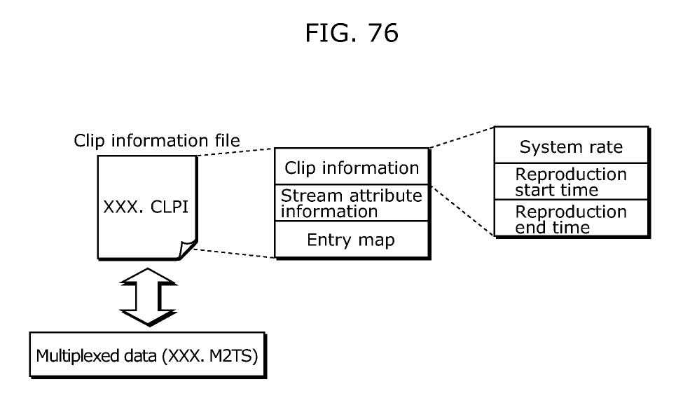

Each of the multiplexed data information files is management information of the multiplexed data as shown in FIG. 76. The multiplexed data information files are in one to one correspondence with the multiplexed data, and each of the files includes multiplexed data information, stream attribute information, and an entry map.

As illustrated in FIG. 76, the multiplexed data includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

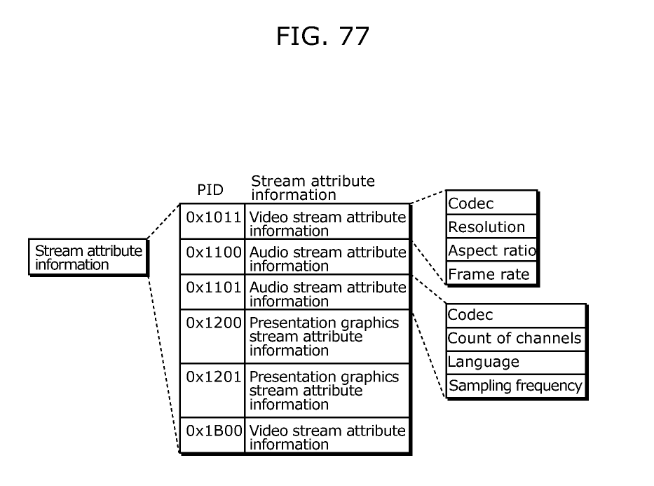

As shown in FIG. 77, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information indicating, for example, what kind of compression codec is used for compressing the audio stream, how many channels are included in the audio stream, which language the audio stream supports, and what the sampling frequency is. The video stream attribute information and the audio stream attribute information are used for initialization of a decoder before the player plays back the information.

In Embodiment 19, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in each of Embodiments includes a step or a unit for allocating unique information indicating video data generated by the moving picture coding method or the moving picture coding apparatus in each of Embodiments, to the stream type included in the PMT or the video stream attribute information. With the configuration, the video data generated by the moving picture coding method or the moving picture coding apparatus described in each of Embodiments can be distinguished from video data that conforms to another standard.

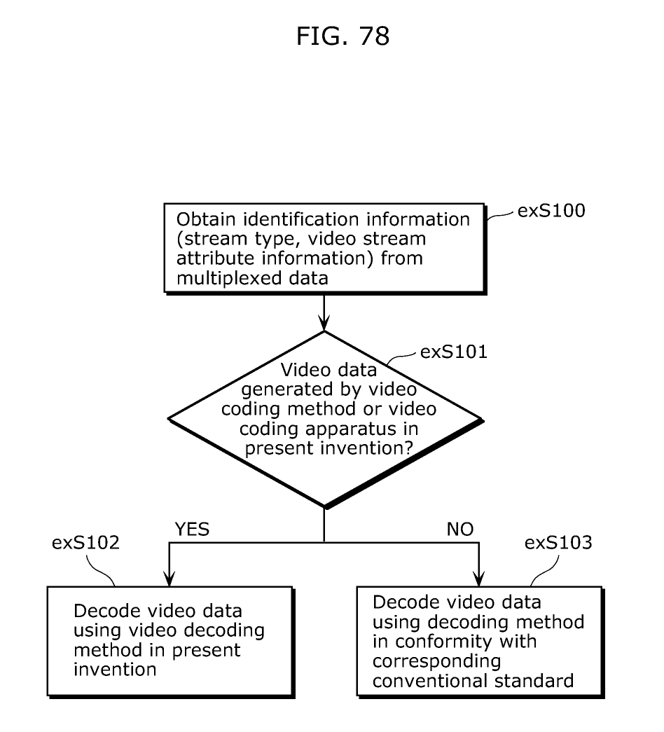

Furthermore, FIG. 78 illustrates steps of the moving picture decoding method according to this embodiment. In Step exS100, the stream type included in the PMT or the video stream attribute information included in the multiplexed data information is obtained from the multiplexed data. Next, in Step exS101, it is determined whether or not the stream type or the video stream attribute information indicates that the multiplexed data is generated by the moving picture coding method or the moving picture coding apparatus in each of Embodiments. When it is determined that the stream type or the video stream attribute information indicates that the multiplexed data is generated by the moving picture coding method or the moving picture coding apparatus in each of Embodiments, in Step exS102, decoding is performed by the moving picture decoding method in each of Embodiments. Furthermore, when the stream type or the video stream attribute information indicates conformance to the conventional standards, such as MPEG-2, MPEG4-AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in each of Embodiments can perform decoding. Even when multiplexed data that conforms to a different standard is inputted, an appropriate decoding method or apparatus can be selected. Thus, it becomes possible to decode information without any error. Furthermore, the moving picture coding method or apparatus or the moving picture decoding method or apparatus in Embodiment 5 can be used in the devices and systems described above.

### Embodiment 20

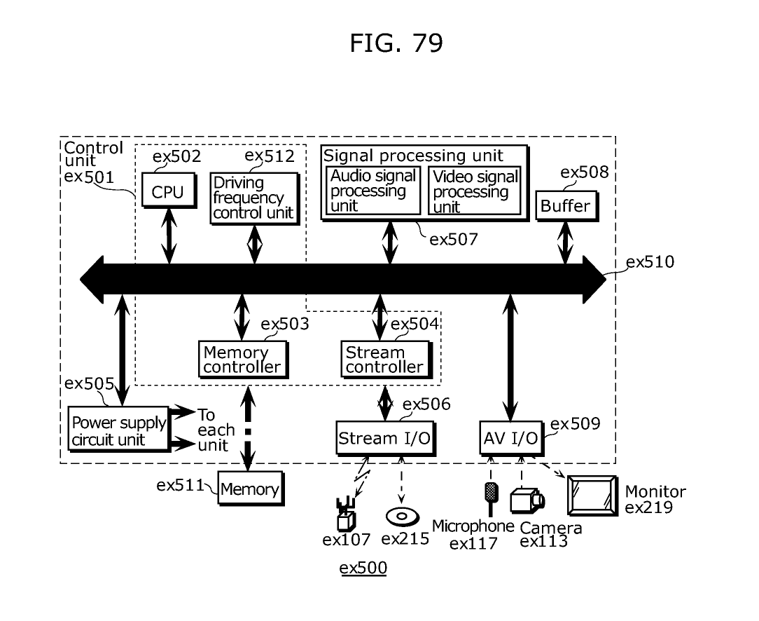

Each of the moving picture coding method, the moving picture coding apparatus, the moving picture decoding method, and the moving picture decoding apparatus in each of Embodiments is typically achieved in the form of an integrated circuit or a Large Scale Integrated (LSI) circuit. As an example of the LSI, FIG. 79 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV I/O ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of Embodiments. Furthermore, the signal processing unit ex507 sometimes multiplexes the coded audio data and the coded video data, and a stream I/O ex506 provides the multiplexed data outside. The provided multiplexed data is transmitted to the base station ex107, or written on the recording media ex215. When data sets are multiplexed, the data should be temporarily stored in the buffer ex508 so that the data sets are synchronized with each other.

Although the memory ex511 is an element outside the LSI ex500 in the above description, it may be included in the LSI ex500. The buffer ex508 is not limited to one buffer, but may be composed of buffers. Furthermore, the LSI ex500 may be made into one chip or a plurality of chips.

Furthermore, although the control unit ex510 includes the CPU ex502, the memory controller ex503, the stream controller ex504, the driving frequency control unit ex512, and so on, the configuration of the control unit ex510 is not limited to such. For example, the signal processing unit ex507 may further include a CPU. Inclusion of another CPU in the signal processing unit ex507 can improve the processing speed. Furthermore, as another example, the CPU ex502 may serve as the signal processing unit ex507 or may include, for instance, an audio signal processing unit that is a part of the signal processing unit ex507. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present invention is applied to biotechnology.

### Embodiment 21

When video data generated in the moving picture coding method or by the moving picture coding apparatus described in each of Embodiments is decoded, compared to when video data that conforms to a conventional standard, such as MPEG-2, MPEG4-AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

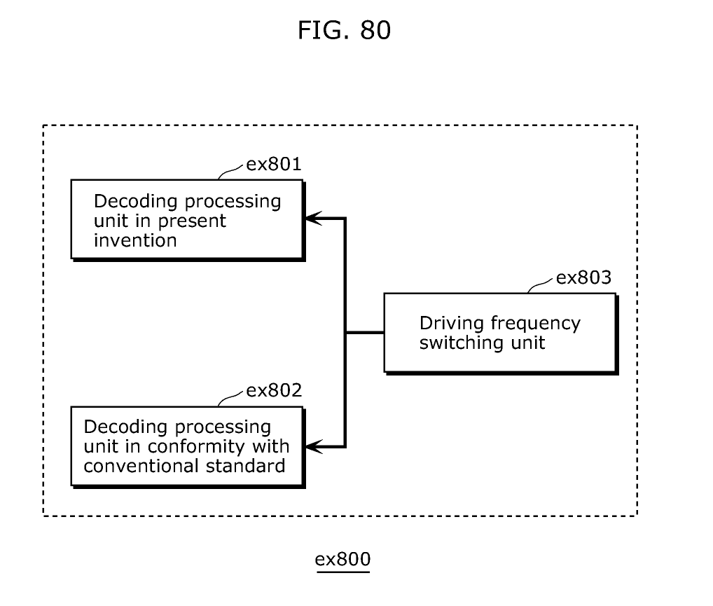

In order to solve the problem, the moving picture decoding apparatus, such as the television ex300 and the LSI ex500, is configured to determine to which standard the video data conforms, and switch between the driving frequencies according to the determined standard. FIG. 80 illustrates a configuration ex800 in Embodiment 21. A driving frequency switching unit ex803 sets a driving frequency to a higher driving frequency when video data is generated by the moving picture coding method or the moving picture coding apparatus described in each of Embodiments. Then, the driving frequency switching unit ex803 instructs a decoding processing unit ex801 that executes the moving picture decoding method described in each of Embodiments to decode the video data. When the video data is the video data that conforms to the conventional standard, the driving frequency switching unit ex803 sets a driving frequency to a lower driving frequency than that of the video data generated by the moving picture coding method or the moving picture coding apparatus described in each of Embodiments. Then, the driving frequency switching unit ex803 instructs the decoding processing unit ex802 that conforms to the conventional standard to decode the video data.

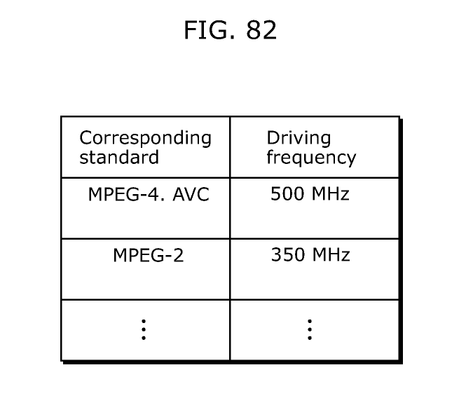

More specifically, the driving frequency switching unit ex803 includes the CPU ex502 and the driving frequency control unit ex512 in FIG. 79. Here, each of the decoding processing unit ex801 that executes the moving picture decoding method described in each of Embodiments and the decoding processing unit ex802 that conforms to the conventional standard corresponds to the signal processing unit ex507 in FIG. 79. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment 19 is probably used for identifying the video data. The identification information is not limited to the one described in Embodiment 19 but may be any information as long as the information indicates to which standard the video data conforms. For example, when it is possible to determine to which standard the video data conforms, based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 82. The driving frequency can be selected by storing the look-up table in the buffer ex508 and in an internal memory of an LSI, and with reference to the look-up table by the CPU ex502.

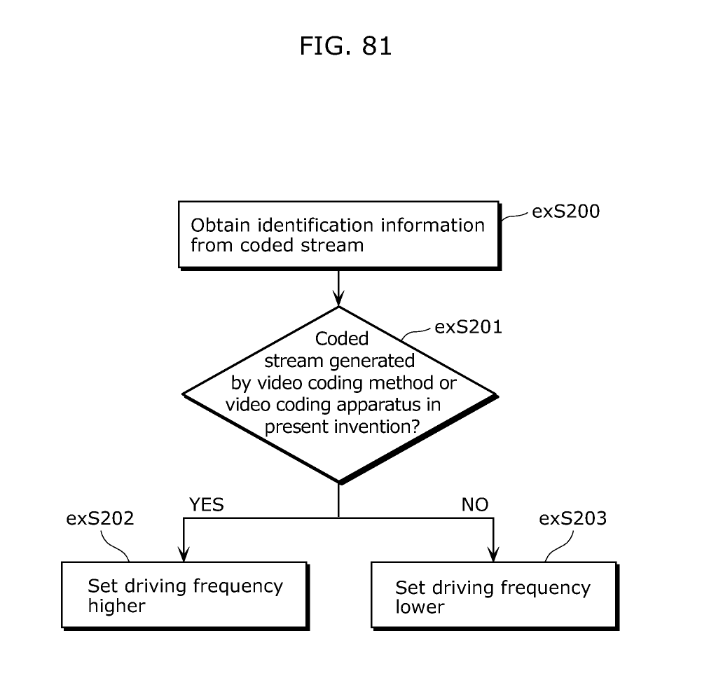

FIG. 81 illustrates steps for executing a method in Embodiment 7. First, in Step exS200, the signal processing unit ex507 obtains identification information from the multiplexed data. Next, in Step exS201, the CPU ex502 determines whether or not the video data is generated by the coding method and the coding apparatus described in each of Embodiments, based on the identification information. When the video data is generated by the coding method and the coding apparatus described in each of Embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG4-AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture coding method or the moving picture coding apparatus described in each of Embodiments.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set a lower voltage than that in the case where the driving frequency is set higher.

Furthermore, in a method for setting a driving frequency, when the processing amount for decoding is larger, the driving frequency may be set higher, and when the processing amount for decoding is smaller, the driving frequency may be set lower. Thus, the setting method is not limited to the ones described above. For example, when the processing amount for decoding video data in conformity with MPEG-AVC is larger than the processing amount for decoding video data generated by the moving picture coding method or the moving picture coding apparatus described in each of Embodiments, the driving frequency is probably set in reverse order to the setting described above.

Furthermore, the method for setting a driving frequency is not limited to setting a driving frequency lower. For example, when the identification information indicates that the video data is generated by the moving picture coding method or the moving picture coding apparatus described in each of Embodiments, the voltage to be applied to the LSI ex500 or the apparatus including the LSI ex500 is probably set higher. When the identification information indicates that the video data conforms to the conventional standard, such as MPEG-2, MPEG4-AVC, and VC-1, the voltage to be applied to the LSI ex500 or the apparatus including the LSI ex500 is probably set lower. As another example, when the identification information indicates that the video data is generated by the moving picture coding method or the moving picture coding apparatus described in each of Embodiments, the driving of the CPU ex502 does not probably have to be suspended. When the identification information indicates that the video data conforms to the conventional standard, such as MPEG-2, MPEG4-AVC, and VC-1, the driving of the CPU ex502 is probably suspended at a given time because the CPU ex502 has extra processing capacity. Even when the identification information indicates that the video data is generated by the moving picture coding method or the moving picture coding apparatus described in each of Embodiments, in the case where the CPU ex502 has extra processing capacity, the driving of the CPU ex502 is probably suspended at a given time. In such a case, the suspending time is probably set shorter than that in the case where the identification information indicates that the video data conforms to the conventional standard, such as MPEG-2, MPEG4-AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### Embodiment 22

There are cases where a plurality of video data that conforms to different standards is provided to the devices and systems, such as a television and a mobile phone. In order to enable decoding the plurality of video data that conforms to the different standards even when the plurality of video data is inputted, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

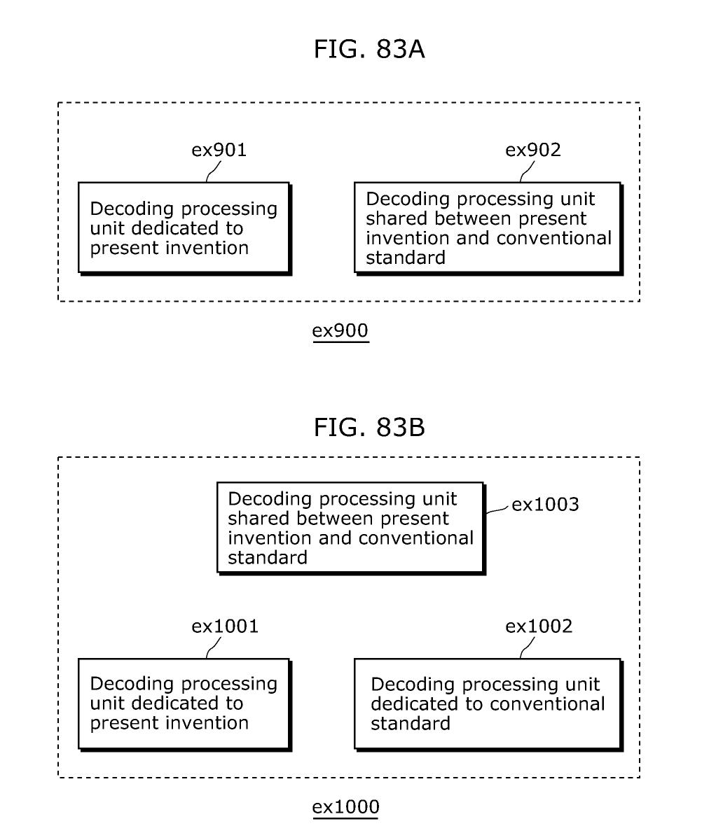

In order to solve the problems, what is conceived is a configuration in which the decoding processing unit for implementing the moving picture decoding method described in each of Embodiments and the decoding processing unit that conforms to the conventional standard, such as MPEG-2, MPEG4-AVC, and VC-1, are partly shared. Ex900 in FIG. 83A shows an example of the configuration. For example, the moving picture decoding method described in each of Embodiments and the moving picture decoding method that conforms to MPEG4-AVC have, partly in common, the details of processing, such as entropy coding, inverse quantization, deblocking filtering, and motion compensated prediction. The details of processing to be shared probably include use of a decoding processing unit ex902 that conforms to MPEG4-AVC. In contrast, a dedicated decoding processing unit ex901 is probably used for other processing that does not conform to MPEG4-AVC and is unique to the present invention. The decoding processing unit for implementing the moving picture decoding method described in each of Embodiments may be shared for the processing to be shared, and a dedicated decoding processing unit may be used for processing unique to that of MPEG4-AVC.

Furthermore, ex1000 in FIG. 83B shows another example in that processing is partly shared. This example uses a configuration including a dedicated decoding processing unit ex1001 that supports the processing unique to the present invention, a dedicated decoding processing unit ex1002 that supports the processing unique to another conventional standard, and a decoding processing unit ex1003 that supports processing to be shared between the moving picture decoding method in the present invention and the conventional moving picture decoding method. Here, the dedicated decoding processing units ex1001 and ex1002 are not necessarily specialized for the processing of the present invention and the processing of the conventional standard, respectively, and may be the ones capable of implementing general processing. Furthermore, the configuration of Embodiment 22 can be implemented by the LSI ex500.

As such, reducing the scale of the circuit of an LSI and reducing the cost are possible by sharing the decoding processing unit for the processing to be shared between the moving picture decoding method in the present invention and the moving picture decoding method in conformity with the conventional standard.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

A moving picture coding method and a moving picture decoding method according to the present invention are applicable to every multimedia data, make it possible to increase coding efficiency, and are useful as a moving picture coding method and a moving picture decoding method for accumulation, transmission, communication, and so on using, for example, cellular phones, DVD apparatuses, and personal computers.

What is claimed is:

1. A moving picture coding method for coding, by using inter picture prediction, a current block to be coded, with reference to a reference picture list in which a reference picture index is assigned to a candidate reference picture so as to specify a reference picture to be referred to when the current block in a current picture to be coded is coded, said moving picture coding method comprising:
determining, as one or more first candidates, one or more motion vectors and one or more reference picture index values which are used by a first adjacent block adjacent to the current block;
determining, as a second candidate, one or more motion vectors used by a second adjacent block adjacent to the current block and the one or more the reference picture index values used by the first adjacent block;
determining, from among the one or more first candidates and the second candidate, one or more motion vectors and one or more reference picture index values which are to be used by the current block; and
coding the current block using the determined one or more motion vectors and the determined one or more reference picture index values.

2. The moving picture coding method according to claim 1,
wherein the second adjacent block is a reference block which is included in a coded picture different from the current picture and is at a position in the coded picture which corresponds to a position of the current block in the current picture.

3. The moving picture coding method according to claim 1, further comprising
specifying, from a candidate list in which candidate indexes are assigned to the one or more first candidates and the second candidate, a candidate index value corresponding to the one or more motion vectors and the one or more reference picture index values which are determined to be used by the current block.

4. The moving picture coding method according to claim 3, further comprising
adding the specified candidate index value to a bitstream obtained by coding the current picture.

5. The moving picture coding method according to claim 1,
wherein the one or more motion vectors in the second candidate are one or more motion vectors obtained by scaling, according to reference distances of the current picture and the reference picture, one or more motion vectors used by a reference block.

6. The moving picture coding method according to claim 1,
wherein in said determining as a second candidate, a reference picture index value used by an adjacent block adjacent to the left of the current block is determined as the reference picture index value of the second candidate.

7. The moving picture coding method according to claim 6,
wherein in said determining as a second candidate, the reference picture index value of the second candidate is determined to be a smallest value when the reference picture index value used by the adjacent block adjacent to the left of the current block is not present.

8. A moving picture decoding method for decoding, by using inter picture prediction, a current block to be decoded, with reference to a reference picture list in which a reference picture index is assigned to a candidate reference picture so as to specify a reference picture to be referred to when the current block in a current picture to be decoded is decoded, said moving picture decoding method comprising:
determining, as one or more first candidates, one or more motion vectors and one or more reference picture index values which are used by a first adjacent block adjacent to the current block;
determining, as a second candidate, one or more motion vectors used by a second adjacent block adjacent to the current block and the one or more reference picture index values used by the first adjacent block;
determining, from among the one or more first candidates and the second candidate, one or more motion vectors and one or more reference picture index values which are to be used by the current block; and
decoding the current block using the determined one or more motion vectors and the determined one or more reference picture index values.

9. The moving picture decoding method according to claim 8,
wherein the second adjacent block is a reference block which is included in a decoded picture different from the current picture and is at a position in the decoded picture which corresponds to a position of the current block in the current picture.

10. The moving picture decoding method according to claim 8, further comprising:
obtaining a candidate index value from a bitstream including the current picture; and
determining, using the obtained candidate index value, one or more motion vectors and one or more reference picture index values which are to be used by the current block, based on a candidate list in which candidate indexes including the candidate index are assigned to the one or more first candidates and the second candidate.

11. The moving picture decoding method according to claim 8,
wherein the one or more motion vectors in the second candidate are one or more motion vectors obtained by scaling, according to reference distances of the current picture and the reference picture, one or more motion vectors used by a reference block.

12. The moving picture decoding method according to claim 8,
wherein in said determining as a second candidate, a reference picture index value used by an adjacent block adjacent to the left of the current block is determined as the reference picture index value of the second candidate.

13. The moving picture decoding method according to claim 12,
wherein in said determining as a second candidate, the reference picture index value of the second candidate is determined to be a smallest value when the reference picture index value used by the adjacent block adjacent to the left of the current block is not present.

14. A moving picture coding apparatus which codes, by using inter picture prediction, a current block to be coded, with reference to a reference picture list in which a reference picture index is assigned to a candidate reference picture so as to specify a reference picture to be referred to when the current block in a current picture to be coded is coded, said moving picture coding apparatus comprising:
a first determination unit configured to determine, as one or more first candidates, one or more motion vectors and one or more reference picture index values which are used by a first adjacent block adjacent to the current block;
a second determination unit configured to determine, as a second candidate, one or more motion vectors used by a second adjacent block adjacent to the current block and the one or more the reference picture index values used by the first adjacent block;
a third determination unit configured to determine, from among the one or more first candidates and the second candidate, one or more motion vectors and one or more reference picture index values which are to be used by the current block; and
a coding unit configured to code the current block using the one or more motion vectors and the one or more reference picture index values which are determined by said third determination unit.

15. A moving picture decoding apparatus which decodes, by using inter picture prediction, a current block to be decoded, with reference to a reference picture list in which a reference picture index is assigned to a candidate reference picture so as to specify a reference picture to be referred to when the current block in a current picture to be decoded is decoded, said moving picture decoding apparatus comprising:
a first determination unit configured to determine, as one or more first candidates, one or more motion vectors and one or more reference picture index values which are used by a first adjacent block adjacent to the current block;
a second determination unit configured to determine, as a second candidate, one or more motion vectors used by a second adjacent block adjacent to the current block and the one or more the reference picture index values used by the first adjacent block;
a third determination unit configured to determine, from among the one or more first candidates and the second candidate, one or more motion vectors and one or more reference picture index values which are to be used by the current block; and
a decoding unit configured to decode the current block using the one or more motion vectors and the one or more reference picture index values which are determined by said third determination unit.

16. A moving picture coding and decoding apparatus which (i) codes, by using inter picture prediction, a current block to be coded, with reference to a reference picture list in which a reference picture index is assigned to a candidate reference picture so as to specify a reference picture to be referred to when the current block in a current picture to be coded is coded, and (ii) decodes, by using the inter picture prediction, a current block to be decoded, with reference to the reference picture list so as to specify a reference picture to be referred to when the current block in a current picture to be decoded is decoded, said moving picture coding and decoding apparatus comprising:
a first determination unit configured to determine, as one or more first candidates, one or more motion vectors and one or more reference picture index values which are used by a first adjacent block adjacent to the current block to be coded;
a second determination unit configured to determine, as a second candidate, one or more motion vectors used by a second adjacent block adjacent to the current block to be coded and the one or more the reference picture index values used by the first adjacent block
a third determination unit configured to determine, from among the one or more first candidates and the second candidate, one or more motion vectors and one or more reference picture index values which are to be used by the current block to be coded;
a coding unit configured to code the current block to be coded, using the one or more motion vectors and the one or more reference picture index values which are determined by said third determination unit;
a fourth determination unit configured to determine, as one or more first candidates, one or more motion vectors and one or more reference picture index values which are used by a first adjacent block adjacent to the current block to be decoded;
a fifth determination unit configured to determine, as a second candidate, one or more motion vectors used by a second adjacent block adjacent to the current block to be decoded and the one or more the reference picture index values used by the first adjacent block;
a sixth determination unit configured to determine, from among the one or more first candidates and the second candidate, one or more motion vectors and one or more reference picture index values which are to be used by the current block to be decoded; and
a decoding unit configured to decode the current block to be decoded, using the one or more motion vectors and the one or more reference picture index values which are determined by said third determination unit.
